(19) United States
(12) Patent Application Publication
(10) Pub. No.: US 2025/0026882 A1
(43) Pub. Date: Jan. 23, 2025

(54) HIGH-MOLECULAR COMPOUND, MOLDING COMPOSITION, FILM, AND CAPACITOR

(71) Applicant: Panasonic Intellectual Property Management Co., Ltd., Osaka (JP)

(72) Inventor: Yusuke OGIHARA, Osaka (JP)

(21) Appl. No.: 18/688,731

(22) PCT Filed: Sep. 2, 2022
(86) PCT No.: PCT/JP2022/033099

§ 371 Date: Mar. 1, 2024

(30) Foreign Application Priority Data
Sep. 6, 2021 (JP) 2021-145060

(51) Int. Cl. C08G 63/685; C08J 5/18; H01G 4/18

(52) U.S. Cl. CPC C08G 63/685; C08J 5/18; H01G 4/18; C08J 2367/00

(57) ABSTRACT

A high-molecular compound has a constitutional unit (U) having a heterocyclic ring, a carbonyl group, and a substituent bonded to the heterocyclic ring. The substituent includes at least one group selected from the group consisting of a halogen group, a hydroxyl group, an aldehyde group, a carboxyl group, an alkyl group, a halogenated alkyl group, and a hydroxyalkyl group.

### TECHNICAL FIELD

The present disclosure generally relates to a high-molecular compound, a molding composition, a film, and a capacitor. More particularly, the present disclosure relates to a novel high-molecular compound, a molding composition containing the high-molecular compound, a film containing the high-molecular compound, and a capacitor including a dielectric layer containing the high-molecular compound.

### BACKGROUND ART

Patent Document 1 discloses a film capacitor element. The film capacitor element is configured as a laminate in which at least a dielectric film layer as a poly-urea formaldehyde film and a metal evaporated film layer are stacked one on top of another.

Patent Document 2 discloses a laminated film. The laminated film includes a first electrode layer, a resin base member, a second electrode layer, and a dielectric layer, which are stacked one on top of another in this order. The dielectric layer includes a copolymer of vinylidene fluoride and tetrafluoroethylene.

### CITATION LIST

### Patent Literature

Patent Document 1: JP 2016-8323 A
Patent Document 2: WO 2014/080832 A1

### SUMMARY OF INVENTION

The problem to be overcome by the present disclosure is to provide a high-molecular compound with a high dielectric constant, a molding composition containing the high-molecular compound, a film containing the high-molecular compound, and a capacitor including a dielectric layer containing the high-molecular compound.

A high-molecular compound according to an aspect of the present disclosure has a constitutional unit (U) having a heterocyclic ring, a carbonyl group, and a substituent bonded to the heterocyclic ring. The substituent includes at least one group selected from the group consisting of a halogen group, a hydroxyl group, an aldehyde group, a carboxyl group, an alkyl group, a halogenated alkyl group, and a hydroxyalkyl group.

A molding composition according to another aspect of the present disclosure contains the high-molecular compound described above.

A film according to still another aspect of the present disclosure contains the high-molecular compound described above.

A capacitor according to yet another aspect of the present disclosure includes a dielectric layer containing the high-molecular compound described above.

### BRIEF DESCRIPTION OF DRAWINGS

FIG. 1 is a schematic representation illustrating a capacitor according to an exemplary embodiment; and

FIG. 2A is a schematic representation illustrating a roll included in a rolled capacitor according to the exemplary embodiment; and

FIG. 2B is a schematic representation illustrating the rolled capacitor according to the exemplary embodiment.

### DESCRIPTION OF EMBODIMENTS

An exemplary embodiment of the present disclosure will now be described. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

### (Overview)

Recently, as electric vehicles (EVs) and hybrid vehicles have become increasingly popular, there has been growing demand for reducing the size of an inverter for use to control their motor. That is why demand for reducing the size of a capacitor, such as a film capacitor, as a component of the inverter has also been on the rise.

Reducing the thickness of a dielectric layer included in a capacitor is one of various methods for reducing the overall size of the capacitor while maintaining its performance.

Nevertheless, reducing the thickness of the dielectric layer not only makes it rather difficult to pattern the dielectric layer into a desired shape but also increases the chances of causing dielectric breakdown as well.

To overcome this problem, the present inventors carried out extensive research and development to provide a technique for increasing the dielectric constant of the dielectric layer even with its thickness not reduced at all or hardly reduced, increasing the capacitance of a capacitor including such a dielectric layer, and reducing the chances of causing dielectric breakdown to the dielectric layer. As a result, the present inventors successfully developed, as a high-molecular compound according to an exemplary embodiment, a high-molecular compound having a higher dielectric constant (which may be equal to or greater than 3.5, for example) than a known high-molecular compound (with a dielectric constant falling within the range from about 2.0 to about 3.0).

A high-molecular compound according to an exemplary embodiment has a constitutional unit (U) having a heterocyclic ring, a carbonyl group, and a substituent bonded to the heterocyclic ring. The substituent includes at least one group selected from the group consisting of a halogen group, a hydroxyl group, an aldehyde group, a carboxyl group, an alkyl group, a halogenated alkyl group, and a hydroxyalkyl group.

This embodiment provides a high-molecular compound with a high dielectric constant, a molding composition containing the high-molecular compound, a film containing the high-molecular compound, and a capacitor including a dielectric layer containing the high-molecular compound. Note that the high-molecular compound according to this embodiment does not have to be used to make a dielectric layer for a capacitor but may also be used for any of various other purposes as well.

### (Details)

### (1) (High-Molecular Compound)

A more specific configuration for the high-molecular compound according to this embodiment will be described.

As described above, a high-molecular compound according to this embodiment has a constitutional unit (U) having a heterocyclic ring, a carbonyl group, and a substituent bonded to the heterocyclic ring. The substituent includes at least one group selected from the group consisting of a halogen group, a hydroxyl group, an aldehyde group, a carboxyl group, an alkyl group, a halogenated alkyl group, and a hydroxyalkyl group. That is to say, the high-molecular compound is a compound having a constitutional unit (U) with one or a plurality of heterocyclic rings, to each of which a substituent is bonded, and one or a plurality of carbonyl groups.

The heterocyclic ring is a ring having atoms of at least two different elements in itself. The heterocyclic ring has, for example, carbon atoms. The heterocyclic ring may also have heteroatoms other than carbon atoms, such as nitrogen, oxygen, or sulfur atoms. Among these atoms, the heterocyclic ring preferably has nitrogen atoms to provide a high-molecular compound having a higher dielectric constant. That is to say, the heterocyclic ring is preferably a nitrogen-containing heterocyclic ring. The heterocyclic ring may also be any of a three-membered ring, a four-membered ring, a five-membered ring, a six-membered ring, or a seven-or-more-membered ring. Among other things, the heterocyclic ring is preferably a five-membered ring or a six-membered ring to stably provide a high-molecular compound having a high dielectric constant.

A carbonyl group is a functional group having a structure represented by —C(═O)—.

In the constitutional unit (U), the carbonyl group is preferably directly bonded to the heterocyclic ring. This allows a high-molecular compound with a higher dielectric constant to be provided. Alternatively, another atom such as an oxygen atom may be interposed between the heterocyclic ring and the carbonyl group. That is to say, the carbon atom that forms the heterocyclic ring and the carbon atom of the carbonyl group may be bonded to each other via another atom such as an oxygen atom.

As used herein, if the carbonyl group is directly bonded to the heterocyclic ring, this means that an atom that forms part of the heterocyclic ring and the carbon atom of the carbonyl group form a covalent bond.

As described above, the substituent includes at least one group selected from the group consisting of a halogen group, a hydroxyl group, an aldehyde group, a carboxyl group, an alkyl group, a halogenated alkyl group, and a hydroxyalkyl group. This allows a high-molecular compound with a high dielectric constant to be provided. The substituent more preferably includes at least one selected from the group consisting of F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH.

The constitutional unit (U) preferably includes at least one selected from the group consisting of the following constitutional unit (UA), a constitutional unit (UB), a constitutional unit (UC1), and a constitutional unit (UC2). This makes it even easier to increase the dielectric constant of the high-molecular compound.

The constitutional unit (UA) has a structure expressed by the following chemical structural formula (A):

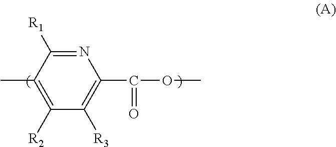

In the chemical structural formula (A), R₁, R₂, and R₃ are each independently either H or a substituent, and least one of R₁, R₂, or R₃ is not H.

In the chemical structural formula (A), R₁, R₂, and R₃ are preferably each independently selected from the list consisting of H, F, Cl, Br, OH, CHO, COOH, CH₃, CH₂F, CHF₂, CH₂Cl, CHCl₂, CCl₃, CH₂Br, CHBr₂, CBr₃, and CHOHCH₂OH, and H is preferably excluded from the list for at least one of R₁, R₂, or R₃ (i.e., at least one of R₁, R₂, or R₃ is preferably not H). This makes it even easier to increase the dielectric constant of the high-molecular compound.

More preferably, in the chemical structural formula (A), R₁ is H; R₂ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₃ is either H or the same as R₂. This makes it even easier to increase the dielectric constant of the high-molecular compound.

More preferably, in the chemical structural formula (A), R₂ is H; R₃ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₁ is either H or the same as R₃. This also makes it even easier to increase the dielectric constant of the high-molecular compound.

More preferably, in the chemical structural formula (A), R₃ is H; R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₂ is either H or the same as R₁. This also makes it even easier to increase the dielectric constant of the high-molecular compound.

Even more preferably, in the chemical structural formula (A), R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and each of R₂ and R₃ is the same as R₁. This makes it significantly easier to increase the dielectric constant of the high-molecular compound.

Note that the constitutional units (UA) may consist of only one type of constitutional units having the same structure or include multiple types of constitutional units having mutually different structures.

The constitutional unit (UB) has a structure expressed by the following chemical structural formula (B):

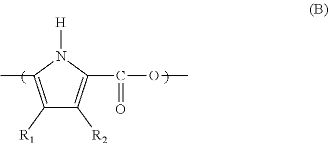

In the chemical structural formula (B), R₁ and R₂ are each independently either H or a substituent, and at least one of R₁ or R₂ is not H.

In the chemical structural formula (B), R₁ and R₂ are preferably each independently selected from the list consisting of H, F, Cl, Br, OH, CHO, COOH, CH₃, CH₂F, CH₂Cl, CHCl₂, CCl₃, CH₂Br, CHBr₂, CBr₃, and CHOHCH₂OH, and H is preferably excluded from the list for at least one of R₁ or R₂. This makes it easier to increase the dielectric constant of the high-molecular compound.

More preferably, in the chemical structural formula (B), R₁ is H; and R₂ is F, Cl, Br, OH, CHO, COOH, CH₃, CH₂F, CH₂Cl, CHCl₂, CCl₃, CH₂Br, CHBr₂, CBr₃, or CHOHCH₂OH. This makes it even easier to increase the dielectric constant of the high-molecular compound.

More preferably, in the chemical structural formula (B), R₁ is F, Cl, Br, OH, CHO, COOH, CH₃, CH₂F, CH₂Cl, CHCl₂, CCl₃, CH₂Br, CHBr₂, CBr₃, or CHOHCH₂OH, and R₂ is either H or the same as R₁. This also makes it even easier to increase the dielectric constant of the high-molecular compound.

Note that the constitutional units (UB) may consist of only one type of constitutional units having the same structure or include multiple types of constitutional units having mutually different structures.

The constitutional unit (UC1) has a structure expressed by the following chemical structural formula (C1):

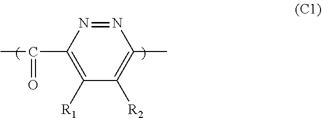

In the chemical structural formula (C1), R₁ and R₂ are each independently either H or a substituent, and at least one of R₁ or R₂ is not H.

In the chemical structural formula (C1), R₁ and R₂ are preferably each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is preferably excluded from the list for at least one of R₁ or R₂. This makes it easier to increase the dielectric constant of the high-molecular compound.

More preferably, in the chemical structural formula (C1), R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either H or the same as R₁. This makes it even easier to increase the dielectric constant of the high-molecular compound.

Note that the constitutional units (UC1) may consist of only one type of constitutional units having the same structure or include multiple types of constitutional units having mutually different structures.

The constitutional unit (UC2) has a structure expressed by the following chemical structural formula (C2):

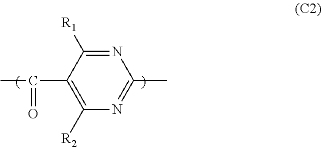

In the chemical structural formula (C2), R₁ and R₂ are each independently either H or a substituent, and at least one of R₁ or R₂ is not H.

In the chemical structural formula (C2), R₁ and R₂ are preferably each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is preferably excluded from the list for at least one of R₁ or R₂. This makes it easier to increase the dielectric constant of the high-molecular compound.

More preferably, in the chemical structural formula (C2), R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either H or the same as R₁. This makes it even easier to increase the dielectric constant of the high-molecular compound.

Note that the constitutional units (UC2) may consist of only one type of constitutional units having the same structure or include multiple types of constitutional units having mutually different structures.

It should also be noted that the constitutional units (U) do not have to include at least one selected from the group consisting of the constitutional unit (UA), the constitutional unit (UB), the constitutional unit (UC1), and the constitutional unit (UC2). That is to say, the constitutional units (U) may include constitutional units other than these constitutional units (UA)-(UC2).

A high-molecular compound according to this embodiment may include only the constitutional units (U) or may further include constitutional units other than the constitutional units (U).

Examples of constitutional units other than the constitutional units (UA)-(UC2) include constitutional units, of which the heterocyclic ring has a different structure from the counterpart of the constitutional units (UA)-(UC2).

Examples of constitutional units other than the constitutional units (UA)-(UC2) further include constitutional units in which either an atom or an atomic group is interposed between the heterocyclic ring, to which the substituent is bonded, and the carbonyl group. This atom includes at least one selected from the group consisting of, for example, an oxygen atom, a nitrogen atom, and other atoms. Also, this atomic group includes at least one selected from the group consisting of, for example, an ether bond, an ester bond, a methylene group, and others.

Constitutional units other than the constitutional units (U) include, for example, at least one selected from the group consisting of appropriate atoms and appropriate atomic groups. Examples of atoms include at least one selected from the group consisting of oxygen atoms, nitrogen atoms, and other atoms. Examples of atomic groups include at least one selected from the group consisting of ether bonds, ester bonds, methylene groups, and others.

A high-molecular compound according to this embodiment contains at least one selected from the group consisting of oligomers and polymers.

A high-molecular compound according to this embodiment may be a regular high polymer having a structure in which only one type of constitutional units are repeated by a single linking method or may also be an irregular high polymer having either a structure consisting of two or more types of constitutional units that are repeated or a structure in which the constitutional units are not linked together by a single method.

A high-molecular compound according to this embodiment may include one, two or more types of the high-molecular compounds according to this embodiment. That is to say, the high-molecular compound according to this embodiment may include a plurality of high-molecular compounds having mutually different chemical structures. This makes it easier to increase the dielectric constant of the high-molecular compound.

The following Tables 1-10 show Examples 1-215 of a film according to this embodiment. In each of these tables, the “chemical structural formula” column shows the chemical structural formula of a high-molecular compound included in the films according to respective examples.

Also, in each of these tables, the “molecular weight” column indicates the molecular weights of the high-molecular compounds included in the films according to respective examples.

The molecular weights of the high-molecular compounds were measured in the following manner.

First, a high-molecular compound according to each example was dissolved in hexafluoropropanol to prepare a measurement sample. Next, the measurement sample thus prepared was subjected to gel filtration chromatography (GPC) and allowed to pass through a column “GPC HFIP-805” (manufactured by Showa Denko K. K.) to separate the high-molecular compound in the measurement sample according to the molecular weight. Then, the high-molecular compounds thus separated were allowed to flow into a differential refractometer “2414 RI detector” (manufactured by Nihon Waters K. K.) in the order in which they were separated, thereby obtaining measurement results reflecting the molecular weight distribution of the high-molecular compounds. Based on the measurement results thus obtained, the molecular weights of the high-molecular compounds were calculated. Note that this is only an exemplary method for measuring the molecular weights of the high-molecular compounds and should not be construed as limiting the scope of the present disclosure.

In each table, the “dielectric constant” and “capacitance” columns respectively indicate the dielectric constants of the films according to respective examples and the capacitances of capacitors formed out of the films according to the respective examples.

The “dielectric constant” and “capacitance” were measured in the following manner. First, a high-molecular compound according to each example was loaded into an extruder of a cast molding machine and heated to a temperature equal to or higher than 180° C. and equal to or lower than 270° C. to be melted. The high-molecular compound thus melted was extruded out of the extruder and then cooled by a chill roller of the cast molding machine to form a sheet. Subsequently, the sheet was stretched in the direction of movement of the sheet by a longitudinal stretching device, stretched in a direction perpendicular to the direction of movement of the sheet by a transverse stretching device, and then cut off to obtain a film. The film had a thickness of 3.0 μm.

Next, a rolled capacitor (of which the dielectric layer had an area of 92 m²), including the film as its dielectric layer, was formed. Note that the rolled capacitor according to this embodiment will be described in detail later in the “(4) Capacitor” section.

Using a parameter analyzer “HP4284A” (manufactured by Hewlett-Packard), the capacitance of the rolled capacitor was measured under measurement conditions including room temperature (25° C.), a frequency of 1 kHz, and an applied voltage of 450 V. Also, the dielectric constant (relative dielectric constant) of the film was calculated based on the capacitance of the capacitor, the area of the dielectric layer, and the thickness of the dielectric layer. Note that these are only exemplary methods for measuring the “dielectric constant” and the “capacitance” and should not be construed as limiting the scope of the present disclosure.

TABLE 1

| | Chemical structural | Substituent | | | | Dielectric | Capacitance |
|---|---|---|---|---|---|---|---|
| | formula | R₁ | R₂ | R₃ | Molecular weight | constant | (μF) |
| Ex.1 | 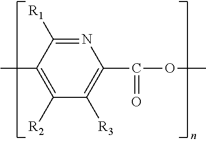 | F | H | H | 7.2 × 10²-3.3 × 10⁶ | 3.7 | 1.0 × 10³ |
| Ex.2 | | H | F | H | 7.2 × 10²-3.3 × 10⁶ | 3.7 | 1.0 × 10³ |
| Ex.3 | | H | H | F | 7.2 × 10²-3.3 × 10⁶ | 3.7 | 1.0 × 10³ |
| Ex.4 | | F | F | H | 8.2 × 10²-3.7 × 10⁶ | 3.6 | 1.0 × 10³ |
| Ex.5 | | H | F | F | 8.2 × 10²-3.7 × 10⁶ | 3.6 | 1.0 × 10³ |
| Ex.6 | | F | H | F | 8.2 × 10²-3.7 × 10⁶ | 3.6 | 1.0 × 10³ |
| Ex.7 | | F | F | F | 9.1 × 10²-4.1 × 10⁶ | 3.5 | 9.7 × 10² |
| Ex.8 | | Cl | H | H | 8.1 × 10²-3.6 × 10⁶ | 3.9 | 1.1 × 10³ |
| Ex.9 | | H | Cl | H | 8.1 × 10²-3.6 × 10⁶ | 3.9 | 1.1 × 10³ |
| Ex.10 | | H | H | Cl | 8.1 × 10²-3.6 × 10⁶ | 3.9 | 1.1 × 10³ |
| Ex.11 | | Cl | Cl | H | 9.9 × 10²-4.4 × 10⁶ | 3.9 | 1.1 × 10³ |
| Ex.12 | | H | Cl | Cl | 9.9 × 10²-4.4 × 10⁶ | 3.9 | 1.1 × 10³ |
| Ex.13 | | Cl | H | Cl | 9.9 × 10²-4.4 × 10⁶ | 3.9 | 1.1 × 10³ |
| Ex.14 | | Cl | Cl | Cl | 1.2 × 10³-5.3 × 10⁶ | 3.9 | 1.1 × 10³ |
| Ex.15 | | Br | H | H | 1.0 × 10³-4.7 × 10⁶ | 3.9 | 1.1 × 10³ |
| Ex.16 | | H | Br | H | 1.0 × 10³-4.7 × 10⁶ | 3.9 | 1.1 × 10³ |
| Ex.17 | | H | H | Br | 1.0 × 10³-4.7 × 10⁶ | 3.9 | 1.1 × 10³ |
| Ex.18 | | Br | Br | H | 1.5 × 10³-6.5 × 10⁶ | 4.0 | 1.1 × 10³ |
| Ex.19 | | H | Br | Br | 1.5 × 10³-6.5 × 10⁶ | 4.0 | 1.1 × 10³ |
| Ex.20 | | Br | H | Br | 1.5 × 10³-6.5 × 10⁶ | 4.0 | 1.1 × 10³ |
| Ex.21 | | Br | Br | Br | 1.9 × 10³-8.4 × 10⁶ | 4.1 | 1.1 × 10³ |
| Ex.22 | | OH | H | H | 7.1 × 10²-3.2 × 10⁶ | 4.6 | 1.3 × 10³ |
| Ex.23 | | H | OH | H | 7.1 × 10²-3.2 × 10⁶ | 4.6 | 1.3 × 10³ |
| Ex.24 | | H | H | OH | 7.1 × 10²-3.2 × 10⁶ | 4.6 | 1.3 × 10³ |
| Ex.25 | | OH | OH | H | 8.0 × 10²-3.6 × 10⁶ | 5.2 | 1.4 × 10³ |
| Ex.26 | | H | OH | OH | 8.0 × 10²-3.6 × 10⁶ | 5.2 | 1.4 × 10³ |
| Ex.27 | | OH | H | OH | 8.0 × 10²-3.6 × 10⁶ | 5.2 | 1.4 × 10³ |
| Ex.28 | | OH | OH | OH | 8.8 × 10²-4.0 × 10⁶ | 5.7 | 1.6 × 10³ |

TABLE 2

| | Chemical structural | Substituent | | | Molecular | Dielectric | Capacitance |
|---|---|---|---|---|---|---|---|
| | formula | R₁ | R₂ | R₃ | weight | constant | (μF) |
| Ex.29 | 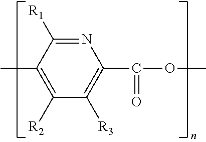 | CHO | H | H | 7.8 × 10²-3.5 × 10⁶ | 4.2 | 1.2 × 10³ |
| Ex.30 | | H | CHO | H | 7.8 × 10²-3.5 × 10⁶ | 4.2 | 1.2 × 10³ |
| Ex.31 | | H | H | CHO | 7.8 × 10²-3.5 × 10⁶ | 4.2 | 1.2 × 10³ |
| Ex.32 | | CHO | CHO | H | 9.2 × 10²-4.1 × 10⁶ | 4.5 | 1.2 × 10³ |
| Ex.33 | | H | CHO | CHO | 9.2 × 10²-4.1 × 10⁶ | 4.5 | 1.2 × 10³ |
| Ex.34 | | CHO | H | CHO | 9.2 × 10²-4.1 × 10⁶ | 4.5 | 1.2 × 10³ |
| Ex.35 | | CHO | CHO | CHO | 1.1 × 10³-4.8 × 10⁶ | 4.7 | 1.3 × 10³ |
| Ex.36 | | COOH | H | H | 8.6 × 10²-3.9 × 10⁶ | 4.2 | 1.2 × 10³ |
| Ex.37 | | H | COOH | H | 8.6 × 10²-3.9 × 10⁶ | 4.2 | 1.2 × 10³ |
| Ex.38 | | H | H | COOH | 8.6 × 10²-3.9 × 10⁶ | 4.2 | 1.2 × 10³ |
| Ex.39 | | COOH | COOH | H | 1.1 × 10³-4.9 × 10⁶ | 4.5 | 1.2 × 10³ |
| Ex.40 | | H | COOH | COOH | 1.1 × 10³-4.9 × 10⁶ | 4.5 | 1.2 × 10³ |
| Ex.41 | | COOH | H | COOH | 1.1 × 10³-4.9 × 10⁶ | 4.5 | 1.2 × 10³ |
| Ex.42 | | COOH | COOH | COOH | 1.3 × 10³-5.9 × 10⁶ | 4.7 | 1.3 × 10³ |
| Ex.43 | | CH₃ | H | H | 7.2 × 10²-3.2 × 10⁶ | 3.6 | 1.0 × 10³ |
| Ex.44 | | H | CH₃ | H | 7.2 × 10²-3.2 × 10⁶ | 3.6 | 1.0 × 10³ |
| Ex.45 | | H | H | CH₃ | 7.2 × 10²-3.2 × 10⁶ | 3.6 | 1.0 × 10³ |
| Ex.46 | | CH₂F | H | H | 8.0 × 10²-3.6 × 10⁶ | 3.5 | 9.7 × 10² |
| Ex.47 | | H | CH₂F | H | 8.0 × 10²-3.6 × 10⁶ | 3.6 | 1.0 × 10³ |
| Ex.48 | | H | H | CH₂F | 8.0 × 10²-3.6 × 10⁶ | 3.6 | 1.0 × 10³ |
| Ex.49 | | CHF₂ | H | H | 8.9 × 10²-4.0 × 10⁶ | 3.5 | 9.7 × 10² |
| Ex.50 | | H | CHF₂ | H | 8.9 × 10²-4.0 × 10⁶ | 3.5 | 9.7 × 10² |
| Ex.51 | | H | H | CHF₂ | 8.9 × 10²-4.0 × 10⁶ | 3.5 | 9.7 × 10² |

TABLE 3

| | Chemical structural | Substituent | | | | Dielectric | Capacitance |
|---|---|---|---|---|---|---|---|
| | formula | R₁ | R₂ | R₃ | Molecular weight | constant | (μF) |
| Ex.52 | 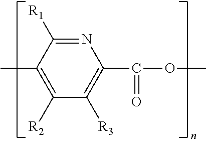 | CH₂Cl | H | H | 8.8 × 10²-4.0 × 10⁶ | 3.6 | 1.0 × 10³ |
| Ex.53 | | H | CH₂Cl | H | 8.8 × 10²-4.0 × 10⁶ | 3.6 | 1.0 × 10³ |
| Ex.54 | | H | H | CH₂Cl | 8.8 × 10²-4.0 × 10⁶ | 3.6 | 1.0 × 10³ |
| Ex.55 | | H | CH₂Cl | CH₂Cl | 1.1 × 10³-5.1 × 10⁶ | 3.5 | 9.7 × 10² |
| Ex.56 | | CH₂Cl | H | CH₂Cl | 1.1 × 10³-5.1 × 10⁶ | 3.5 | 9.7 × 10² |
| Ex.57 | | CH₂Cl | CH₂Cl | H | 1.1 × 10³-5.1 × 10⁶ | 3.5 | 9.7 × 10² |
| Ex.58 | | CH₂Cl | CH₂Cl | CH₂Cl | 1.4 × 10³-6.2 × 10⁶ | 3.5 | 9.7 × 10² |
| Ex.59 | | CHCl₂ | H | H | 1.1 × 10³-4.8 × 10⁶ | 3.7 | 1.0 × 10³ |
| Ex.60 | | H | CHCl₂ | H | 1.1 × 10³-4.8 × 10⁶ | 3.7 | 1.0 × 10³ |
| Ex.61 | | H | H | CHCl₂ | 1.1 × 10³-4.8 × 10⁶ | 3.7 | 1.0 × 10³ |
| Ex.62 | | H | CHCl₂ | CHCl₂ | 1.5 × 10³-6.7 × 10⁶ | 3.6 | 1.0 × 10³ |
| Ex.63 | | CHCl₂ | H | CHCl₂ | 1.5 × 10³-6.7 × 10⁶ | 3.6 | 1.0 × 10³ |
| Ex.64 | | CHCl₂ | CHCl₂ | H | 1.5 × 10³-6.7 × 10⁶ | 3.6 | 1.0 × 10³ |
| Ex.65 | | CHCl₂ | CHCl₂ | CHCl₂ | 1.9 × 10³-8.7 × 10⁶ | 3.6 | 1.0 × 10³ |
| Ex.66 | | CCl₃ | H | H | 1.2 × 10³-5.6 × 10⁶ | 3.8 | 1.1 × 10³ |
| Ex.67 | | H | CCl₃ | H | 1.2 × 10³-5,6 × 10⁶ | 3.8 | 1.1 × 10³ |
| Ex.68 | | H | H | CCl₃ | 1.2 × 10³-5.6 × 10⁶ | 3.8 | 1.1 × 10³ |
| Ex.69 | | H | CCl₃ | CCl₃ | 1.9 × 10³-8.3 × 10⁶ | 3.8 | 1.1 × 10³ |
| Ex.70 | | CCl₃ | H | CCl₃ | 1.9 × 10³-8.3 × 10⁶ | 3.8 | 1.1 × 10³ |
| Ex.71 | | CCl₃ | CCl₃ | H | 1.9 × 10³-8.3 × 10⁶ | 3.8 | 1.1 × 10³ |
| Ex.72 | | CCl₃ | CCl₃ | CCl₃ | 2.5 × 10³-1.1 × 10⁷ | 3.7 | 1.0 × 10³ |
| Ex.73 | | CH₂Br | H | H | 1.1 × 10³-5.0 × 10⁶ | 3.6 | 1.0 × 10³ |
| Ex.74 | | H | CH₂Br | H | 1.1 × 10³-5.0 × 10⁶ | 3.6 | 1.0 × 10³ |
| Ex.75 | | H | H | CH₂Br | 1.1 × 10³-5.0 × 10⁶ | 3.6 | 1.0 × 10³ |
| Ex.76 | | H | CH₂Br | CH₂Br | 1.6 × 10³-7.2 × 10⁶ | 3.5 | 9.7 × 10² |
| Ex.77 | | CH₂Br | H | CH₂Br | 1.6 × 10³-7.2 × 10⁶ | 3.5 | 9.7 × 10² |
| Ex.78 | | CH₂Br | CH₂Br | H | 1.6 × 10³-7.2 × 10⁶ | 3.5 | 9.7 × 10² |
| Ex.79 | | CH₂Br | CH₂Br | CH₂Br | 2.1 × 10³-9.4 × 10⁶ | 3.5 | 9.7 × 10² |

TABLE 4

| | Chemical structural | Substituent | | | Molecular | Dielectric | Capacitance |
|---|---|---|---|---|---|---|---|
| | formula | R₁ | R₂ | R₃ | Weight | constant | (μF) |
| Ex.80 | 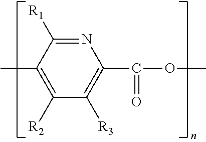 | CHBr₂ | H | H | 1.5 × 10³-6.9 × 10⁶ | 3.7 | 1.0 × 10³ |
| Ex.81 | | H | CHBr₂ | H | 1.5 × 10³-6.9 × 10⁶ | 3.7 | 1.0 × 10³ |
| Ex.82 | | H | H | CHBr₂ | 1.5 × 10³-6.9 × 10⁶ | 3.7 | 1.0 × 10³ |
| Ex.83 | | H | CHBr₂ | CHBr₂ | 2.4 × 10³-1.1 × 10⁷ | 3.7 | 1.0 × 10³ |
| Ex.84 | | CHBr₂ | H | CHBr₂ | 2.4 × 10³-1.1 × 10⁷ | 3.7 | 1.0 × 10³ |
| Ex.85 | | CHBr₂ | CHBr₂ | H | 2.4 × 10³-1.1 × 10⁷ | 3.7 | 1.0 × 10³ |
| Ex.86 | | CHBr₂ | CHBr₂ | CHBr₂ | 3.3 × 10³-1.5 × 10⁷ | 3.7 | 1.0 × 10³ |
| Ex.87 | | CBr₃ | H | H | 1.9 × 10³-8.7 × 10⁶ | 3.9 | 1.1 × 10³ |
| Ex.88 | | H | CBr₃ | H | 1.9 × 10³-8.7 × 10⁶ | 3.9 | 1.1 × 10³ |
| Ex.89 | | H | H | CBr₃ | 1.9 × 10³-8.7 × 10⁷ | 3.9 | 1.1 × 10³ |
| Ex.90 | | H | CBr₃ | CBr₃ | 3.2 × 10³-1.5 × 10⁷ | 3.9 | 1.1 × 10³ |
| Ex.91 | | CBr₃ | H | CBr₃ | 3.2 × 10³-1.5 × 10⁷ | 3.9 | 1.1 × 10³ |
| Ex.92 | | CBr₃ | CBr₃ | H | 3.2 × 10³-1.5 × 10⁷ | 3.9 | 1.1 × 10³ |
| Ex.93 | | CBr₃ | CBr₃ | CBr₃ | 4.5 × 10³-2.0 × 10⁷ | 3.9 | 1.1 × 10³ |
| Ex.94 | | CHOHCH₂OH | H | H | 9.2 × 10²-4.2 × 10⁶ | 4.6 | 1.3 × 10³ |
| Ex.95 | | H | CHOHCH₂OH | H | 9.2 × 10²-4.2 × 10⁶ | 4.6 | 1.3 × 10³ |
| Ex.96 | | H | H | CHOHCH₂OH | 9.2 × 10²-4.2 × 10⁶ | 4.6 | 1.3 × 10³ |
| Ex.97 | | H | CHOHCH₂OH | CHOHCH₂OH | 1.3 × 10³-5.6 × 10⁶ | 4.9 | 1.4 × 10³ |
| Ex.98 | | CHOHCH₂OH | H | CHOHCH₂OH | 1.3 × 10³-5.6 × 10⁶ | 4.9 | 1.4 × 10³ |
| Ex.99 | | CHOHCH₂OH | CHOHCH₂OH | H | 1.3 × 10³-5.6 × 10⁶ | 4.9 | 1.4 × 10³ |
| Ex.100 | | CHOHCH₂OH | CHOHCH₂OH | CHOHCH₂OH | 1.6 × 10³-7.1 × 10⁶ | 5.2 | 1.4 × 10³ |

TABLE 5

| | Chemical structural | Substituent | | | Dielectric | Capacitance |
|---|---|---|---|---|---|---|
| | formula | R₁ | R₂ | Molecular weight | constant | (μF) |
| Ex.101 | 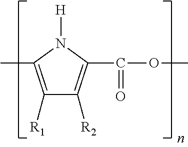 | F | H | 6.6 × 10²-3.0 × 10⁶ | 3.7 | 1.0 × 10³ |
| Ex.102 | | H | F | 6.6 × 10²-3.0 × 10⁶ | 3.7 | 1.0 × 10³ |
| Ex.103 | | F | F | 7.5 × 10²-3.4 × 10⁶ | 3.6 | 1.0 × 10³ |
| Ex.104 | | Cl | H | 7.5 × 10²-3.4 × 10⁶ | 3.9 | 1.1 × 10³ |
| Ex.105 | | H | Cl | 7.5 × 10²-3.4 × 10⁶ | 3.9 | 1.1 × 10³ |
| Ex.106 | | Cl | Cl | 9.3 × 10²-4.2 × 10⁶ | 3.9 | 1.1 × 10³ |
| Ex.107 | | Br | H | 9.8 × 10²-4.4 × 10⁶ | 3.9 | 1.1 × 10³ |
| Ex.108 | | H | Br | 9.8 × 10²-4.4 × 10⁶ | 3.9 | 1.1 × 10³ |
| Ex.109 | | Br | Br | 1.4 × 10³-6.2 × 10⁶ | 4.0 | 1.1 × 10³ |
| Ex.110 | | OH | H | 6.5 × 10²-2.9 × 10⁶ | 4.6 | 1.3 × 10³ |
| Ex.111 | | H | OH | 6.5 × 10²-2.9 × 10⁶ | 4.6 | 1.3 × 10³ |
| Ex.112 | | OH | OH | 7.3 × 10²-3.3 × 10⁶ | 5.3 | 1.5 × 10³ |
| Ex.113 | | CHO | H | 7.1 × 10²-3.2 × 10⁶ | 4.2 | 1.2 × 10³ |
| Ex.114 | | H | CHO | 7.1 × 10²-3.2 × 10⁶ | 4.2 | 1.2 × 10³ |
| Ex.115 | | CHO | CHO | 8.6 × 10²-3.9 × 10⁶ | 4.5 | 1.2 × 10³ |
| Ex.116 | | COOH | H | 8.0 × 10²-3.6 × 10⁶ | 4.3 | 1.2 × 10³ |
| Ex.117 | | H | COOH | 8.0 × 10²-3.6 × 10⁶ | 4.3 | 1.2 × 10³ |
| Ex.118 | | COOH | COOH | 8.6 × 10²-3.9 × 10⁶ | 4.5 | 1.2 × 10³ |
| Ex.119 | | CH₃ | H | 6.4 × 10²-2.9 × 10⁶ | 3.5 | 9.7 × 10² |
| Ex.120 | | H | CH₃ | 6.4 × 10²-2.9 × 10⁶ | 3.5 | 9.7 × 10² |
| Ex.121 | | CH₂F | H | 7.3 × 10²-3.3 × 10⁶ | 3.5 | 9.7 × 10² |
| Ex.122 | | H | CH₂F | 7.3 × 10²-3.3 × 10⁶ | 3.5 | 9.7 × 10² |

TABLE 6

| | Chemical structural | Substituent | | | Dielectric | Capacitance |
|---|---|---|---|---|---|---|
| | formula | R₁ | R₂ | Molecular weight | constant | (μF) |
| Ex.123 | 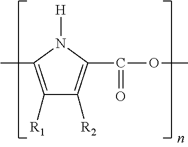 | CH₂Cl | H | 8.2 × 10²-3.7 × 10⁶ | 3.6 | 1.0 × 10³ |
| Ex.124 | | H | CH₂Cl | 8.2 × 10²-3.7 × 10⁶ | 3.6 | 1.0 × 10³ |
| Ex.125 | | CH₂Cl | CH₂Cl | 1.1 × 10³-4.8 × 10⁶ | 3.5 | 9.7 × 10² |
| Ex.126 | | CHCl₂ | H | 1.0 × 10³-4.5 × 10⁶ | 3.7 | 1.0 × 10³ |
| Ex.127 | | H | CHCl₂ | 1.0 × 10³-4.5 × 10⁶ | 3.7 | 1.0 × 10³ |
| Ex.128 | | CHCl₂ | CHCl₂ | 1.4 × 10³-6.4 × 10⁶ | 3.6 | 1.0 × 10³ |
| Ex.129 | | CCl₃ | H | 1.2 × 10³-5.3 × 10⁶ | 3.8 | 1.1 × 10³ |
| Ex.130 | | H | CCl₃ | 1.2 × 10³-5.3 × 10⁶ | 3.8 | 1.1 × 10³ |
| Ex.131 | | CCl₃ | CCl₃ | 1.8 × 10³-8.1 × 10⁶ | 3.7 | 1.0 × 10³ |
| Ex.132 | | CH₂Br | H | 1.1 × 10³-4.7 × 10⁶ | 3.6 | 1.0 × 10³ |
| Ex.133 | | H | CH₂Br | 1.1 × 10³-4.7 × 10⁶ | 3.6 | 1.0 × 10³ |
| Ex.134 | | CH₂Br | CH₂Br | 1.5 × 10³-6.9 × 10⁶ | 3.5 | 9.7 × 10² |
| Ex.135 | | CHBr₂ | H | 1.5 × 10³-6.6 × 10⁶ | 3.7 | 1.0 × 10³ |
| Ex.136 | | H | CHBr₂ | 1.5 × 10³-6.6 × 10⁶ | 3.7 | 1.0 × 10³ |
| Ex.137 | | CHBr₂ | CHBr₂ | 2.4 × 10³-1.1 × 10⁷ | 3.7 | 1.0 × 10³ |
| Ex.138 | | CBr₃ | H | 1.9 × 10³-8.4 × 10⁶ | 3.9 | 1.1 × 10³ |
| Ex.139 | | H | CBr₃ | 1.9 × 10³-8.4 × 10⁶ | 3.9 | 1.1 × 10³ |
| Ex.140 | | CBr₃ | CBr₃ | 3.2 × 10³-1.4 × 10⁷ | 3.9 | 1.1 × 10³ |
| Ex.141 | | CHOHCH₂OH | H | 8.8 × 10²-4.0 × 10⁶ | 4.6 | 1.3 × 10³ |
| Ex.142 | | H | CHOHCH₂OH | 8.8 × 10²-4.0 × 10⁶ | 4.6 | 1.3 × 10³ |
| Ex.143 | | CHOHCH₂OH | CHOHCH₂OH | 1.2 × 10²-5.4 × 10⁶ | 5.0 | 1.4 × 10³ |

TABLE 7

| | Chemical structural | Substituent | | | Dielectric | Capacitance |
|---|---|---|---|---|---|---|
| | formula | R₁ | R₂ | Molecular weight | constant | (μF) |
| Ex.144 | 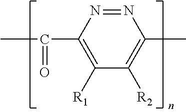 | F | H | 6.5 × 10²-2.9 × 10⁶ | 4.7 | 1.3 × 10³ |
| Ex.145 | | F | F | 7.4 × 10²-3.3 × 10⁶ | 4.5 | 1.2 × 10³ |
| Ex.146 | | Cl | H | 7.3 × 10²-3.3 × 10⁶ | 4.8 | 1.3 × 10³ |
| Ex.147 | | Cl | Cl | 7.3 × 10²-3.3 × 10⁶ | 4.7 | 1.3 × 10³ |
| Ex.148 | | Br | H | 9.6 × 10²-4.3 × 10⁶ | 4.8 | 1.3 × 10³ |
| Ex.149 | | Br | Br | 1.4 × 10³-6.2 × 10⁶ | 4.8 | 1.3 × 10³ |
| Ex.150 | | OH | H | 6.4 × 10²-2.9 × 10⁶ | 5.6 | 1.5 × 10³ |
| Ex.151 | | OH | OH | 7.2 × 10²-3.2 × 10⁶ | 6.2 | 1.7 × 10³ |
| Ex.152 | | CHO | H | 7.0 × 10²-3.1 × 10⁶ | 5.1 | 1.4 × 10³ |
| Ex.153 | | CHO | CHO | 8.4 × 10²-3.8 × 10⁶ | 5.3 | 1.5 × 10³ |
| Ex.154 | | COOH | H | 7.8 × 10²-3.5 × 10⁶ | 5.1 | 1.4 × 10³ |
| Ex.155 | | COOH | COOH | 1.0 × 10³-4.5 × 10⁶ | 5.2 | 1.4 × 10³ |
| Ex.156 | | CH₃ | H | 6.3 × 10²-2.8 × 10⁶ | 4.5 | 1.2 × 10³ |
| Ex.157 | | CH₃ | CH₃ | 7.0 × 10²-3.1 × 10⁶ | 4.2 | 1.2 × 10³ |
| Ex.158 | | C₂H₅ | H | 7.0 × 10²-3.1 × 10⁶ | 4.1 | 1.1 × 10³ |
| Ex.159 | | C₂H₅ | C₂H₅ | 8.4 × 10²-3.8 × 10⁶ | 3.7 | 1.0 × 10³ |
| Ex.160 | | CH₂F | H | 7.2 × 10²-3.2 × 10⁶ | 4.4 | 1.2 × 10³ |
| Ex.161 | | CH₂F | CH₂F | 8.9 × 10²-4.0 × 10⁶ | 4.1 | 1.1 × 10³ |

TABLE 8

| | Chemical structural | Substituent | | | Dielectric | Capacitance |
|---|---|---|---|---|---|---|
| | formula | R₁ | R₂ | Molecular weight | constant | (μF) |
| Ex.162 | 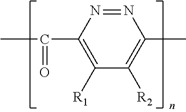 | CHF₂ | H | 8.1 × 10²-3.7 × 10⁶ | 4.3 | 1.2 × 10³ |
| Ex.163 | | CHF₂ | CHF₂ | 1.1 × 10³-4.8 × 10⁶ | 3.9 | 1.1 × 10³ |
| Ex.164 | | CF₃ | H | 9.1 × 10²-4.1 × 10⁶ | 4.1 | 1.1 × 10³ |
| Ex.165 | | CF₃ | CF₃ | 1.3 × 10³-5.7 × 10⁶ | 3.7 | 1.0 × 10³ |
| Ex.166 | | CH₂Cl | H | 8.0 × 10²-3.6 × 10⁶ | 4.4 | 1.2 × 10³ |
| Ex.167 | | CH₂Cl | CH₂Cl | 1.1 × 10³-4.8 × 10⁶ | 4.1 | 1.1 × 10³ |
| Ex.168 | | CHCl₂ | H | 9.8 × 10²-4.4 × 10⁶ | 4.4 | 1.2 × 10³ |
| Ex.169 | | CHCl₂ | CHCl₂ | 1.4 × 10³-6.4 × 10⁶ | 4.1 | 1.1 × 10³ |
| Ex.170 | | CCl₃ | H | 1.2 × 10³-5.2 × 10⁶ | 4.4 | 1.2 × 10³ |
| Ex.171 | | CCl₃ | CCl₃ | 1.8 × 10³-8.0 × 10⁶ | 4.2 | 1.2 × 10³ |
| Ex.172 | | CH₂Br | H | 1.0 × 10³-4.7 × 10⁶ | 4.3 | 1.2 × 10³ |
| Ex.173 | | CH₂Br | CH₂Br | 1.5 × 10³-6.8 × 10⁶ | 4.0 | 1.1 × 10³ |
| Ex.174 | | CHBr₂ | H | 1.4 × 10³-6.5 × 10⁶ | 4.4 | 1.2 × 10³ |
| Ex.175 | | CHBr₂ | CHBr₂ | 2.3 × 10³-1.1 × 10⁷ | 4.2 | 1.2 × 10³ |
| Ex.176 | | CBr₃ | H | 1.9 × 10³-8.4 × 10⁶ | 4.5 | 1.2 × 10³ |
| Ex.177 | | CBr₃ | CBr₃ | 3.2 × 10³-1.4 × 10⁷ | 4.3 | 1.2 × 10³ |
| Ex.178 | | CHOHCH₂OH | H | 8.6 × 10²-3.9 × 10⁶ | 5.3 | 1.5 × 10³ |
| Ex.179 | | CHOHCH₂OH | CHOHCH₂OH | 1.2 × 10³-5.3 × 10⁶ | 5.5 | 1.5 × 10³ |

TABLE 9

| | Chemical structural | Substituent | | | Dielectric | Capacitance |
|---|---|---|---|---|---|---|
| | formula | R₁ | R₂ | Molecular weight | constant | (μF) |
| Ex.180 | 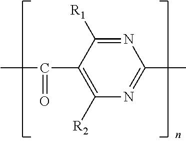 | F | H | 6.5 × 10²-2.9 × 10⁶ | 4.6 | 1.3 × 10³ |
| Ex.181 | | F | F | 7.4 × 10²-3.3 × 10⁶ | 4.4 | 1.2 × 10³ |
| Ex.182 | | Cl | H | 7.3 × 10²-3.3 × 10⁶ | 4.7 | 1.3 × 10³ |
| Ex.183 | | Cl | Cl | 7.3 × 10²-3.3 × 10⁶ | 4.6 | 1.3 × 10³ |
| Ex.184 | | Br | H | 9.6 × 10²-4.3 × 10⁶ | 4.7 | 1.3 × 10³ |
| Ex.185 | | Br | Br | 1.4 × 10³-6.2 × 10⁶ | 4.7 | 1.3 × 10³ |
| Ex.186 | | OH | H | 6.4 × 10²-2.9 × 10⁶ | 5.5 | 1.5 × 10³ |
| Ex.187 | | OH | OH | 7.2 × 10²-3.2 × 10⁶ | 6.1 | 1.7 × 10³ |
| Ex.188 | | CHO | H | 7.0 × 10²-3.1 × 10⁶ | 5.0 | 1.4 × 10³ |
| Ex.189 | | CHO | CHO | 8.4 × 10²-3.8 × 10⁶ | 5.1 | 1.4 × 10³ |
| Ex.190 | | COOH | H | 7.8 × 10²-3.5 × 10⁶ | 5.0 | 1.4 × 10³ |
| Ex.191 | | COOH | COOH | 1.0 × 10³-4.5 × 10⁶ | 5.1 | 1.4 × 10³ |
| Ex.192 | | CH₃ | H | 6.3 × 10²-2.8 × 10⁶ | 4.4 | 1.2 × 10³ |
| Ex.193 | | CH₃ | CH₃ | 7.0 × 10²-3.1 × 10⁶ | 4.1 | 1.1 × 10³ |
| Ex.194 | | C₂H₅ | H | 7.0 × 10²-3.1 × 10⁶ | 4.0 | 1.1 × 10³ |
| Ex.195 | | C₂H₅ | C₂H₅ | 8.4 × 10²-3.8 × 10⁶ | 3.6 | 1.0 × 10³ |
| Ex.196 | | CH₂F | H | 7.2 × 10²-3.2 × 10⁶ | 4.3 | 1.2 × 10³ |
| Ex.197 | | CH₂F | CH₂F | 8.9 × 10²-4.0 × 10⁶ | 4.0 | 1.1 × 10³ |

TABLE 10

| | Chemical structural | Substituent | | | Dielectric | Capacitance |
|---|---|---|---|---|---|---|
| | formula | R₁ | R₂ | Molecular weight | constant | (μF) |
| Ex.198 | 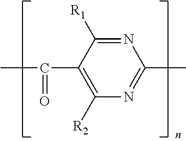 | CHF₂ | H | 8.1 × 10²-3.7 × 10⁶ | 4.1 | 1.1 × 10³ |
| Ex.199 | | CHF₂ | CHF₂ | 1.1 × 10³-4.8 × 10⁶ | 3.8 | 1.1 × 10³ |
| Ex.200 | | CF₃ | H | 9.1 × 10²-4.1 × 10⁶ | 4.0 | 1.1 × 10³ |
| Ex.201 | | CF₃ | CF₃ | 1.3 × 10³-5.7 × 10⁶ | 3.6 | 1.0 × 10³ |
| Ex.202 | | CH₂Cl | H | 8.0 × 10²-3.6 × 10⁶ | 4.3 | 1.2 × 10³ |
| Ex.203 | | CH₂Cl | CH₂Cl | 1.1 × 10³-4.8 × 10⁶ | 4.0 | 1.1 × 10³ |
| Ex.204 | | CHCl₂ | H | 9.8 × 10²-4.4 × 10⁶ | 4.3 | 1.2 × 10³ |
| Ex.205 | | CHCl₂ | CHCl₂ | 1.4 × 10³-6.4 × 10⁶ | 4.1 | 1.1 × 10³ |
| Ex.206 | | CCl₃ | H | 1.2 × 10³-5.2 × 10⁶ | 4.3 | 1.2 × 10³ |
| Ex.207 | | CCl₃ | CCl₃ | 1.8 × 10³-8.0 × 10⁶ | 4.1 | 1.1 × 10³ |
| Ex.208 | | CH₂Br | H | 1.0 × 10³-4.7 × 10⁶ | 4.2 | 1.2 × 10³ |
| Ex.209 | | CH₂Br | CH₂Br | 1.5 × 10³-6.8 × 10⁶ | 3.9 | 1.1 × 10³ |
| Ex.210 | | CHBr₂ | H | 1.4 × 10³-6.5 × 10⁶ | 4.3 | 1.2 × 10³ |
| Ex.211 | | CHBr₂ | CHBr₂ | 2.3 × 10³-1.1 × 10⁷ | 4.1 | 1.1 × 10³ |
| Ex.212 | | CBr₃ | H | 1.9 × 10³-8.4 × 10⁶ | 4.4 | 1.2 × 10³ |
| Ex.213 | | CBr₃ | CBr₃ | 3.2 × 10³-1.4 × 10⁷ | 4.3 | 1.2 × 10³ |
| Ex.214 | | CHOHCH₂OH | H | 8.6 × 10²-3.9 × 10⁶ | 5.2 | 1.4 × 10³ |
| Ex.215 | | CHOHCH₂OH | CHOHCH₂OH | 1.2 × 10³-5.3 × 10⁶ | 5.5 | 1.5 × 10³ |

A synthesis route for a high-molecular compound according to this embodiment will be described.

A synthesis route for a high-molecular compound having the constitutional unit (UA) expressed by the chemical structural formula (A) will be described.

The high-molecular compound having the constitutional unit (UA) has a constitutional unit derived from a monomer synthesized by using the following monomer (MA) as a starting material:

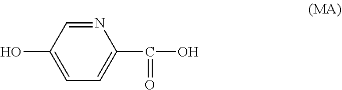

A synthesis route for a high-molecular compound having a constitutional unit (UA) with a heterocyclic ring, to which C1 is bonded as a substituent, will be described.

By allowing a monomer (MA) as a starting material to react with Cl₂, a reaction product containing a monomer (MA-C1) with a heterocyclic ring, to which C1 is bonded as a substituent, may be produced. It is preferable that this reaction product be classified as appropriate to recover the target monomer. The monomer (MA-C1) herein refers to at least one monomer selected from the group consisting of monomers (MA-C1-1) through (MA-C1-7). As used herein, to “classify” refers to the operation of separating and recovering, by purification, for example, a monomer to be obtained as a target product from a reaction product. Also, regarding each reaction shown in the description of the synthetic route, the production ratio of each monomer during the reaction may be appropriately optimized by adjusting the reaction duration and reaction temperature. As an example, a reaction formula for synthesizing a monomer (MA-C1-1) from the monomer (MA) and the respective structures of the monomers (MA-C1-1) through (MA-C1-7) are shown below:

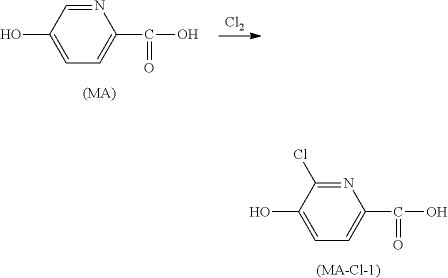

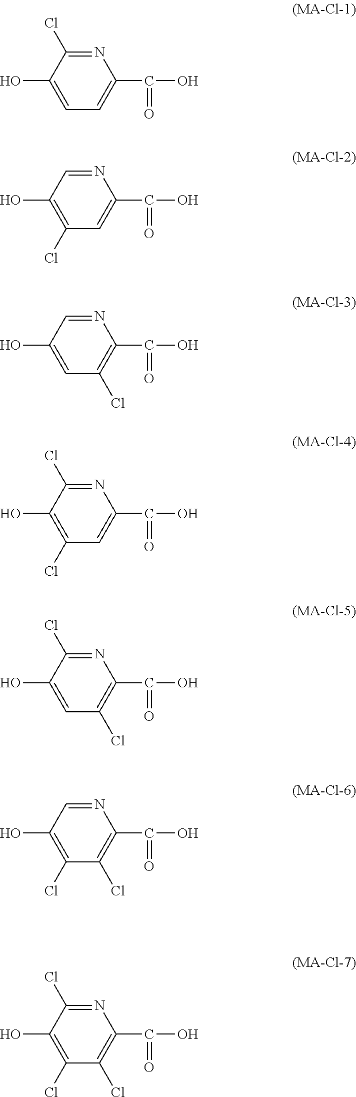

By subjecting the monomer (MA-C1) to ester polymerization, a high-molecular compound having a constitutional unit (UA) with a heterocyclic ring, to which C1 is bonded as a substituent, may be produced. As used herein, “ester polymerization” refers to polymerization by dehydration condensation between an alcohol and carboxylic acid. As an example, a reaction formula for synthesizing the target high-molecular compound from the monomer (MA-C1-1) is shown below.

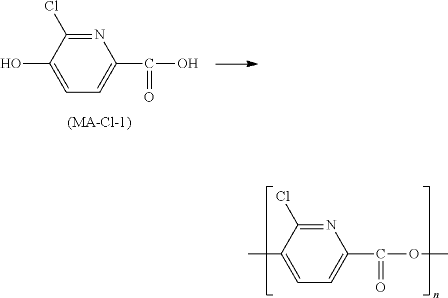

### Ester Polymerization

A synthesis route for a high-molecular compound having a constitutional unit (UA) with a heterocyclic ring, to which Br is bonded as a substituent, will be described.

By allowing a monomer (MA) as a starting material to react with Br₂, a reaction product containing a monomer (MA-Br) with a heterocyclic ring, to which Br is bonded as a substituent, may be produced. It is preferable that this reaction product be classified as appropriate to recover the target monomer. The monomer (MA-Br) herein refers to at least one monomer selected from the group consisting of monomers (MA-Br-1) through (MA-Br-7). In the monomers (MA-Br-1) through (MA-Br-7), Br is substituted for C1 in the monomers (MA-C1-1) through (MA-C1-7), respectively. As an example, a reaction formula for synthesizing the monomer (MA-Br-1) from the monomer (MA) is shown below.

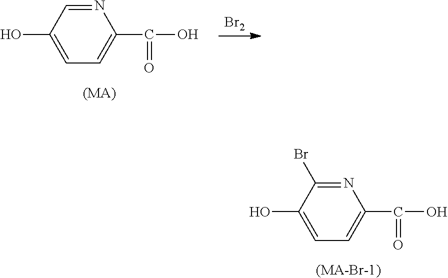

By subjecting the monomer (MA-Br) to ester polymerization, a high-molecular compound having a constitutional unit (UA) with a heterocyclic ring, to which Br is bonded as a substituent, may be produced. As an example, a reaction formula for synthesizing the target high-molecular compound from the monomer (MA-Br-1) is shown below.

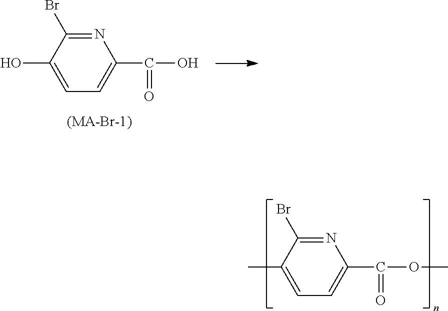

### Ester Polymerization

A synthesis route for a high-molecular compound having a constitutional unit (UA) with a heterocyclic ring, to which F is bonded as a substituent, will be described.

By allowing the monomer (MA-C1) produced by the above-described method and KF to react with each other in a sulfolane solvent, a reaction product containing a monomer (MA-F) with a heterocyclic ring, to which F is bonded as a substituent, may be produced. It is preferable that this reaction product be classified as appropriate to recover the target monomer. The monomer (MA-F) having the heterocyclic ring, to which F is bonded as a substituent, refers to at least one monomer selected from the group consisting of monomers (MA-F-1) through (MA-F-7). In the monomers (MA-F-1) through (MA-F-7), F is substituted for C1 in the monomers (MA-C1-1) through (MA-C1-7), respectively. As an example, a reaction formula for synthesizing the monomer (MA-F-1) from the monomer (MA-C1-1) is shown below.

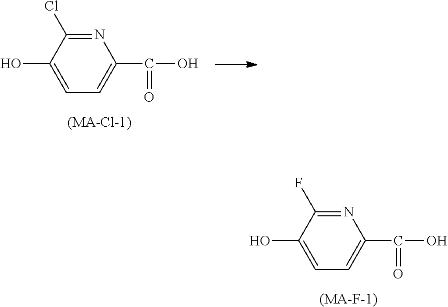

### KF/Sulfolane

By subjecting the monomer (MA-F) with the heterocyclic ring, to which F is bonded as a substituent, to ester polymerization, a high-molecular compound having a constitutional unit (UA) with the heterocyclic ring, to which F is bonded as a substituent, may be produced. As an example, a reaction formula for synthesizing the target high-molecular compound from the monomer (MA-F-1) is shown below.

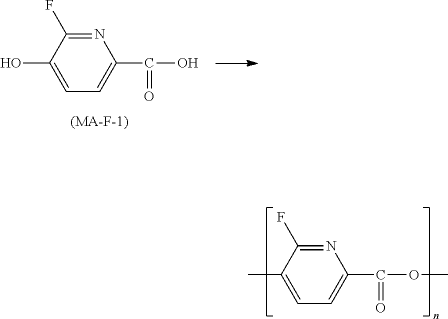

### Ester Polymerization

A synthesis route for a high-molecular compound having a constitutional unit (UA) with a heterocyclic ring, to which OH is bonded as a substituent, will be described.

By allowing the monomer (MA-C1) and NaOH to react with each other in water, a reaction product containing a monomer (MA-OH) with the heterocyclic ring, to which OH is bonded as a substituent, may be produced. It is preferable that this reaction product be classified as appropriate to recover the target monomer. The monomer (MA-OH) herein refers to at least one monomer selected from the group consisting of monomers (MA-OH-1) through (MA-OH-7). In the monomers (MA-OH-1) through (MA-OH-7), OH is substituted for C1 in the monomers (MA-C1-1) through (MA-C1-7), respectively. As an example, a reaction formula for synthesizing the monomer (MA-OH-1) from the monomer (MA-C1-1) is shown below.

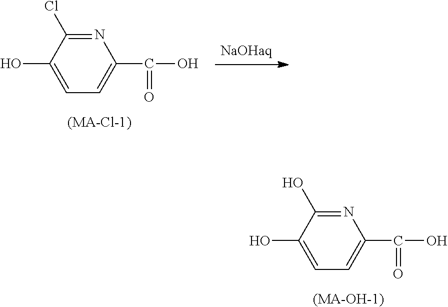

By allowing the monomer (MA-OH) with the heterocyclic ring, to which OH is bonded as a substituent, to react with acetyl chloride, a reaction product containing a monomer (MA-CH₃COO) with a heterocyclic ring, to which CH₃COO is bonded as a substituent, may be produced. It is preferable that this reaction product be classified as appropriate to recover the target monomer. The monomer (MA-CH₃COO) herein refers to at least one monomer selected from the group consisting of monomers (MA-CH₃COO-1) through (MA-CH₃COO-7). In the monomers (MA-CH₃COO-1) through (MA-CH₃COO-7), CH₃COO is substituted for C1 in the monomers (MA-C1-1) through (MA-C1-7), respectively. As an example, a reaction formula for synthesizing the monomer (MA-CH₃COO-1) from the monomer (MA-OH-1) is shown below.

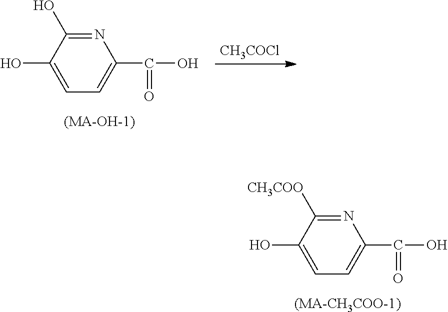

A high-molecular compound produced by subjecting the monomer (MA-CH₃COO) to ester polymerization is allowed to react with NaOH in a water/ethanol solvent to desorb an acetyl group. As a result, a high-molecular compound, having a constitutional unit (UA) with a heterocyclic ring, to which OH is bonded as a substituent, may be produced. As an example, a reaction formula for synthesizing the target high-molecular compound from the monomer (MA-CH₃COO-1) is shown below.

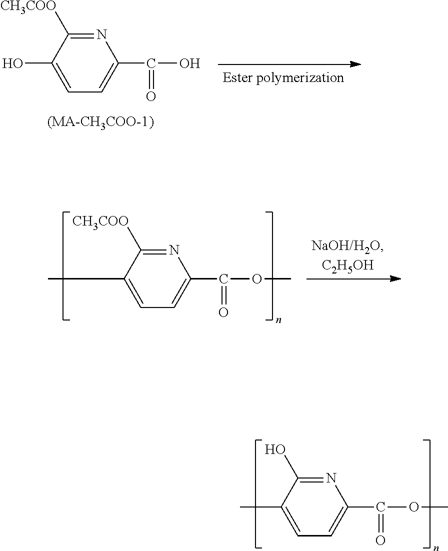

A synthesis route for a high-molecular compound having a constitutional unit (UA) with a heterocyclic ring, to which CH₃ is bonded as a substituent, will be described.

By using AlCl₃ as a catalyst to allow the monomer (MA) and CH₃C1 to react with each other, a reaction product containing a monomer (MA-CH₃) with the heterocyclic ring, to which CH₃ is bonded as a substituent, may be produced. It is preferable that this reaction product be classified as appropriate to recover the target monomer. The monomer (MA-CH₃) herein refers to at least one monomer selected from the group consisting of monomers (MA-CH₃-1) through (MA-CH₃-7). In the monomers (MA-CH₃-1) through (MA-CH₃-7), CH₃ is substituted for C1 in the monomers (MA-C1-1) through (MA-C1-7), respectively. As an example, a reaction formula for synthesizing the monomer (MA-CH₃-1) from the monomer (MA) is shown below.

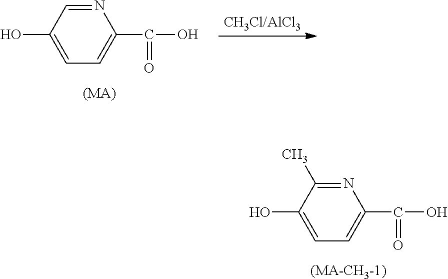

By subjecting the monomer (MA-CH₃) having the heterocyclic ring, to which CH₃ is bonded as a substituent, to ester polymerization, a high-molecular compound having a constitutional unit (UA) with the heterocyclic ring, to which CH₃ is bonded as a substituent, is produced. As an example, a reaction formula for synthesizing the target high-molecular compound from the monomer (MA-CH₃-1) is shown below.

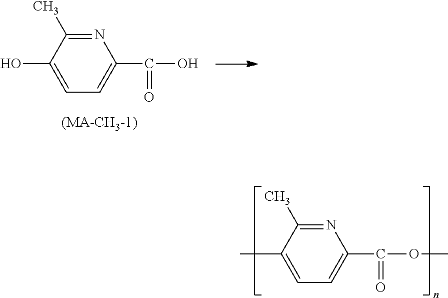

### Ester Polymerization

A synthesis route for a high-molecular compound having a constitutional unit (UA) with a heterocyclic ring, to which CH₂F is bonded as a substituent, will be described.

By allowing the monomer (MA-CH₃) to react with F₂, a reaction product containing a monomer (MA-CH₂F) with the heterocyclic ring, to which CH₂F is bonded as a substituent, may be produced. It is preferable that this reaction product be classified as appropriate to recover the target monomer. The monomer (MA-CH₂F) herein refers to at least one monomer selected from the group consisting of monomers (MA-CH₂F-1) through (MA-CH₂F-7). In the monomers (MA-CH₂F-1) through (MA-CH₂F-7), CH₂F is substituted for C1 in the monomers (MA-C1-1) through (MA-C1-7), respectively. As an example, a reaction formula for synthesizing the monomer (MA-CH₂F-1) from the monomer (MA-CH₃-1) is shown below.

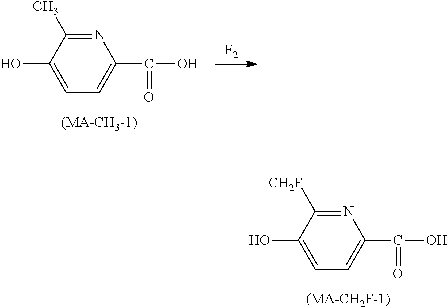

By subjecting the monomer (MA-CH₂F) to ester polymerization, a high-molecular compound having a constitutional unit (UA) with the heterocyclic ring, to which CH₂F is bonded as a substituent, may be produced. As an example, a reaction formula for synthesizing the target high-molecular compound from the monomer (MA-CH₂F-1) is shown below.

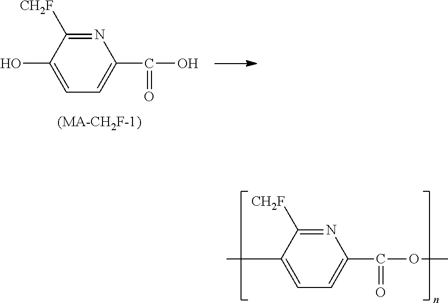

### Ester Polymerization

A synthesis route for a high-molecular compound having a constitutional unit (UA) with a heterocyclic ring, to which CHF₂ is bonded as a substituent, will be described.

By allowing the monomer (MA-CH₂F) to react with F₂, a reaction product containing a monomer (MA-CHF₂) with the heterocyclic ring, to which CHF₂ is bonded as a substituent, may be produced. It is preferable that this reaction product be classified as appropriate to recover the target monomer. The monomer (MA-CHF₂) herein refers to at least one monomer selected from the group consisting of monomers (MA-CHF₂-1) through (MA-CHF₂-7). In the monomers (MA-CHF₂-1) through (MA-CHF₂-7), CHF₂ is substituted for C1 in the monomers (MA-C1-1) through (MA-C1-7), respectively. As an example, a reaction formula for synthesizing the monomer (MA-CHF₂-1) from the monomer (MA-CH₂F-1) is shown below.

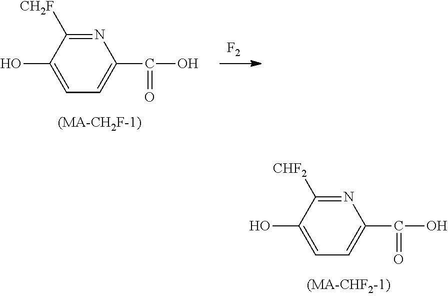

By subjecting the monomer (MA-CHF₂) to ester polymerization, a high-molecular compound having a constitutional unit (UA) with the heterocyclic ring, to which CHF₂ is bonded as a substituent, may be produced. As an example, a reaction formula for synthesizing the target high-molecular compound from the monomer (MA-CHF₂-1) is shown below.

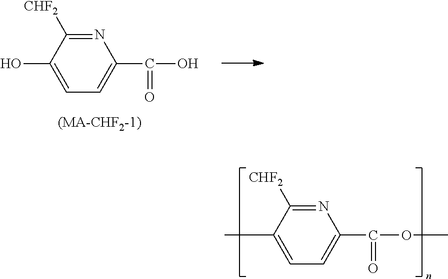

### Ester Polymerization

A synthesis route for a high-molecular compound having a constitutional unit (UA) with a heterocyclic ring, to which CH₂Cl is bonded as a substituent, will be described.

By allowing the monomer (MA-CH₃) to react with Cl₂, a reaction product containing a monomer (MA-CH₂Cl) with the heterocyclic ring, to which CH₂Cl is bonded as a substituent, may be produced. It is preferable that this reaction product be classified as appropriate to recover the target monomer. The monomer (MA-CH₂Cl) herein refers to at least one monomer selected from the group consisting of monomers (MA-CH₂Cl-1) through (MA-CH₂Cl-7). In the monomers (MA-CH₂Cl-1) through (MA-CH₂Cl-7), CH₂Cl is substituted for C1 in the monomers (MA-C1-1) through (MA-C1-7), respectively. As an example, a reaction formula for synthesizing the monomer (MA-CH₂Cl-1) from the monomer (MA-CH₃-1) is shown below.

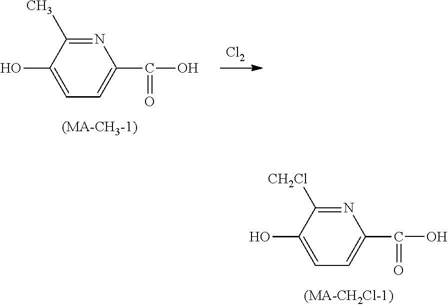

By subjecting the monomer (MA-CH₂Cl) to ester polymerization, a high-molecular compound having a constitutional unit (UA) with the heterocyclic ring, to which CH₂Cl is bonded as a substituent, may be produced. As an example, a reaction formula for synthesizing the target high-molecular compound from the monomer (MA-CH₂Cl-1) is shown below.

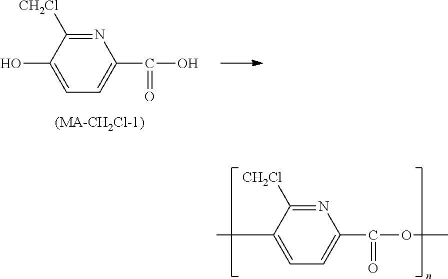

### Ester Polymerization

A synthesis route for a high-molecular compound having a constitutional unit (UA) with a heterocyclic ring, to which CHCl₂ is bonded as a substituent, will be described.

By allowing the monomer (MA-CH₂Cl) to react with Cl₂, a reaction product containing a monomer (MA-CHCl₂) with the heterocyclic ring, to which CHCl₂ is bonded as a substituent, may be produced. It is preferable that this reaction product be classified as appropriate to recover the target monomer. The monomer (MA-CHCl₂) herein refers to at least one monomer selected from the group consisting of monomers (MA-CHCl₂-1) through (MA-CHCl₂-7). In the monomers (MA-CHCl₂-1) through (MA-CHCl₂-7), CHCl₂ is substituted for C1 in the monomers (MA-C1-1) through (MA-C1-7), respectively. As an example, a reaction formula for synthesizing the monomer (MA-CHCl₂-1) from the monomer (MA-CH₂Cl-1) is shown below.

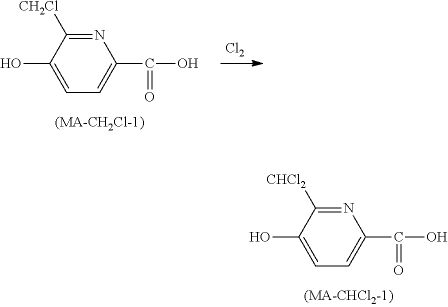

By subjecting the monomer (MA-CHCl₂) to ester polymerization, a high-molecular compound having a constitutional unit (UA) with the heterocyclic ring, to which CHCl₂ is bonded as a substituent, may be produced. As an example, a reaction formula for synthesizing the target high-molecular compound from the monomer (MA-CHCl₂-1) is shown below.

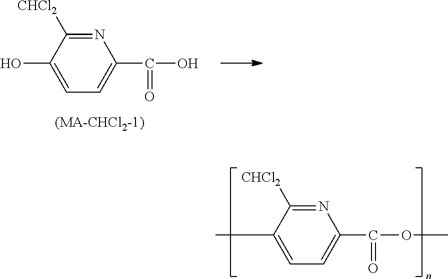

### Ester Polymerization

A synthesis route for a high-molecular compound having a constitutional unit (UA) with a heterocyclic ring, to which CCl₃ is bonded as a substituent, will be described.

By allowing the monomer (MA-CHCl₂) to react with Cl₂, a reaction product containing a monomer (MA-CCl₃) with the heterocyclic ring, to which CCl₃ is bonded as a substituent, may be produced. It is preferable that this reaction product be classified as appropriate to recover the target monomer. The monomer (MA-CCl₃) herein refers to at least one monomer selected from the group consisting of monomers (MA-CCl₃-1) through (MA-CCl₃-7). In the monomers (MA-CCl₃-1) through (MA-CCl₃-7), CCl₃ is substituted for C1 in the monomers (MA-C1-1) through (MA-C1-7), respectively. As an example, a reaction formula for synthesizing the monomer (MA-CCl₃-1) from the monomer (MA-CHCl₂-1) is shown below.

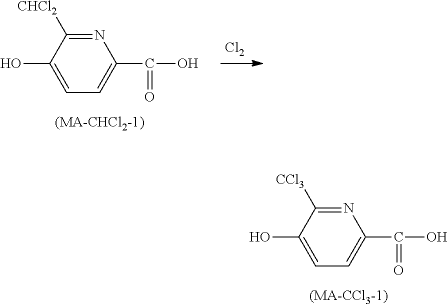

By subjecting the monomer (MA-CCl₃) to ester polymerization, a high-molecular compound having a constitutional unit (UA) with the heterocyclic ring, to which CCl₃ is bonded as a substituent, may be produced. As an example, a reaction formula for synthesizing the target high-molecular compound from the monomer (MA-CCl₃-1) is shown below.

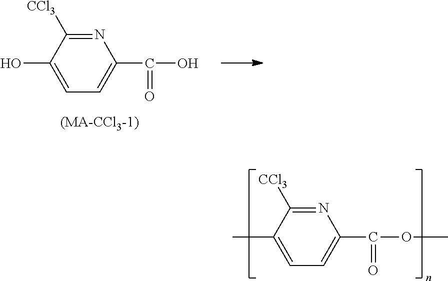

### Ester Polymerization

A synthesis route for a high-molecular compound having a constitutional unit (UA) with a heterocyclic ring, to which CH₂Br is bonded as a substituent, will be described.

By allowing the monomer (MA-CH₃) to react with Br₂, a reaction product containing a monomer (MA-CH₂Br) with the heterocyclic ring, to which CH₂Br is bonded as a substituent, may be produced. It is preferable that this reaction product be classified as appropriate to recover the target monomer. The monomer (MA-CH₂Br) herein refers to at least one monomer selected from the group consisting of monomers (MA-CH₂Br-1) through (MA-CH₂Br-7). In the monomers (MA-CH₂Br-1) through (MA-CH₂Br-7), CH₂Br is substituted for C1 in the monomers (MA-C1-1) through (MA-C1-7), respectively. As an example, a reaction formula for synthesizing the monomer (MA-CH₂Br-1) from the monomer (MA-CH₃-1) is shown below.

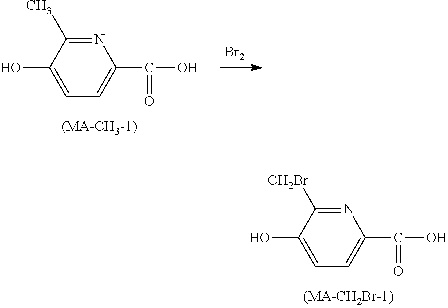

By subjecting the monomer (MA-CH₂Br) to ester polymerization, a high-molecular compound having a constitutional unit (UA) with the heterocyclic ring, to which CH₂Br is bonded as a substituent, may be produced. As an example, a reaction formula for synthesizing the target high-molecular compound from the monomer (MA-CH₂Br-1) is shown below.

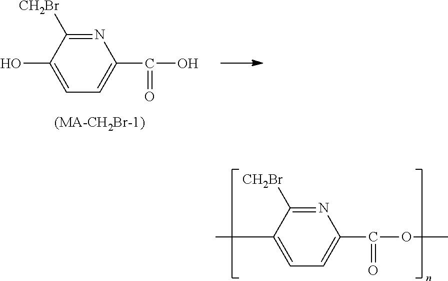

### Ester Polymerization

A synthesis route for a high-molecular compound having a constitutional unit (UA) with a heterocyclic ring, to which CHBr₂ is bonded as a substituent, will be described.

By allowing the monomer (MA-CH₂Br) to react with Br₂, a reaction product containing a monomer (MA-CHBr₂) with the heterocyclic ring, to which CHBr₂ is bonded as a substituent, may be produced. It is preferable that this reaction product be classified as appropriate to recover the target monomer. The monomer (MA-CHBr₂) herein refers to at least one monomer selected from the group consisting of monomers (MA-CHBr₂-1) through (MA-CHBr₂-7). In the monomers (MA-CHBr₂-1) through (MA-CHBr₂-7), CHBr₂ is substituted for C1 in the monomers (MA-C1-1) through (MA-C1-7), respectively. As an example, a reaction formula for synthesizing the monomer (MA-CHBr₂-1) from the monomer (MA-CH₂Br-1) is shown below.

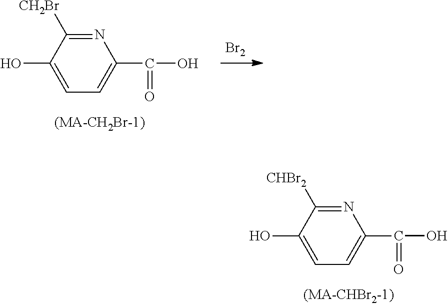

By subjecting the monomer (MA-CHBr₂) to ester polymerization, a high-molecular compound having a constitutional unit (UA) with the heterocyclic ring, to which CHBr₂ is bonded as a substituent, may be produced. As an example, a reaction formula for synthesizing the target high-molecular compound from the monomer (MA-CHBr₂-1) is shown below.

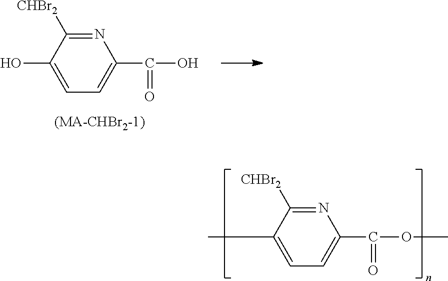

### Ester Polymerization

A synthesis route for a high-molecular compound having a constitutional unit (UA) with a heterocyclic ring, to which CBr₃ is bonded as a substituent, will be described.

By allowing the monomer (MA-CHBr₂) to react with Br₂, a reaction product containing a monomer (MA-CBr₃) with the heterocyclic ring, to which CBr₃ is bonded as a substituent, may be produced. It is preferable that this reaction product be classified as appropriate to recover the target monomer. The monomer (MA-CBr₃) herein refers to at least one monomer selected from the group consisting of monomers (MA-CBr₃-1) through (MA-CBr₃-7). In the monomers (MA-CBr₃-1) through (MA-CBr₃-7), CBr₃ is substituted for C1 in the monomers (MA-C1-1) through (MA-C1-7), respectively. As an example, a reaction formula for synthesizing the monomer (MA-CBr₃-1) from the monomer (MA-CHBr₂-1) is shown below.

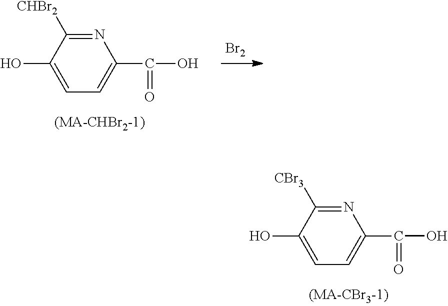

By subjecting the monomer (MA-CBr₃) to ester polymerization, a high-molecular compound having a constitutional unit (UA) with the heterocyclic ring, to which CBr₃ is bonded as a substituent, may be produced. As an example, a reaction formula for synthesizing the target high-molecular compound from the monomer (MA-CBr₃-1) is shown below.

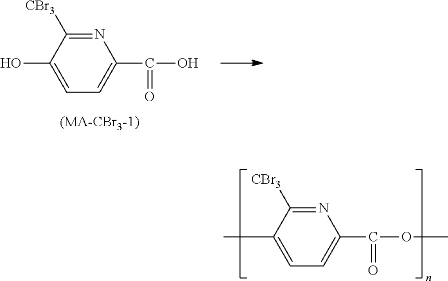

### Ester Polymerization

A synthesis route for a high-molecular compound having a constitutional unit (UA) with a heterocyclic ring, to which CHO is bonded as a substituent, will be described.

By allowing the monomer (MA-CH₂Cl) and NaOH to react with each other in water, a reaction product containing a monomer (MA-CH₂OH) with a heterocyclic ring, to which CH₂OH is bonded as a substituent, may be produced. It is preferable that this reaction product be classified as appropriate to recover the target monomer. The monomer (MA-CH₂OH) herein refers to at least one monomer selected from the group consisting of monomers (MA-CH₂OH-1) through (MA-CH₂OH-7). In the monomers (MA-CH₂OH-1) through (MA-CH₂OH-7), CH₂OH is substituted for C1 in the monomers (MA-C1-1) through (MA-C1-7), respectively. As an example, a reaction formula for synthesizing the monomer (MA-CH₂OH-1) from the monomer (MA-CH₂Cl-1) is shown below.

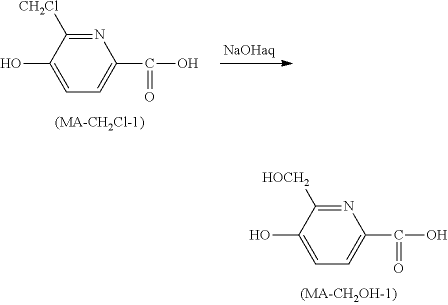

By allowing the monomer (MA-CH₂OH) and pyridinium chlorochromate (hereinafter referred to as “PCC”) to react with each other in a methylene chloride solvent, a reaction product containing a monomer (MA-CHO) with the heterocyclic ring, to which CHO is bonded as a substituent, may be produced. It is preferable that this reaction product be classified as appropriate to recover the target monomer. The monomer (MA-CHO) herein refers to at least one monomer selected from the group consisting of monomers (MA-CHO-1) through (MA-CHO-7). In the monomers (MA-CHO-1) through (MA-CHO-7), CHO is substituted for C1 in the monomers (MA-C1-1) through (MA-C1-7), respectively. As an example, a reaction formula for synthesizing the monomer (MA-CHO-1) from the monomer (MA-CH₂OH-1) is shown below.

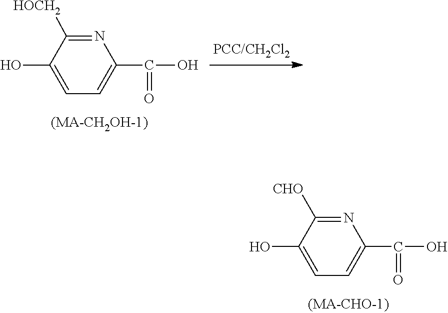

By subjecting the monomer (MA-CHO) to ester polymerization, a high-molecular compound having a constitutional unit (UA) with the heterocyclic ring, to which CHO is bonded as a substituent, may be produced. As an example, a reaction formula for synthesizing the target high-molecular compound from the monomer (MA-CHO-1) is shown below.

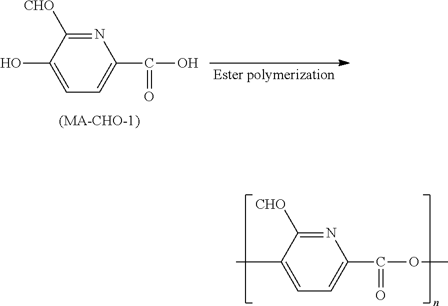

A synthesis route for a high-molecular compound having a constitutional unit (UA) with a heterocyclic ring, to which COOH is bonded as a substituent, will be described.

By allowing the monomer (MA-CH₂OH) to react with a mixture of potassium dichromate and an aqueous solution of sulfuric acid, a reaction product containing a monomer (MA-COOH) with the heterocyclic ring, to which COOH is bonded as a substituent, may be produced. It is preferable that this reaction product be classified as appropriate to recover the target monomer. The monomer (MA-COOH) herein refers to at least one monomer selected from the group consisting of monomers (MA-COOH-1) through (MA-COOH-7). In the monomers (MA-COOH-1) through (MA-COOH-7), COOH is substituted for C1 in the monomers (MA-C1-1) through (MA-C1-7), respectively. As an example, a reaction formula for synthesizing the monomer (MA-COOH-1) from the monomer (MA-CH₂OH-1) is shown below.

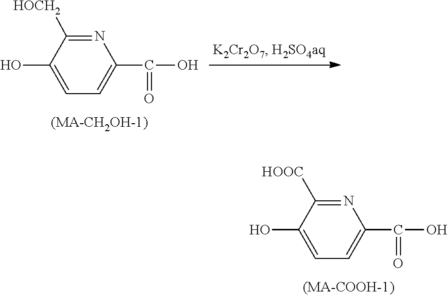

By allowing the monomer (MA-COOH) and thionyl chloride to react with each other in a methanol solvent, a reaction product containing a monomer (MA-COOCH₃) with a heterocyclic ring, to which COOCH₃ is bonded as a substituent, may be produced. It is preferable that this reaction product be classified as appropriate to recover the target monomer. The monomer (MA-COOCH₃) herein refers to at least one monomer selected from the group consisting of monomers (MA-COOCH₃-1) through (MA-COOCH₃-7). In the monomers (MA-COOCH₃-1) through (MA-COOCH₃-7), COOCH₃ is substituted for C1 in the monomers (MA-C1-1) through (MA-C1-7), respectively. As an example, a reaction formula for synthesizing the monomer (MA-COOCH₃-1) from the monomer (MA-COOH-1) is shown below.

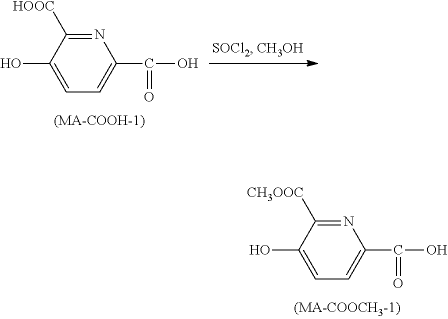

A high-molecular compound produced by subjecting the monomer (MA-COOCH₃) to ester polymerization is allowed to react with NaOH in a water/ethanol solvent, and then washed with hydrochloric acid, thereby obtaining a high-molecular compound having a constitutional unit (UA) with a heterocyclic ring, to which COOH is bonded as a substituent. As an example, a reaction formula for synthesizing the target high-molecular compound from the monomer (MA-COOCH₃-1) is shown below.

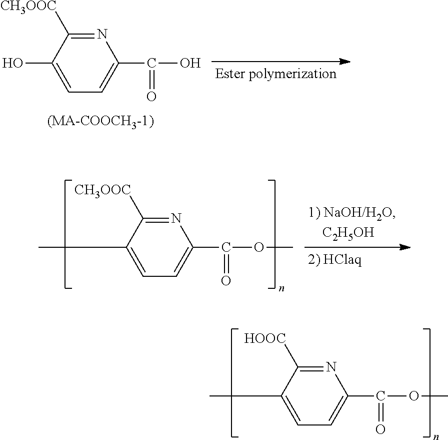

A synthesis route for a high-molecular compound having a constitutional unit (UA) with a heterocyclic ring, to which CHOHCH₂OH is bonded as a substituent, will be described.

By allowing the monomer (MA) to react with C₂H₅Li in a toluene solvent, a reaction product containing a monomer (MA-C₂H₅) with a heterocyclic ring, to which C₂H₅ is bonded as a substituent, may be produced. It is preferable that this reaction product be classified as appropriate to recover the target monomer. The monomer (MA-C₂H₅) herein refers to at least one monomer selected from the group consisting of monomers (MA-C₂H₅-1) through (MA-C₂H₅-7). In the monomers (MA-C₂H₅-1) through (MA-C₂H₅-7), C₂H₅ is substituted for C1 in the monomers (MA-C1-1) through (MA-C1-7), respectively. As an example, a reaction formula for synthesizing the monomer (MA-C₂H₅-1) from the monomer (MA) is shown below.

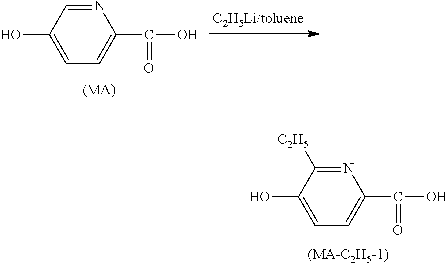

By allowing the monomer (MA-C₂H₅) to react with Cl₂, a reaction product containing a monomer (MA-CHClCH₂Cl) with a heterocyclic ring, to which CHClCH₂Cl is bonded as a substituent, may be produced. It is preferable that this reaction product be classified as appropriate to recover the target monomer. The monomer (MA-CHClCH₂Cl) herein refers to at least one monomer selected from the group consisting of monomers (MA-CHClCH₂Cl-1) through (MA-CHClCH₂Cl-7). In the monomers (MA-CHClCH₂Cl-1) through (MA-CHClCH₂Cl-7), CHClCH₂Cl is substituted for C1 in the monomers (MA-C1-1) through (MA-C1-7), respectively. As an example, a reaction formula for synthesizing the monomer (MA-CHClCH₂Cl-1) from the monomer (MA-C₂H₅-1) is shown below.

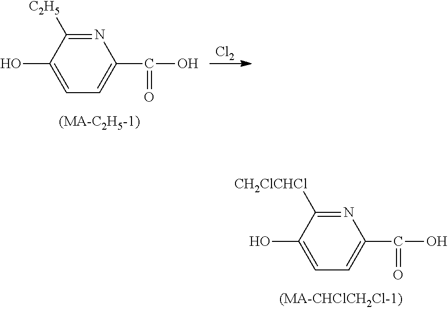

By allowing the monomer (MA-CHClCH₂Cl) to react with NaOH in water, a reaction product containing a monomer (MA-CHOHCH₂OH) with a heterocyclic ring, to which CHOHCH₂OH is bonded as a substituent, may be produced. It is preferable that this reaction product be classified as appropriate to recover the target monomer. The monomer (MA-CHOHCH₂OH) herein refers to at least one monomer selected from the group consisting of monomers (MA-CHOHCH₂OH-1) through (MA-CHOHCH₂OH-7). In the monomers (MA-CHOHCH₂OH-1) through (MA-CHOHCH₂OH-7), CHOHCH₂OH is substituted for C1 in the monomers (MA-C1-1) through (MA-C1-7), respectively. As an example, a reaction formula for synthesizing the monomer (MA-CHOHCH₂OH-1) from the monomer (MA-CHClCH₂Cl-1) is shown below.

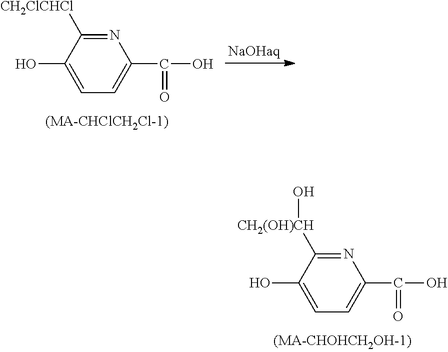

By allowing the monomer (MA-CHOHCH₂OH) to react with acetyl chloride, a reaction product containing a monomer (MA-CHOAcCH₂OAc) with a heterocyclic ring, to which CHOAcCH₂OAc (where Ac stands for an acetyl group) is bonded as a substituent, may be produced. It is preferable that this reaction product be classified as appropriate to recover the target monomer. The monomer (MA-CHOAcCH₂OAc) herein refers to at least one monomer selected from the group consisting of monomers (MA-CHOAcCH₂OAc-1) through (MA-CHOAcCH₂OAc-7). In the monomers (MA-CHOAcCH₂OAc-1) through (MA-CHOAcCH₂OAc-7), CHOAcCH₂OAc is substituted for C1 in the monomers (MA-C1-1) through (MA-C1-7), respectively. As an example, a reaction formula for synthesizing the monomer (MA-CHOAcCH₂OAc-1) from the monomer (MA-CHOHCH₂OH-1) is shown below.

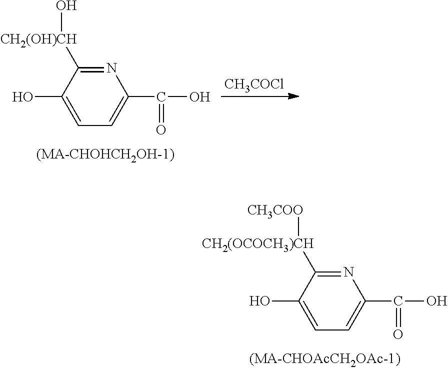

A high-molecular compound produced by subjecting the monomer (MA-CHOAcCH₂OAc) to ester polymerization is allowed to react with NaOH in a water/ethanol solvent to desorb an acetyl group. As a result, a high-molecular compound, having a constitutional unit (UA) with a heterocyclic ring, to which CHOHCH₂OH is bonded as a substituent, may be produced. As an example, a reaction formula for synthesizing the target high-molecular compound from the monomer (MA-CHOAcCH₂OAc-1) is shown below.

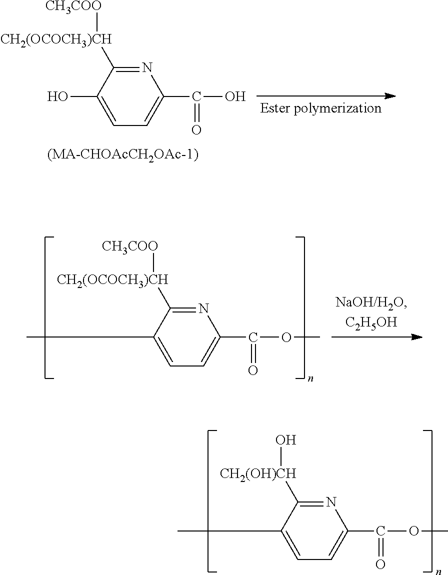

A synthesis route for a high-molecular compound having the constitutional unit (UB) expressed by the chemical structural formula (B) will be described.

The high-molecular compound having the constitutional unit (UB) has a constitutional unit derived from a monomer synthesized by using the following monomer (MB) as a starting material:

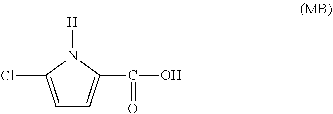

A synthesis route for a high-molecular compound having a constitutional unit (UB) with a heterocyclic ring, to which C1 is bonded as a substituent, will be described.

By allowing the monomer (MB) as a starting material to react with Cl₂, a reaction product containing at least one monomer (MB-X) selected from the group consisting of monomers (MB-X-1) through (MB-X-3) may be produced. It is preferable that this reaction product be classified as appropriate to recover the target monomer. As an example, a reaction formula for synthesizing a monomer (MB-X-1) from the monomer (MB) and the respective structures of the monomers (MB-X-1) through (MB-X-3) are shown below:

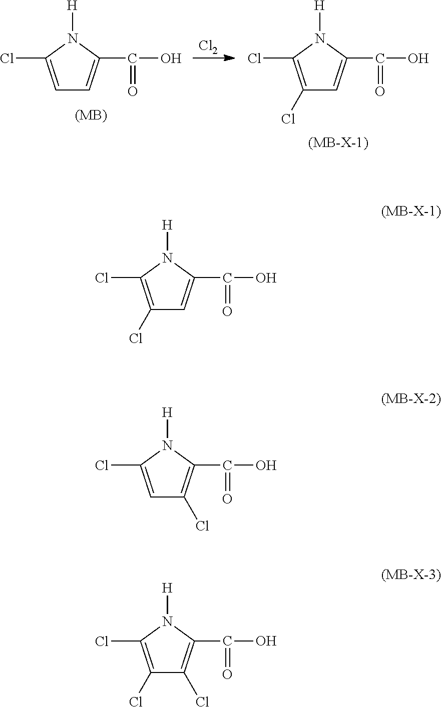

By allowing the monomer (MB-X) produced by the above-described method and NaOH to react with each other in water, a monomer (MB-C1) with the heterocyclic ring, to which C1 is bonded as a substituent, may be produced. It is preferable that this reaction product be classified as appropriate to recover the target monomer. The monomer (MB-C1) herein refers to at least one monomer selected from the group consisting of monomers (MB-C1-1) through (MB-C1-3). As an example, a reaction formula for synthesizing the monomer (MB-C1-1) from the monomer (MB-X-1) and the respective structures of the monomers (MB-C1-1) through (MB-C1-3) are shown below:

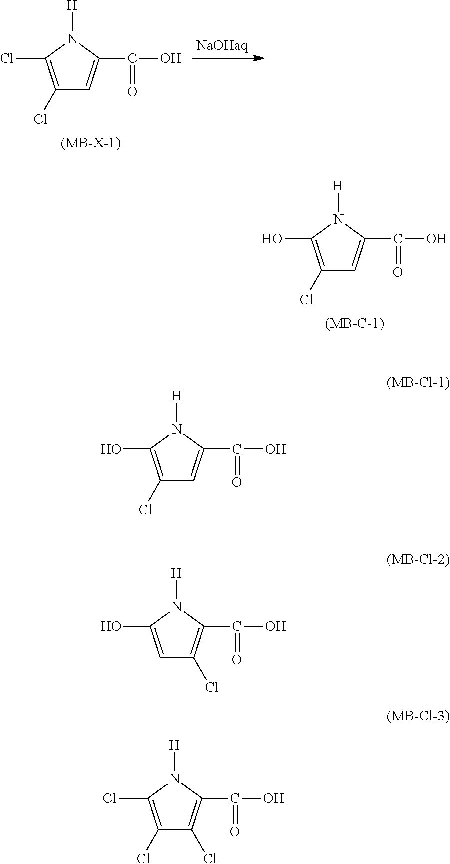 [SMILES: O=C(O)c1cc(Cl)c(Cl)[nH]1 ; O=C(O)c1cc(Cl)c(O)[nH]1 ; O=C(O)c1cc(Cl)c(O)[nH]1 ; O=C(O)c1[nH]c(O)cc1Cl ; O=C(O)c1[nH]c(Cl)c(Cl)c1Cl]

By subjecting the monomer (MB-C1) to ester polymerization, a high-molecular compound having the constitutional unit (UB) with the heterocyclic ring, to which C1 is bonded as a substituent, may be produced. As an example, a reaction formula for synthesizing the target high-molecular compound from a monomer (MB-C1-1) is shown below.

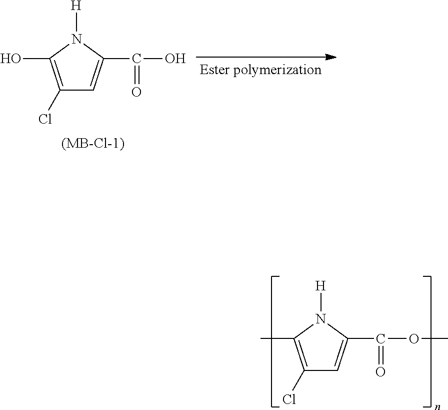

A synthesis route for a high-molecular compound having a constitutional unit (UB) with a heterocyclic ring, to which F is bonded as a substituent, will be described.

By allowing the monomer (MB-C1) and KF to react with each other in a sulfolane solvent, a reaction product containing a monomer (MB-F) with the heterocyclic ring, to which F is bonded as a substituent, may be produced. It is preferable that this reaction product be classified as appropriate to recover the target monomer. The monomer (MB-F) herein refers to at least one monomer selected from the group consisting of monomers (MB-F-1) through (MB-F-3). In the monomers (MB-F-1) through (MB-F-3), F is substituted for C1 in the monomers (MB-C1-1) through (MB-C1-3), respectively. As an example, a reaction formula for synthesizing the monomer (MB-F-1) from the monomer (MB-C1-1) is shown below.

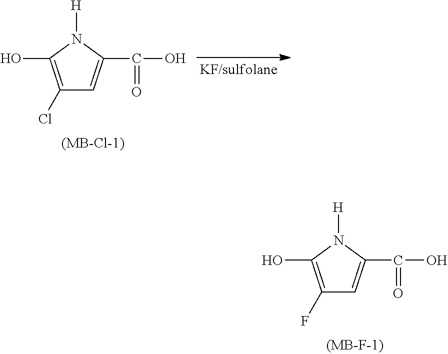 [SMILES: O=C(O)c1cc(Cl)c(O)[nH]1 ; O=C(O)c1cc(F)c(O)[nH]1]

By subjecting the monomer (MB-F) to ester polymerization, a high-molecular compound having a constitutional unit (UB) with the heterocyclic ring, to which F is bonded as a substituent, may be produced. As an example, a reaction formula for synthesizing the target high-molecular compound from a monomer (MB-F-1) is shown below.

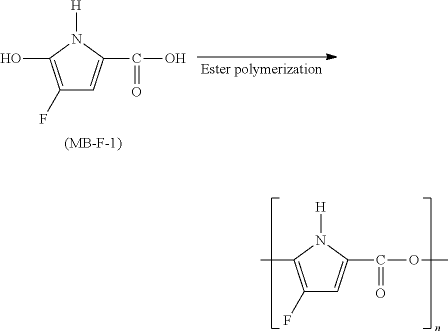

A synthesis route for a high-molecular compound having a constitutional unit (UB) with a heterocyclic ring, to which Br is bonded as a substituent, will be described.

A reaction product, produced by allowing the monomer (MB) as a starting material to react with NaOH in a methanol solvent and then washing the reactant with hydrochloric acid, is further allowed to react with hydrochloric acid, thereby obtaining a monomer (MB-S). A reaction formula for synthesizing the monomer (MB-S) from the monomer (MB) is shown below.

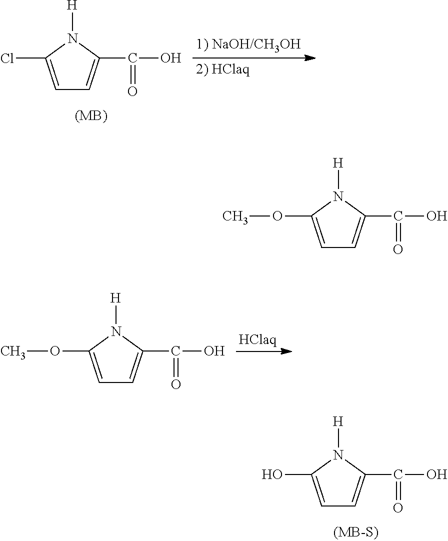

By allowing the monomer (MB-S) produced by the above-described method and Br₂ to react with each other, a reaction product containing a monomer (MB-Br) with the heterocyclic ring, to which Br is bonded as a substituent, may be produced. It is preferable that this reaction product be classified as appropriate to recover the target monomer. The monomer (MB-Br) herein refers to at least one monomer selected from the group consisting of monomers (MB-Br-1) through (MB-Br-3). In the monomers (MB-Br-1) through (MB-Br-3), Br is substituted for C1 in the monomers (MB-C1-1) through (MB-C1-3), respectively. As an example, a reaction formula for synthesizing the monomer (MB-Br-1) from the monomer (MB-S) is shown below.

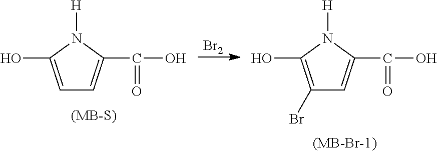

By subjecting the monomer (MB-Br) to ester polymerization, a high-molecular compound having a constitutional unit (UB) with the heterocyclic ring, to which Br is bonded as a substituent, may be produced. As an example, a reaction formula for synthesizing the target high-molecular compound from the monomer (MB-Br-1) is shown below.

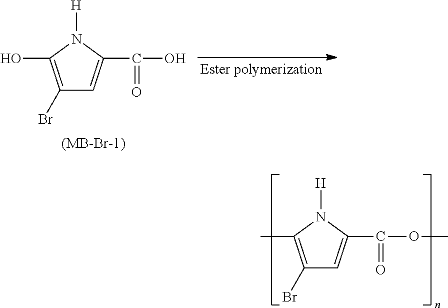

A synthesis route for a high-molecular compound having a constitutional unit (UB) with a heterocyclic ring, to which OH is bonded as a substituent, will be described.

By allowing the monomer (MB-C1) and NaOH to react with each other in water, a reaction product containing a monomer (MB-OH) with the heterocyclic ring, to which OH is bonded as a substituent, may be produced. It is preferable that this reaction product be classified as appropriate to recover the target monomer. The monomer (MB-OH) herein refers to at least one monomer selected from the group consisting of monomers (MB-OH-1) through (MB-OH-3). In the monomers (MB-OH-1) through (MB-OH-3), OH is substituted for C1 in the monomers (MB-C1-1) through (MB-C1-3), respectively. As an example, a reaction formula for synthesizing the monomer (MB-OH-1) from the monomer (MB-C1-1) is shown below.

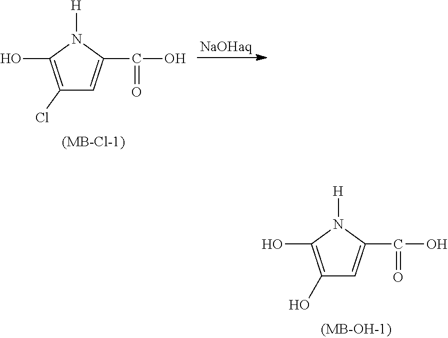

By allowing the monomer (MB-OH) to react with acetyl chloride, a reaction product containing a monomer (MB-CH₃COO) with a heterocyclic ring, to which CH₃COO is bonded as a substituent, may be produced. It is preferable that this reaction product be classified as appropriate to recover the target monomer. The monomer (MB-CH₃COO) herein refers to at least one monomer selected from the group consisting of monomers (MB-CH₃COO-1) through (MB-CH₃COO-3). In the monomers (MB-CH₃COO-1) through (MB-CH₃COO-3), CH₃COO is substituted for C1 in the monomers (MB-C1-1) through (MB-C1-3), respectively. As an example, a reaction formula for synthesizing the monomer (MB-CH₃COO-1) from the monomer (MB-OH-1) is shown below.

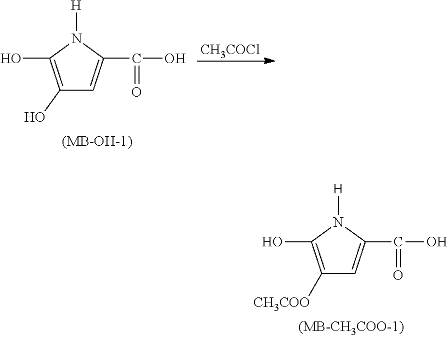

A high-molecular compound produced by subjecting the monomer (MB-CH₃COO) to ester polymerization is allowed to react with NaOH in a water/ethanol solvent to desorb an acetyl group. As a result, a high-molecular compound, having a constitutional unit (UB) with a heterocyclic ring, to which OH is bonded as a substituent, may be produced. As an example, a reaction formula for synthesizing the target high-molecular compound from the monomer (MB-CH₃COO-1) is shown below.

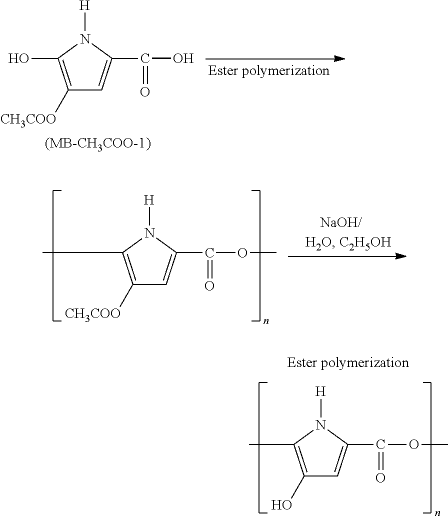

A synthesis route for a high-molecular compound having a constitutional unit (UB) with a heterocyclic ring, to which CH₃ is bonded as a substituent, will be described.

By allowing the monomer (MB-S) produced by the above-described method and CH₃C1 to react with each other using AlCl₃ as a catalyst, a reaction product containing a monomer (MB-CH₃) with the heterocyclic ring, to which CH₃ is bonded as a substituent, may be produced. It is preferable that this reaction product be classified as appropriate to recover the target monomer. The monomer (MB-CH₃) herein refers to at least one monomer selected from the group consisting of monomers (MB-CH₃-1) through (MB-CH₃-3). In the monomers (MB-CH₃-1) through (MB-CH₃-3), CH₃ is substituted for C1 in the monomers (MB-C1-1) through (MB-C1-3), respectively. As an example, a reaction formula for synthesizing the monomer (MB-CH₃-1) from the monomer (MB-S) is shown below.

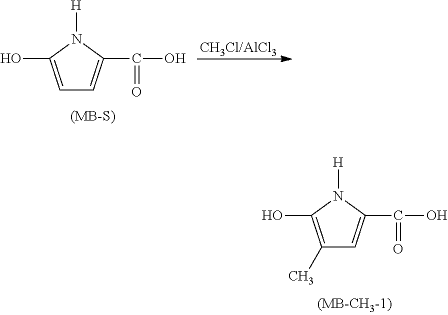

By subjecting the monomer (MB-CH₃) to ester polymerization, a high-molecular compound having a constitutional unit (UB) with the heterocyclic ring, to which CH₃ is bonded as a substituent, may be produced. As an example, a reaction formula for synthesizing the target high-molecular compound from the monomer (MB-CH₃-1) is shown below.

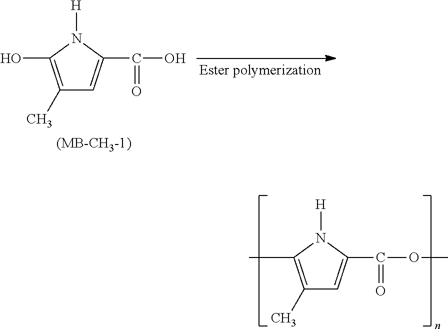

A synthesis route for a high-molecular compound having a constitutional unit (UB) with a heterocyclic ring, to which CH₂F is bonded as a substituent, will be described.

By allowing the monomer (MB-CH₃) to react with F₂, a reaction product containing a monomer (MB-CH₂F) with the heterocyclic ring, to which CH₂F is bonded as a substituent, may be produced. It is preferable that this reaction product be classified as appropriate to recover the target monomer. The monomer (MB-CH₂F) herein refers to at least one monomer selected from the group consisting of monomers (MB-CH₂F-1) through (MB-CH₂F-3). In the monomers (MB-CH₂F-1) through (MB-CH₂F-3), CH₂F is substituted for C1 in the monomers (MB-C1-1) through (MB-C1-3), respectively. As an example, a reaction formula for synthesizing the monomer (MB-CH₂F-1) from the monomer (MB-CH₃-1) is shown below.

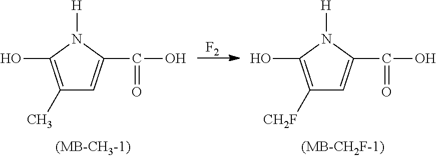

By subjecting the monomer (MB-CH₂F) to ester polymerization, a high-molecular compound having a constitutional unit (UB) with the heterocyclic ring, to which CH₂F is bonded as a substituent, may be produced. As an example, a reaction formula for synthesizing the target high-molecular compound from the monomer (MB-CH₂F-1) is shown below.

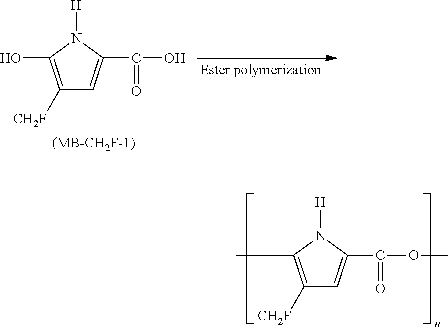

A synthesis route for a high-molecular compound having a constitutional unit (UB) with a heterocyclic ring, to which CH₂Cl is bonded as a substituent, will be described.

By allowing the monomer (MB-CH₃) to react with Cl₂, a reaction product containing a monomer (MB-CH₂Cl) with the heterocyclic ring, to which CH₂Cl is bonded as a substituent, may be produced. It is preferable that this reaction product be classified as appropriate to recover the target monomer. The monomer (MB-CH₂Cl) herein refers to at least one monomer selected from the group consisting of monomers (MB-CH₂Cl-1) through (MB-CH₂Cl-3). In the monomers (MB-CH₂Cl-1) through (MB-CH₂Cl-3), CH₂Cl is substituted for C1 in the monomers (MB-C1-1) through (MB-C1-3), respectively. As an example, a reaction formula for synthesizing the monomer (MB-CH₂Cl-1) from the monomer (MB-CH₃-1) is shown below.

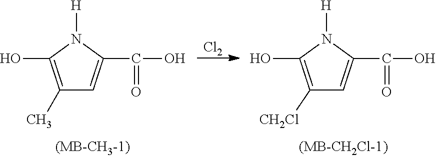

By subjecting the monomer (MB-CH₂Cl) to ester polymerization, a high-molecular compound having a constitutional unit (UB) with the heterocyclic ring, to which CH₂Cl is bonded as a substituent, may be produced. As an example, a reaction formula for synthesizing the target high-molecular compound from the monomer (MB-CH₂Cl-1) is shown below.

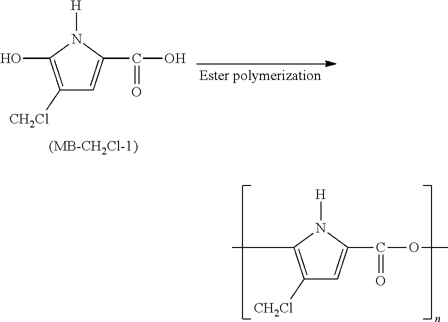

A synthesis route for a high-molecular compound having a constitutional unit (UB) with a heterocyclic ring, to which CHCl₂ is bonded as a substituent, will be described.

By allowing the monomer (MB-CH₂Cl) to react with Cl₂, a reaction product containing a monomer with the heterocyclic ring, to which CHCl₂ is bonded as a substituent, may be produced. It is preferable that this reaction product be classified as appropriate to recover the target monomer. The monomer (MB-CHCl₂) herein refers to at least one monomer selected from the group consisting of monomers (MB-CHCl₂-1) through (MB-CHCl₂-3). In the monomers (MB-CHCl₂-1) through (MB-CHCl₂-3), CHCl₂ is substituted for C1 in the monomers (MB-C1-1) through (MB-C1-3), respectively. As an example, a reaction formula for synthesizing the monomer (MB-CHCl₂-1) from the monomer (MB-CH₂Cl-1) is shown below.

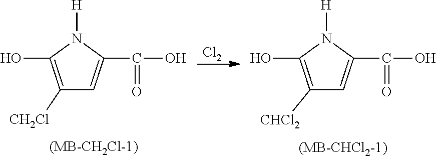

By subjecting the monomer (MB-CHCl₂) to ester polymerization, a high-molecular compound having a constitutional unit (UB) with the heterocyclic ring, to which CHCl₂ is bonded as a substituent, may be produced. As an example, a reaction formula for synthesizing the target high-molecular compound from the monomer (MB-CHCl₂-1) is shown below.

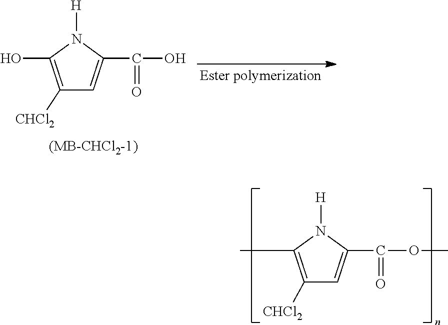

A synthesis route for a high-molecular compound having a constitutional unit (UB) with a heterocyclic ring, to which CCl₃ is bonded as a substituent, will be described.

By allowing the monomer (MB-CHCl₂) to react with Cl₂, a reaction product containing a monomer (MB-CCl₃) with the heterocyclic ring, to which CCl₃ is bonded as a substituent, may be produced. It is preferable that this reaction product be classified as appropriate to recover the target monomer. The monomer (MB-CCl₃) herein refers to at least one monomer selected from the group consisting of monomers (MB-CCl₃-1) through (MB-CCl₃-3). In the monomers (MB-CCl₃-1) through (MB-CCl₃-3), CCl₃ is substituted for C1 in the monomers (MB-C1-1) through (MB-C1-3), respectively. As an example, a reaction formula for synthesizing the monomer (MB-CCl₃-1) from the monomer (MB-CHCl₂-1) is shown below.

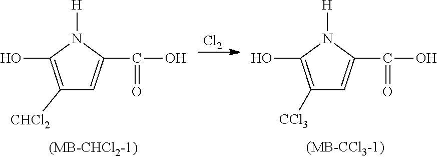

By subjecting the monomer (MB-CCl₃) to ester polymerization, a high-molecular compound having a constitutional unit (UB) with the heterocyclic ring, to which CCl₃ is bonded as a substituent, may be produced. As an example, a reaction formula for synthesizing the target high-molecular compound from the monomer (MB-CC₃-1) is shown below.

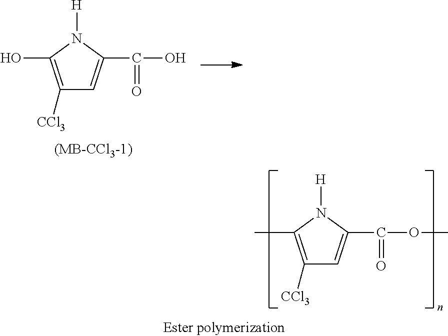

A synthesis route for a high-molecular compound having a constitutional unit (UB) with a heterocyclic ring, to which CH₂Br is bonded as a substituent, will be described.

By allowing the monomer (MB-CH₃) to react with Br₂, a reaction product containing a monomer (MB-CH₂Br) with the heterocyclic ring, to which CH₂Br is bonded as a substituent, may be produced. It is preferable that this reaction product be classified as appropriate to recover the target monomer. The monomer (MB-CH₂Br) herein refers to at least one monomer selected from the group consisting of monomers (MB-CH₂Br-1) through (MB-CH₂Br-3). In the monomers (MB-CH₂Br-1) through (MB-CH₂Br-3), CH₂Br is substituted for C1 in the monomers (MB-C1-1) through (MB-C1-3), respectively. As an example, a reaction formula for synthesizing the monomer (MB-CH₂Br-1) from the monomer (MB-CH₃-1) is shown below.

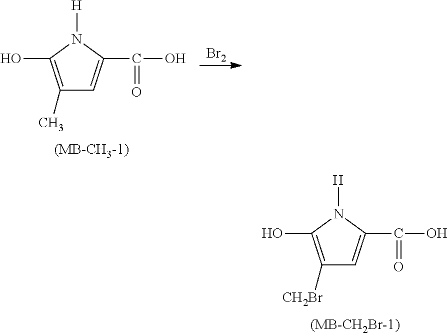

By subjecting the monomer (MB-CH₂Br) to ester polymerization, a high-molecular compound having a constitutional unit (UB) with the heterocyclic ring, to which CH₂Br is bonded as a substituent, may be produced. As an example, a reaction formula for synthesizing the target high-molecular compound from the monomer (MB-CH₂Br-1) is shown below.

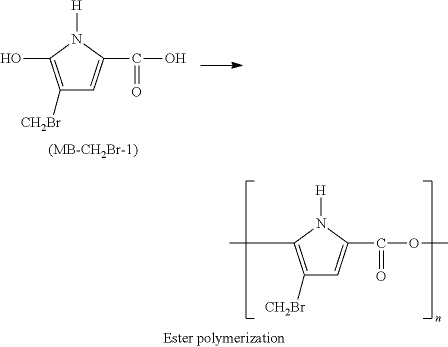

A synthesis route for a high-molecular compound having a constitutional unit (UB) with a heterocyclic ring, to which CHBr₂ is bonded as a substituent, will be described.

By allowing the monomer (MB-CH₂Br) to react with Br₂, a reaction product containing a monomer (MB-CHBr₂) with the heterocyclic ring, to which CHBr₂ is bonded as a substituent, may be produced. It is preferable that this reaction product be classified as appropriate to recover the target monomer. The monomer (MB-CHBr₂) herein refers to at least one monomer selected from the group consisting of monomers (MB-CHBr₂-1) through (MB-CHBr₂-3). In the monomers (MB-CHBr₂-1) through (MB-CHBr₂-3), CHBr₂ is substituted for C1 in the monomers (MB-C1-1) through (MB-C1-3), respectively. As an example, a reaction formula for synthesizing the monomer (MB-CHBr₂-1) from the monomer (MB-CH₂Br-1) is shown below.

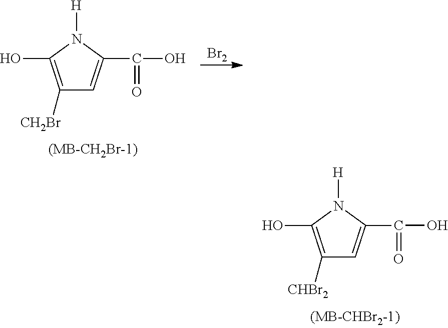

By subjecting the monomer (MB-CHBr₂) to ester polymerization, a high-molecular compound having a constitutional unit (UB) with the heterocyclic ring, to which CHBr₂ is bonded as a substituent, may be produced. As an example, a reaction formula for synthesizing the target high-molecular compound from the monomer (MB-CHBr₂-1) is shown below.

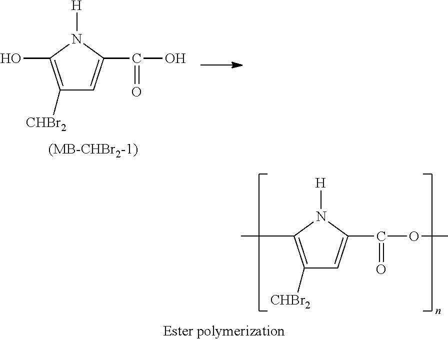

A synthesis route for a high-molecular compound having a constitutional unit (UB) with a heterocyclic ring, to which CBr₃ is bonded as a substituent, will be described.

By allowing the monomer (MB-CHBr₂) to react with Br₂, a reaction product containing a monomer (MB-CBr₃) with the heterocyclic ring, to which CBr₃ is bonded as a substituent, may be produced. It is preferable that this reaction product be classified as appropriate to recover the target monomer. The monomer (MB-CBr₃) herein refers to at least one monomer selected from the group consisting of monomers (MB-CBr₃-1) through (MB-CBr₃-3). In the monomers (MB-CBr₃-1) through (MB-CBr₃-3), CBr₃ is substituted for C1 in the monomers (MB-C1-1) through (MB-C1-3), respectively. As an example, a reaction formula for synthesizing the monomer (MB-CBr₃-1) from the monomer (MB-CHBr₂-1) is shown below.

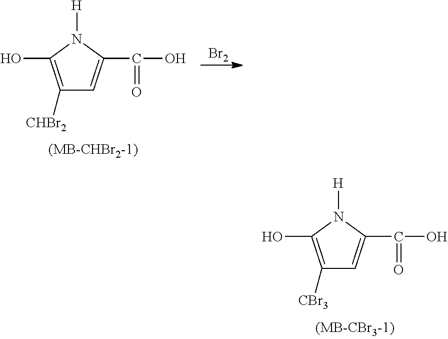

By subjecting the monomer (MB-CBr₃) to ester polymerization, a high-molecular compound having a constitutional unit (UB) with the heterocyclic ring, to which CBr₃ is bonded as a substituent, may be produced. As an example, a reaction formula for synthesizing the target high-molecular compound from the monomer (MB-CBr₃-1) is shown below.

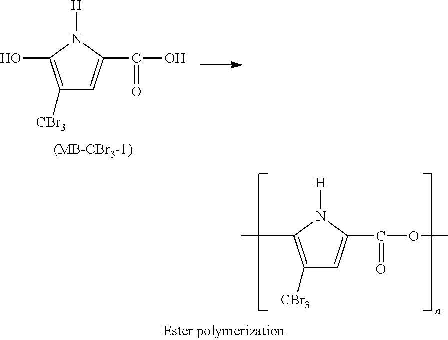

A synthesis route for a high-molecular compound having a constitutional unit (UB) with a heterocyclic ring, to which CHO is bonded as a substituent, will be described.

By allowing the monomer (MB-CH₂Cl) and NaOH to react with each other in water, a reaction product containing a monomer (MB-CH₂OH) with a heterocyclic ring, to which CH₂OH is bonded as a substituent, may be produced. It is preferable that this reaction product be classified as appropriate to recover the target monomer. The monomer (MB-CH₂OH) herein refers to at least one monomer selected from the group consisting of monomers (MB-CH₂OH-1) through (MB-CH₂OH-3). In the monomers (MB-CH₂OH-1) through (MB-CH₂OH-3), CH₂OH is substituted for C1 in the monomers (MB-C1-1) through (MB-C1-3), respectively. As an example, a reaction formula for synthesizing the monomer (MB-CH₂OH-1) from the monomer (MB-CH₂Cl-1) is shown below.

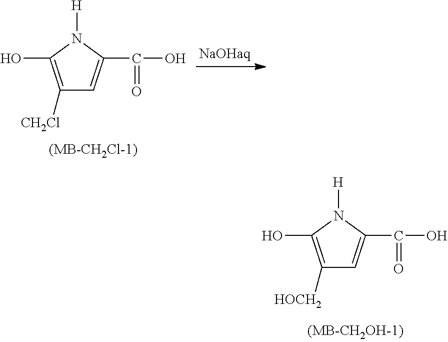

By allowing a monomer (MB-CH₂OH) and PCC to react with each other in a methylene chloride solvent, a reaction product containing a monomer (MB-CHO) with the heterocyclic ring, to which CHO is bonded as a substituent, may be produced. It is preferable that this reaction product be classified as appropriate to recover the target monomer. The monomer (MB-CHO) herein refers to at least one monomer selected from the group consisting of monomers (MB-CHO-1) through (MB-CHO-3). In the monomers (MB-CHO-1) through (MB-CHO-3), CHO is substituted for C1 in the monomers (MB-C1-1) through (MB-C1-3), respectively. As an example, a reaction formula for synthesizing the monomer (MB-CHO-1) from the monomer (MB-CH₂OH-1) is shown below.

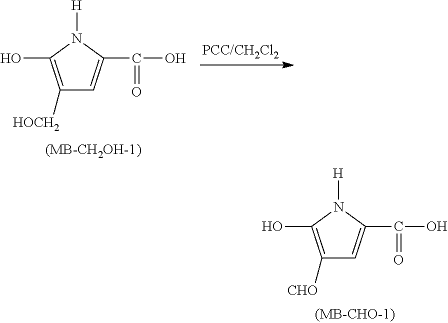

By subjecting the monomer (MB-CHO) to ester polymerization, a high-molecular compound having a constitutional unit (UB) with the heterocyclic ring, to which CHO is bonded as a substituent, may be produced. As an example, a reaction formula for synthesizing the target high-molecular compound from the monomer (MB-CHO-1) is shown below.

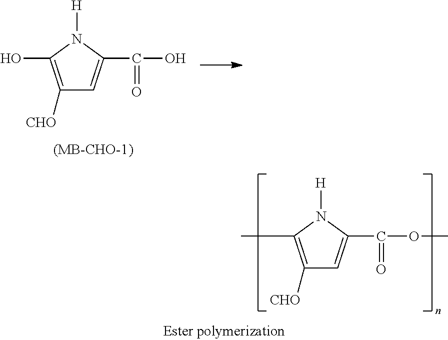

A synthesis route for a high-molecular compound having a constitutional unit (UB) with a heterocyclic ring, to which COOH is bonded as a substituent, will be described.

By allowing the monomer (MB-CH₂OH) to react with a mixture of potassium dichromate and an aqueous solution of sulfuric acid, a reaction product containing a monomer (MB-COOH) with the heterocyclic ring, to which COOH is bonded as a substituent, may be produced. It is preferable that this reaction product be classified as appropriate to recover the target monomer. The monomer (MB-COOH) herein refers to at least one monomer selected from the group consisting of monomers (MB-COOH-1) through (MB-COOH-3). In the monomers (MB-COOH-1) through (MB-COOH-3), COOH is substituted for C1 in the monomers (MB-C1-1) through (MB-C1-3), respectively. As an example, a reaction formula for synthesizing the monomer (MB-COOH-1) from the monomer (MB-CH₂OH-1) is shown below.

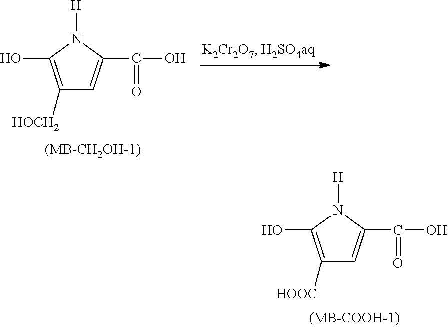

By allowing a monomer (MB-COOH) and thionyl chloride to react with each other in a methanol solvent, a reaction product containing a monomer (MB-COOCH₃) with a heterocyclic ring, to which COOCH₃ is bonded as a substituent, may be produced. It is preferable that this reaction product be classified as appropriate to recover the target monomer. The monomer (MB-COOCH₃) herein refers to at least one monomer selected from the group consisting of monomers (MB-COOCH₃-1) through (MB-COOCH₃-3). In the monomers (MB-COOCH₃-1) through (MB-COOCH₃-3), COOCH₃ is substituted for C1 in the monomers (MB-C1-1) through (MB-C1-3), respectively. As an example, a reaction formula for synthesizing the monomer (MB-COOCH₃-1) from the monomer (MB-COOH-1) is shown below.

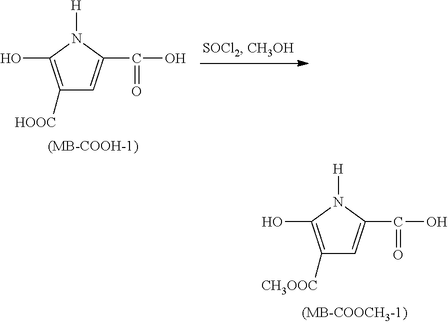

A high-molecular compound produced by subjecting the monomer (MB-COOCH₃) to ester polymerization is allowed to react with NaOH in a water/ethanol solvent, and then washed with hydrochloric acid, thereby producing a high-molecular compound having a constitutional unit (UB) with such a heterocyclic ring, to which COOH is bonded as a substituent. As an example, a reaction formula for synthesizing the target high-molecular compound from the monomer (MB-COOCH₃-1) is shown below.

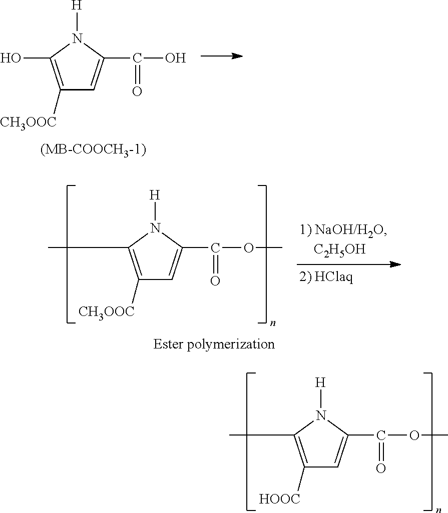

A synthesis route for a high-molecular compound having a constitutional unit (UB) with a heterocyclic ring, to which CHOHCH₂OH is bonded as a substituent, will be described.

By allowing the monomer (MB-S) produced by the above-described method to react with C₂H₅Li in a toluene solvent, a reaction product containing a monomer (MB-C₂H₅) with a heterocyclic ring, to which C₂H₅ is bonded as a substituent, may be produced. It is preferable that this reaction product be classified as appropriate to recover the target monomer. The monomer (MB-C₂H₅) herein refers to at least one monomer selected from the group consisting of monomers (MB-C₂H₅-1) through (MB-C₂H₅-3). In the monomers (MB-C₂H₅-1) through (MB-C₂H₅-3), C₂H₅ is substituted for C1 in the monomers (MB-C1-1) through (MB-C1-3), respectively. As an example, a reaction formula for synthesizing the monomer (MB-C₂H₅-1) from the monomer (MB-S) is shown below.

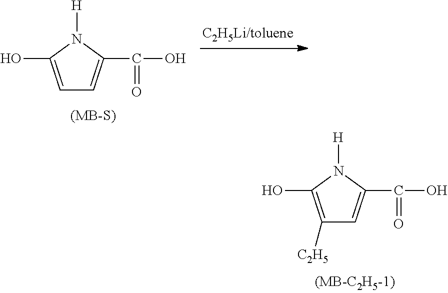 [SMILES: O=C(O)c1ccc(O)[nH]1 ; CCc1cc(C(=O)O)[nH]c1O]

By allowing the monomer (MB-C₂H₅) to react with Cl₂, a reaction product containing a monomer (MB-CHClCH₂Cl) with a heterocyclic ring, to which CHClCH₂Cl is bonded as a substituent, may be produced. It is preferable that this reaction product be classified as appropriate to recover the target monomer. The monomer (MB-CHClCH₂Cl) herein refers to at least one monomer selected from the group consisting of monomers (MB-CHClCH₂Cl-1) through (MB-CHClCH₂Cl-3). In the monomers (MB-CHClCH₂Cl-1) through (MB-CHClCH₂Cl-3), CHClCH₂Cl is substituted for C1 in the monomers (MB-C1-1) through (MB-C1-3), respectively. As an example, a reaction formula for synthesizing the monomer (MB-CHClCH₂Cl-1) from the monomer (MB-C₂H₅-1) is shown below.

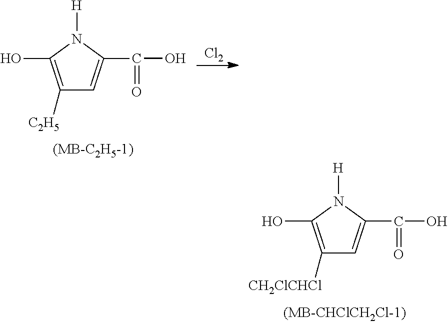

By allowing the monomer (MB-CHClCH₂Cl) to react with NaOH in water, a reaction product containing a monomer (MB-CHOHCH₂OH) with such a heterocyclic ring, to which CHOHCH₂OH is bonded as a substituent, may be produced. It is preferable that this reaction product be classified as appropriate to recover the target monomer. The monomer (MB-CHOHCH₂OH) herein refers to at least one monomer selected from the group consisting of monomers (MB-CHOHCH₂OH-1) through (MB-CHOHCH₂OH-3). In the monomers (MB-CHOHCH₂OH-1) through (MB-CHOHCH₂OH-3), CHOHCH₂OH is substituted for C1 in the monomers (MB-C1-1) through (MB-C1-3), respectively. As an example, a reaction formula for synthesizing the monomer (MB-CHOHCH₂OH-1) from the monomer (MB-CHClCH₂Cl-1) is shown below.

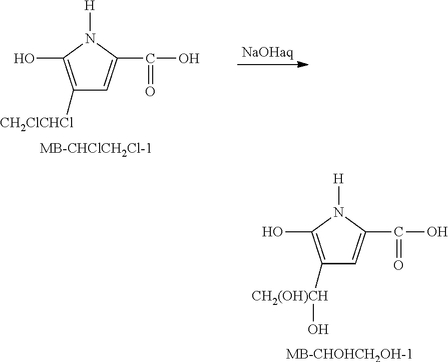

By allowing the monomer (MB-CHOHCH₂OH) to react with acetyl chloride, a reaction product containing a monomer (MB-CHOAcCH₂OAc) with a heterocyclic ring, to which CHOAcCH₂OAc is bonded as a substituent, may be produced. It is preferable that this reaction product be classified as appropriate to recover the target monomer. The monomer (MB-CHOAcCH₂OAc) herein refers to at least one monomer selected from the group consisting of monomers (MB-CHOAcCH₂OAc-1) through (MB-CHOAcCH₂OAc-3). In the monomers (MB-CHOAcCH₂OAc-1) through (MB-CHOAcCH₂OAc-3), CHOAcCH₂OAc is substituted for C1 in the monomers (MB-C1-1) through (MB-C1-3), respectively. As an example, a reaction formula for synthesizing the monomer (MB-CHOAcCH₂OAc-1) from the monomer (MB-CHOHCH₂OH-1) is shown below.

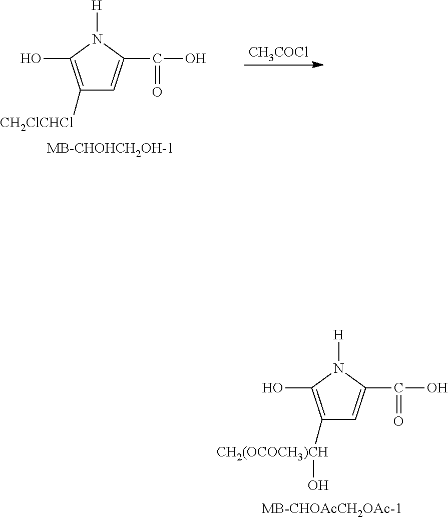

A high-molecular compound produced by subjecting the monomer (MB-CHOAcCH₂OAc) to ester polymerization is allowed to react with NaOH in a water/ethanol solvent. As a result, a high-molecular compound, having a constitutional unit (UB) with such a heterocyclic ring, to which CHOHCH₂OH is bonded as a substituent, may be produced. As an example, a reaction formula for synthesizing the target high-molecular compound from the monomer (MB-CHOAcCH₂OAc-1) is shown below.

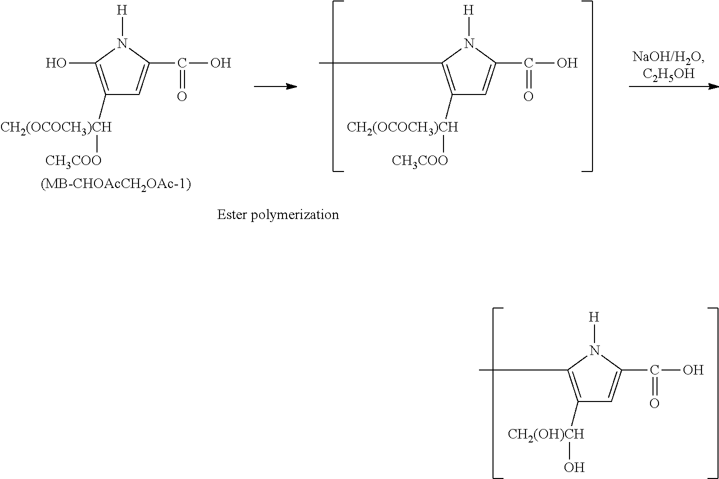

A synthesis route for a high-molecular compound having the constitutional unit (UC1) expressed by the chemical structural formula (C1) will be described.

A high-molecular compound having the constitutional unit (UC1) includes a constitutional unit derived from a monomer synthesized by using the following monomer (MC1_A) as a starting material and a constitutional unit derived from a monomer synthesized by using the following monomer (MC1_B) as a starting material:

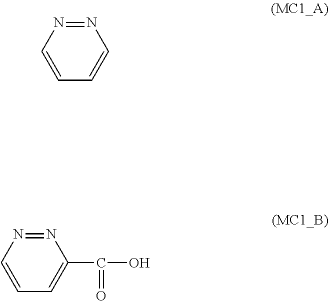 [SMILES: c1ccnnc1 ; O=C(O)c1cccnn1]

Following the various reaction methods for introducing substituents that have been mentioned in the foregoing description of the synthesis routes for the high-molecular compounds each having the constitutional unit (UA) and the synthetic routes for the high-molecular compounds each having the constitutional unit (UB) allows a monomer (MC1_A-X-Y) and a monomer (MC1_B-X-Y) each having a heterocyclic ring, to which a substituent is bonded, to be produced from the monomer (MC1_A) and the monomer (MC1_B) as respective starting materials. It is preferable that the monomer (MC1_A-X-Y) and the monomer (MC1_B-X-Y) be classified as appropriate to recover the target monomers. As used herein, X in the monomer (MC1_A-X-Y) denotes a substituent bonded to the heterocyclic ring of (MC1_A) and X in the monomer (MC1_B-X-Y) denotes a substituent bonded to the heterocyclic ring of the monomer (MC1_B). Meanwhile, Y of the monomer (MC1_A-X-Y) denotes a number assigned to each isomer according to the position and number of substituents bonded to the heterocyclic ring, to distinguish the respective isomers produced during the reaction and Y of the monomer (MC1_B-X-Y) denotes a number assigned to each isomer according to the position and number of substituents bonded to the heterocyclic ring, to distinguish the respective isomers produced during the reaction.

A synthesis route for a high-molecular compound having a constitutional unit (UC1) with a heterocyclic ring, to which C1 is bonded as a substituent, will be described.

By allowing each of the monomer (MC1_A) and monomer (MC1_B) as respective starting materials to react with Cl₂, a reaction product containing a monomer (MC1_A-C1) and a reaction product containing a monomer (MC1_B-C1) may be respectively produced. It is preferable that these reaction products be classified as appropriate to recover the target monomers. The monomer (MC1_A-C1) herein refers to at least one monomer selected from the group consisting of monomers (MC1_A-C1-1) and (MC1_A-C1-2). The monomer (MC1_B-C1) herein refers to at least one monomer selected from the group consisting of monomers (MC1_B-C1-1) and (MC1_B-C1-2). Regarding each reaction shown in the description of the synthetic route, the production ratio of each monomer during the reaction may be appropriately optimized by adjusting the reaction duration and reaction temperature. As an example, a reaction formula for synthesizing the monomer (MC1_A-C1-1) from the monomer (MC1_A), a reaction formula for synthesizing the monomer (MC1_B-C1-1) from the monomer (MC1_B), and the respective structures of the monomers (MC1_A-C1-1) and (MC1_A-C1-2) and the monomers (MC1_B-C1-1) and (MC1_B-C1-2) are shown below.

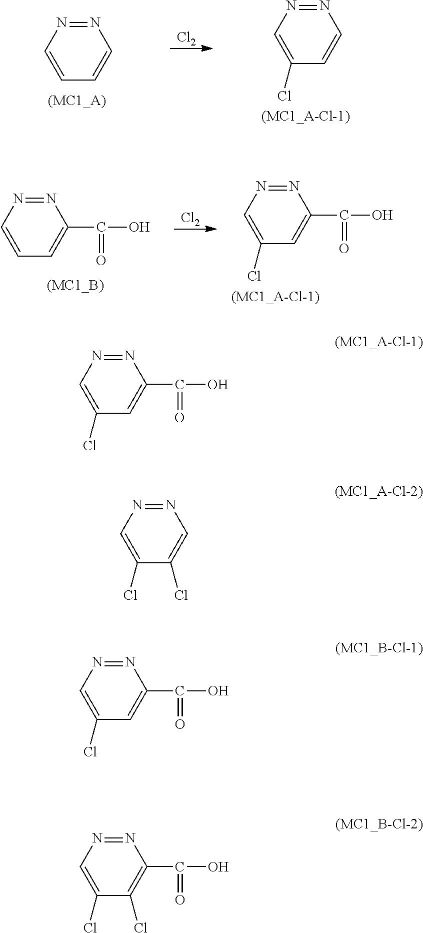

By allowing the monomer (MC1_B-C1) to react with phosphorus pentachloride, a reaction product containing a monomer (MC1_C-C1) may be obtained. It is preferable that this reaction product be classified as appropriate to recover the target monomer. The monomer (MC1_C-C1) herein refers to at least one monomer selected from the group consisting of the monomer (MC1_C-C1-1) and the monomer (MC1_C-C1-2). As an example, a reaction formula for synthesizing the monomer (MC1_C-C1-1) from the monomer (MC1_B-C1-1) and the respective structures of the monomers (MC1_C-C1-1) and (MC1_C-C1-2) are shown below.

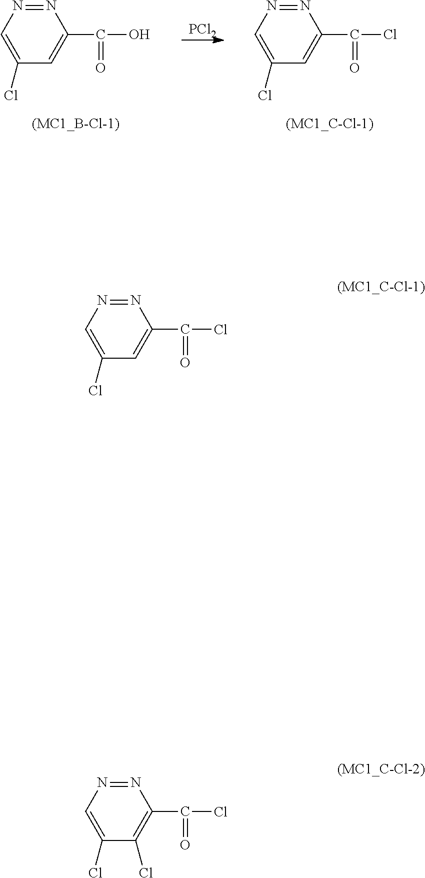

By allowing the monomer (MC1_A-C1) and the monomer (MC1_C-C1) to react with each other using AlCl₃ as a catalyst, a high-molecular compound having a constitutional unit (UC1) with such a heterocyclic ring, to which C1 is bonded as a substituent, may be produced. As an example, a reaction formula for synthesizing the target high-molecular compound from the monomer (MC1_A-C1-1) and the monomer (MC1_C-C1-1) is shown below.

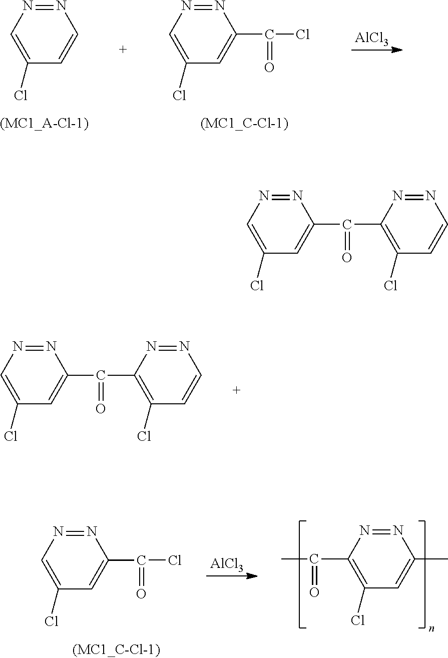

A synthesis route for a high-molecular compound having a constitutional unit (UC1) with a heterocyclic ring, to which F is bonded as a substituent, will be described.

By allowing each of the monomer (MC1_A-C1) and the monomer (MC1_B-C1) to react with KF in a sulfolane solvent, C1 in each of these monomers may be replaced with F, thus producing a reaction product containing a monomer (MC1_A-F) and a reaction product containing a monomer (MC1_B-F). It is preferable that each of these reaction products be classified as appropriate to recover the target monomer. The monomer (MC1_A-F) herein refers to at least one monomer selected from the group consisting of monomers (MC1_A-F-1) and (MC1_A-F-2). The monomer (MC1_B-F) herein refers to at least one monomer selected from the group consisting of monomers (MC1B-F-1) and (MC1B-F-2). In the monomers (MC1A-F-1) and (MC1A-F-2), F is substituted for C1 in the monomers (MC1_A-C1-1) and (MC1_A-C1-2), respectively. In the monomers (MC1_B-F-1) and (MC1_B-F-2), F is substituted for C1 in the monomers (MC1_B-C1-1) and (MC1_B-C1-2), respectively. As an example, a reaction formula for synthesizing the monomer (MC1_A-F-1) from the monomer (MC1_A-C1-1) and a reaction formula for synthesizing the monomer (MC1_B-F-1) from the monomer (MC1_B-C1-1) are shown below.

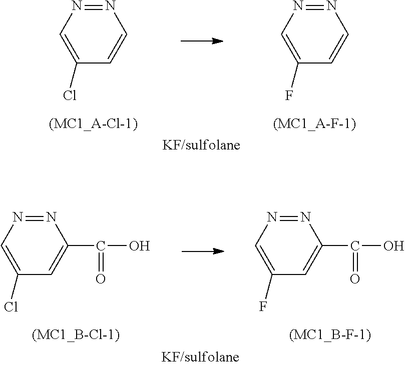 [SMILES: Clc1ccnnc1 ; Fc1ccnnc1 ; O=C(O)c1cc(Cl)cnn1 ; O=C(O)c1cc(F)cnn1]

Following the synthesis route of the high-molecular compound having the constitutional unit (UC1) with the heterocyclic ring, to which C1 is bonded as the substituent, except that the monomer (MC1_A-F) and the monomer (MC1_B-F) are used instead of the monomer (MC1_A-C1) and the monomer (MC1_B-C1), respectively, allows a high-molecular compound having a constitutional unit (UC1) with such a heterocyclic ring, to which F is bonded as an alternative substituent, to be synthesized. An exemplary structure of a high-molecular compound synthesized by using the monomer (MC1_A-F-1) and the monomer (MC1_B-F-1) is shown below as an example.

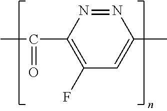

A synthesis route for a high-molecular compound having a constitutional unit (UC1) with a heterocyclic ring, to which Br is bonded as a substituent, will be described.

By allowing each of the monomer (MC1_A) and monomer (MC1_B) as respective starting materials to react with Br₂, a reaction product containing a monomer (MC1_A-Br) and a reaction product containing a monomer (MC1_B-Br) may be respectively produced. It is preferable that these reaction products be classified as appropriate to recover the target monomers. The monomer (MC1_A-Br) herein refers to at least one monomer selected from the group consisting of monomers (MC1_A-Br-1) and (MC1_A-Br-2). The monomer (MC1_B-Br) herein refers to at least one monomer selected from the group consisting of monomers (MC1_B-Br-1) and (MC1_B-Br-2). In the monomers (MC1_A-Br-1) and (MC1_A-Br-2), Br is substituted for C1 in the monomers (MC1_A-C1-1) and (MC1_A-C1-2), respectively. In the monomers (MC1_B-Br-1) and (MC1_B-Br-2), Br is substituted for C1 in the monomers (MC1_B-C1-1) and (MC1_B-C1-2), respectively. As an example, a reaction formula for synthesizing the monomer (MC1_A-Br-1) from the monomer (MC1_A) and a reaction formula for synthesizing the monomer (MC1_B-Br-1) from the monomer (MC1_B) are shown below.

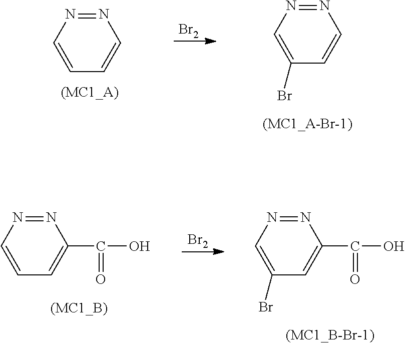

Following the synthesis route of the high-molecular compound having the constitutional unit (UC1) with the heterocyclic ring, to which C1 is bonded as the substituent, except that the monomer (MC1_A-Br) and the monomer (MC1_B-Br) are used instead of the monomer (MC1_A-C1) and the monomer (MC1_B-C1), respectively, allows a high-molecular compound having a constitutional unit (UC1) with such a heterocyclic ring, to which Br is bonded as an alternative substituent, to be synthesized. An exemplary structure of a high-molecular compound synthesized by using the monomer (MC1_A-Br-1) and the monomer (MC1_B-Br-1) is shown below as an example.

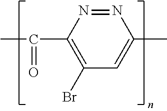

A synthesis route for a high-molecular compound having a constitutional unit (UC1) with a heterocyclic ring, to which OH is bonded as a substituent, will be described.

By allowing each of the monomer (MC1_A-C1) and the monomer (MC1_B-C1) to react with NaOH in water, C1 may be replaced with OH and thereby a reaction product containing a monomer (MC1_A-OH) and a reaction product containing a monomer (MC1_B-OH) may be respectively produced. It is preferable that these reaction products be classified as appropriate to recover the target monomers. The monomer (MC1_A-OH) herein refers to at least one monomer selected from the group consisting of monomers (MC1_A-OH-1) and (MC1_A-OH-2). The monomer (MC1_B-OH) herein refers to at least one monomer selected from the group consisting of monomers (MC1_B-OH-1) and (MC1_B-OH-2). In the monomers (MC1_A-OH-1) and (MC1_A-OH-2), OH is substituted for C1 in the monomers (MC1_A-C1-1) and (MC1_A-C1-2), respectively. In the monomers (MC1_B-OH-1) and (MC1_B-OH-2), OH is substituted for C1 in the monomers (MC1_B-C1-1) and (MC1_B-C1-2), respectively. As an example, a reaction formula for synthesizing the monomer (MC1_A-OH-1) from the monomer (MC1_A-C1-1) and a reaction formula for synthesizing the monomer (MC1_B-OH-1) from the monomer (MC1_B-C1-1) are shown below.

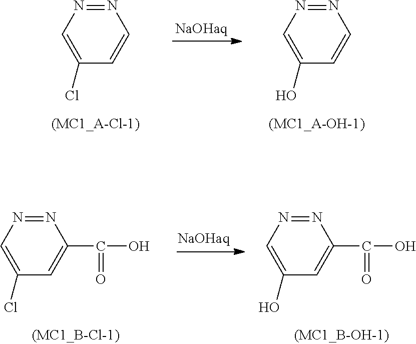 [SMILES: Clc1ccnnc1 ; Oc1ccnnc1 ; O=C(O)c1cc(Cl)cnn1 ; O=C(O)c1cc(O)cnn1]

Following the synthesis route of the high-molecular compound having the constitutional unit (UC1) with the heterocyclic ring, to which C1 is bonded as the substituent, except that the monomer (MC1_A-OH) and the monomer (MC1_B-OH) are used instead of the monomer (MC1_A-C1) and the monomer (MC1_B-C1), respectively, allows a high-molecular compound having a constitutional unit (UC1) with such a heterocyclic ring, to which OH is bonded as an alternative substituent, to be synthesized. An exemplary structure of a high-molecular compound synthesized by using the monomer (MC1_A-OH-1) and the monomer (MC1_B-OH-1) is shown below as an example.

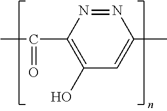

A synthesis route for a high-molecular compound having a constitutional unit (UC1) with a heterocyclic ring, to which CH₃ is bonded as a substituent, will be described.

By allowing each of the monomer (MC1_A) and the monomer (MC1_B) as respective starting materials to react with CH₃C1 in the presence of AlCl₃, a reaction product containing a monomer (MC1_A-CH₃) and a reaction product containing a monomer (MC1_B-CH₃) may be respectively produced. It is preferable that these reaction products be classified as appropriate to recover the target monomers. The monomer (MC1_A-CH₃) herein refers to at least one monomer selected from the group consisting of monomers (MC1_A-CH₃-1) and (MC1_A-CH₃-2). The monomer (MC1_B-CH₃) herein refers to at least one monomer selected from the group consisting of monomers (MC1_B-CH₃-1) and (MC1_B-CH₃-2). In the monomers (MC1_A-CH₃-1) and (MC1_A-CH₃-2), CH₃ is substituted for C1 in the monomers (MC1_A-C1-1) and (MC1_A-C1-2), respectively. In the monomers (MC1_B-CH₃-1) and (MC1_B-CH₃-2), CH₃ is substituted for C1 in the monomers (MC1_B-C1-1) and (MC1_B-C1-2), respectively. As an example, a reaction formula for synthesizing the monomer (MC1_A-CH₃-1) from the monomer (MC1_A) and a reaction formula for synthesizing the monomer (MC1_B-CH₃-1) from the monomer (MC1_B) are shown below.

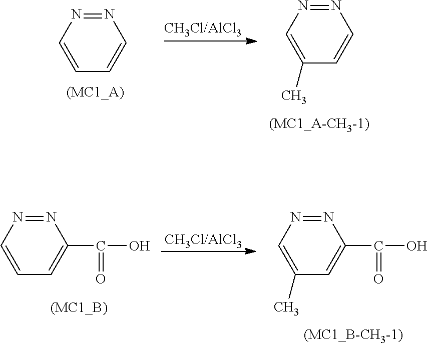

Following the synthesis route of the high-molecular compound having the constitutional unit (UC1) with the heterocyclic ring, to which C1 is bonded as the substituent, except that the monomer (MC1_A-CH₃) and the monomer (MC1_B-CH₃) are used instead of the monomer (MC1_A-C1) and the monomer (MC1_B-C1), respectively, allows a high-molecular compound having a constitutional unit (UC1) with such a heterocyclic ring, to which CH₃ is bonded as an alternative substituent, to be synthesized. An exemplary structure of a high-molecular compound synthesized by using the monomer (MC1_A-CH₃-1) and the monomer (MC1_B-CH₃-1) is shown below as an example:

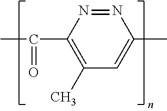

A synthesis route for a high-molecular compound having a constitutional unit (UC1) with a heterocyclic ring, to which C₂H₅ is bonded as a substituent, will be described.

By allowing each of the monomer (MC1_A) and the monomer (MC1_B) as respective starting materials to react with C₂H₅Li, a reaction product containing a monomer (MC1_A-C₂H₅) and a reaction product containing a monomer (MC1_B-C₂H₅) may be respectively produced. It is preferable that these reaction products be classified as appropriate to recover the target monomers. The monomer (MC1_A-C₂H₅) herein refers to at least one monomer selected from the group consisting of monomers (MC1_A-C₂H₅-1) and (MC1_A-C₂H₅-2). The monomer (MC1_B-C₂H₅) herein refers to at least one monomer selected from the group consisting of monomers (MC1_B-C₂H₅-1) and (MC1_B-C₂H₅-2). In the monomers (MC1_A-C₂H₅-1) and (MC1_A-C₂H₅-2), C₂H₅ is substituted for C1 in the monomers (MC1_A-C1-1) and (MC1_A-C1-2), respectively. In the monomers (MC1_B-C₂H₅-1) and (MC1_B-C₂H₅-2), C₂H₅ is substituted for C1 in the monomers (MC1_B-C1-1) and (MC1_B-C1-2), respectively. As an example, a reaction formula for synthesizing the monomer (MC1_A-C₂H-1) from the monomer (MC1_A) and a reaction formula for synthesizing the monomer (MC1_B-C₂H₅-1) from the monomer (MC1_B) are shown below.

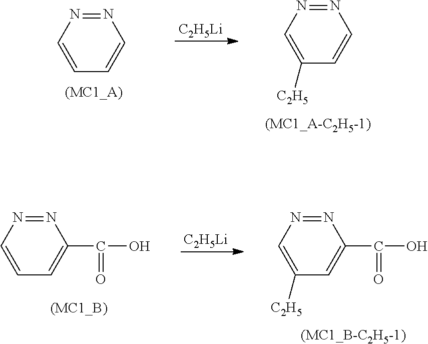 [SMILES: "C2H5Li" ; "C2H5Li" ; c1ccnnc1 ; CCc1ccnnc1 ; O=C(O)c1cccnn1 ; CCc1cnnc(C(=O)O)c1]

Following the synthesis route of the high-molecular compound having the constitutional unit (UC1) with the heterocyclic ring, to which C1 is bonded as the substituent, except that the monomer (MC1_A-C₂H₅) and the monomer (MC1_B-C₂H₅) are used instead of the monomer (MC1_A-C1) and the monomer (MC1_B-C1), respectively, allows a high-molecular compound having a constitutional unit (UC1) with such a heterocyclic ring, to which C₂H₅ is bonded as an alternative substituent, to be synthesized. An exemplary structure of a high-molecular compound synthesized by using the monomer (MC1_A-C₂H-1) and the monomer (MC1_B-C₂H₅-1) is shown below as an example.

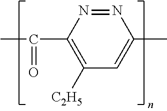

A synthesis route for a high-molecular compound having a constitutional unit (UC1) with a heterocyclic ring, to which CH₂F is bonded as a substituent, will be described.

By allowing each of the monomer (MC1_A-CH₃) and the monomer (MC1_B-CH₃) to react with F₂, a reaction product containing a monomer (MC1_A-CH₂F) and a reaction product containing a monomer (MC1_B-CH₂F) may be respectively produced. It is preferable that these reaction products be classified as appropriate to recover the target monomers. The monomer (MC1_A-CH₂F) herein refers to at least one monomer selected from the group consisting of monomers (MC1_A-CH₂F-1) and (MC1_A-CH₂F-2). The monomer (MC1_B-CH₂F) herein refers to at least one monomer selected from the group consisting of monomers (MC1_B-CH₂F-1) and (MC1_B-CH₂F-2). In the monomers (MC1_A-CH₂F-1) and (MC1_A-CH₂F-2), CH₂F is substituted for C1 in the monomers (MC1_A-C1-1) and (MC1_A-C1-2), respectively. In the monomers (MC1_B-CH₂F-1) and (MC1_B-CH₂F-2), CH₂F is substituted for C1 in the monomers (MC1_B-C1-1) and (MC1_B-C1-2), respectively. As an example, a reaction formula for synthesizing the monomer (MC1_A-CH₂F-1) from the monomer (MC1_A-CH₃-1) and a reaction formula for synthesizing the monomer (MC1_B-CH₂F-1) from the monomer (MC1_B-CH₃-1) are shown below.

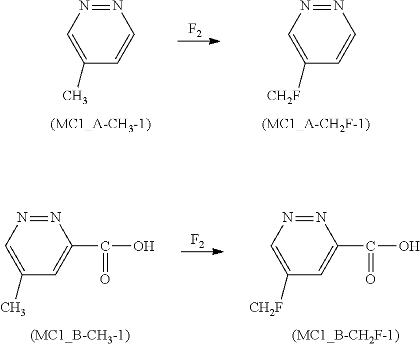

Following the synthesis route of the high-molecular compound having the constitutional unit (UC1) with the heterocyclic ring, to which C1 is bonded as the substituent, except that the monomer (MC1_A-CH₂F) and the monomer (MC1_B-CH₂F) are used instead of the monomer (MC1_A-C1) and the monomer (MC1_B-C1), respectively, allows a high-molecular compound having a constitutional unit (UC1) with such a heterocyclic ring, to which CH₂F is bonded as an alternative substituent, to be synthesized. An exemplary structure of a high-molecular compound synthesized by using the monomer (MC1_A-CH₂F-1) and the monomer (MC1_B-CH₂F-1) is shown below as an example.

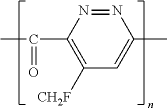

A synthesis route for a high-molecular compound having a constitutional unit (UC1) with a heterocyclic ring, to which CHF₂ is bonded as a substituent, will be described.

By allowing each of the monomer (MC1_A-CH₂F) and the monomer (MC1_B-CH₂F) to react with F₂, a reaction product containing a monomer (MC1_A-CHF₂) and a reaction product containing a monomer (MC1_B-CHF₂) may be respectively produced. It is preferable that these reaction products be classified as appropriate to recover the target monomers. The monomer (MC1_A-CHF₂) herein refers to at least one monomer selected from the group consisting of monomers (MC1_A-CHF₂-1) and (MC1_A-CHF₂-2). The monomer (MC1_B-CHF₂) herein refers to at least one monomer selected from the group consisting of monomers (MC1_B-CHF₂-1) and (MC1_B-CHF₂-2). In the monomers (MC1_A-CHF₂-1) and (MC1_A-CHF₂-2), CHF₂ is substituted for C1 in the monomers (MC1_A-C1-1) and (MC1_A-C1-2), respectively. In the monomers (MC1_B-CHF₂-1) and (MC1_B-CHF₂-2), CHF₂ is substituted for C1 in the monomers (MC1_B-C1-1) and (MC1_B-C1-2), respectively. As an example, a reaction formula for synthesizing the monomer (MC1_A-CHF₂-1) from the monomer (MC1_A-CH₂F-1) and a reaction formula for synthesizing the monomer (MC1_B-CHF₂-1) from the monomer (MC1_B-CH₂F-1) are shown below.

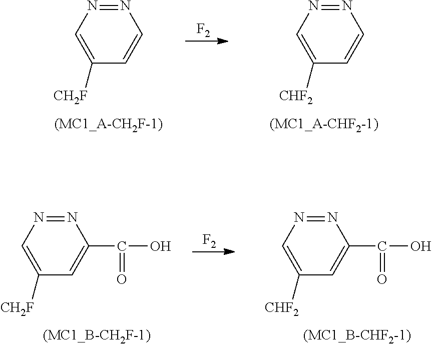

Following the synthesis route of the high-molecular compound having the constitutional unit (UC1) with the heterocyclic ring, to which C1 is bonded as the substituent, except that the monomer (MC1_A-CHF₂) and the monomer (MC1_B-CHF₂) are used instead of the monomer (MC1_A-C1) and the monomer (MC1_B-C1), respectively, allows a high-molecular compound having a constitutional unit (UC1) with such a heterocyclic ring, to which CHF₂ is bonded as an alternative substituent, to be synthesized. An exemplary structure of a high-molecular compound synthesized by using the monomer (MC1_A-CHF₂-1) and the monomer (MC1_B-CHF₂-1) is shown below as an example.

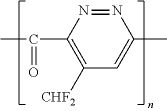

A synthesis route for a high-molecular compound having a constitutional unit (UC1) with a heterocyclic ring, to which CF₃ is bonded as a substituent, will be described.

By allowing each of the monomer (MC1_A-CHF₂) and the monomer (MC1_B-CHF₂) to react with F₂, a reaction product containing a monomer (MC1_A-CF₃) and a reaction product containing a monomer (MC1_B-CF₃) may be respectively produced. It is preferable that these reaction products be classified as appropriate to recover the target monomers. The monomer (MC1_A-CF₃) herein refers to at least one monomer selected from the group consisting of monomers (MC1_A-CF₃-1) and (MC1_A-CF₃-2). The monomer (MC1_B-CF₃) herein refers to at least one monomer selected from the group consisting of monomers (MC1_B-CF₃-1) and (MC1_B-CF₃-2). In the monomers (MC1_A-CF₃-1) and (MC1_A-CF₃-2), CF₃ is substituted for C1 in the monomers (MC1_A-C1-1) and (MC1_A-C1-2), respectively. In the monomers (MC1_B-CF₃-1) and (MC1_B-CF₃-2), CF₃ is substituted for C1 in the monomers (MC1_B-C1-1) and (MC1_B-C1-2), respectively. As an example, a reaction formula for synthesizing the monomer (MC1_A-CF₃-1) from the monomer (MC1_A-CHF₂-1) and a reaction formula for synthesizing the monomer (MC1_B-CF₃-1) from the monomer (MC1_B-CHF₂-1) are shown below:

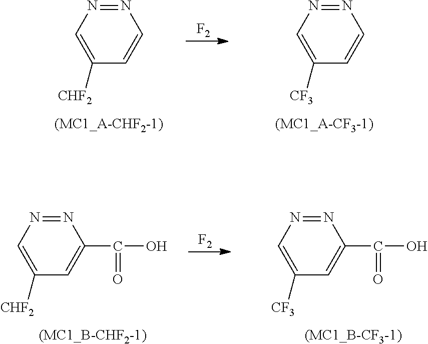

Following the synthesis route of the high-molecular compound having the constitutional unit (UC1) with the heterocyclic ring, to which C1 is bonded as the substituent, except that the monomer (MC1_A-CF₃) and the monomer (MC1_B-CF₃) are used instead of the monomer (MC1_A-C1) and the monomer (MC1_B-C1), respectively, allows a high-molecular compound having a constitutional unit (UC1) with such a heterocyclic ring, to which CF₃ is bonded as an alternative substituent, to be synthesized. An exemplary structure of a high-molecular compound synthesized by using the monomer (MC1_A-CF₃-1) and the monomer (MC1_B-CF₃-1) is shown below as an example.

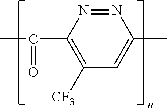

A synthesis route for a high-molecular compound having a constitutional unit (UC1) with a heterocyclic ring, to which CH₂Cl is bonded as a substituent, will be described.

By allowing each of the monomer (MC1_A-CH₃) and the monomer (MC1_B-CH₃) to react with Cl₂, a reaction product containing a monomer (MC1_A-CH₂Cl) and a reaction product containing a monomer (MC1_B-CH₂Cl) may be respectively produced. It is preferable that these reaction products be classified as appropriate to recover the target monomers. The monomer (MC1_A-CH₂Cl) herein refers to at least one monomer selected from the group consisting of monomers (MC1_A-CH₂Cl-1) and (MC1_A-CH₂Cl-2). The monomer (MC1_B-CH₂Cl) herein refers to at least one monomer selected from the group consisting of monomers (MC1_B-CH₂Cl-1) and (MC1_B-CH₂Cl-2). In the monomers (MC1_A-CH₂Cl-1) and (MC1_A-CH₂Cl-2), CH₂Cl is substituted for C1 in the monomers (MC1_A-C1-1) and (MC1_A-C1-2), respectively. In the monomers (MC1_B-CH₂Cl-1) and (MC1_B-CH₂Cl-2), CH₂Cl is substituted for C1 in the monomers (MC1_B-C1-1) and (MC1_B-C1-2), respectively. As an example, a reaction formula for synthesizing the monomer (MC1_A-CH₂Cl-1) from the monomer (MC1_A-CH₃-1) and a reaction formula for synthesizing the monomer (MC1_B-CH₂Cl-1) from the monomer (MC1_B-CH₃-1) are shown below.

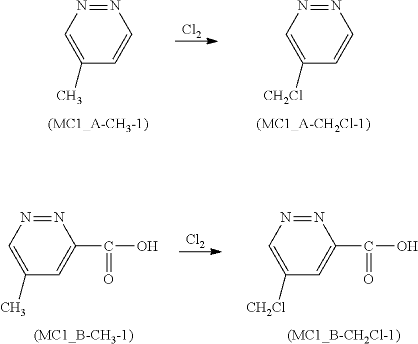

Following the synthesis route of the high-molecular compound having the constitutional unit (UC1) with the heterocyclic ring, to which C1 is bonded as the substituent, except that the monomer (MC1_A-CH₂Cl) and the monomer (MC1_B-CH₂Cl) are used instead of the monomer (MC1_A-C1) and the monomer (MC1_B-C1), respectively, allows a high-molecular compound having a constitutional unit (UC1) with such a heterocyclic ring, to which CH₂Cl is bonded as an alternative substituent, to be synthesized. An exemplary structure of a high-molecular compound synthesized by using the monomer (MC1_A-CH₂Cl-1) and the monomer (MC1_B-CH₂Cl-1) is shown below as an example.

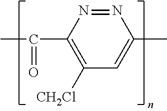

A synthesis route for a high-molecular compound having a constitutional unit (UC1) with a heterocyclic ring, to which CHCl₂ is bonded as a substituent, will be described.

By allowing each of the monomer (MC1_A-CH₂Cl) and the monomer (MC1_B-CH₂Cl) to react with Cl₂, a reaction product containing a monomer (MC1_A-CHCl₂) and a reaction product containing a monomer (MC1_B-CHCl₂) may be respectively produced. It is preferable that these reaction products be classified as appropriate to recover the target monomers. The monomer (MC1_A-CHCl₂) herein refers to at least one monomer selected from the group consisting of monomers (MC1_A-CHCl₂-1) and (MC1_A-CHCl₂-2). The monomer (MC1_B-CHCl₂) herein refers to at least one monomer selected from the group consisting of monomers (MC1_B-CHCl₂-1) and (MC1_B-CHCl₂-2). In the monomers (MC1_A-CHCl₂-1) and (MC1_A-CHCl₂-2), CHCl₂ is substituted for C1 in the monomers (MC1_A-C1-1) and (MC1_A-C1-2), respectively. In the monomers (MC1_B-CHCl₂-1) and (MC1_B-CHCl₂-2), CHCl₂ is substituted for C1 in the monomers (MC1_B-C1-1) and (MC1_B-C1-2), respectively. As an example, a reaction formula for synthesizing the monomer (MC1_A-CHCl₂-1) from the monomer (MC1_A-CH₂Cl-1) and a reaction formula for synthesizing the monomer (MC1_B-CHCl₂-1) from the monomer (MC1_B-CH₂Cl-1) are shown below:

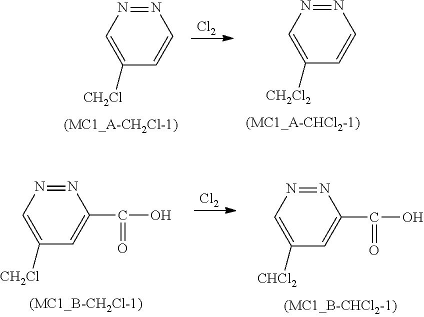

Following the synthesis route of the high-molecular compound having the constitutional unit (UC1) with the heterocyclic ring, to which C1 is bonded as the substituent, except that the monomer (MC1_A-CHCl₂) and the monomer (MC1_B-CHCl₂) are used instead of the monomer (MC1_A-C1) and the monomer (MC1_B-C1), respectively, allows a high-molecular compound having a constitutional unit (UC1) with such a heterocyclic ring, to which CHCl₂ is bonded as an alternative substituent, to be synthesized. An exemplary structure of a high-molecular compound synthesized by using the monomer (MC1_A-CHCl₂-1) and the monomer (MC1_B-CHCl₂-1) is shown below as an example.

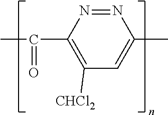

A synthesis route for a high-molecular compound having a constitutional unit (UC1) with a heterocyclic ring, to which CCl₃ is bonded as a substituent, will be described.

By allowing each of the monomer (MC1_A-CHCl₂) and the monomer (MC1_B-CHCl₂) to react with Cl₂, a reaction product containing a monomer (MC1_A-CCl₃) and a reaction product containing a monomer (MC1_B-CCl₃) may be respectively produced. It is preferable that these reaction products be classified as appropriate to recover the target monomers. The monomer (MC1_A-CCl₃) herein refers to at least one monomer selected from the group consisting of monomers (MC1_A-CCl₃-1) and (MC1_A-CCl₃-2). The monomer (MC1_B-CCl₃) herein refers to at least one monomer selected from the group consisting of monomers (MC1_B-CCl₃-1) and (MC1_B-CCl₃-2). In the monomers (MC1_A-CCl₃-1) and (MC1_A-CCl₃-2), CCl₃ is substituted for C1 in the monomers (MC1_A-C1-1) and (MC1_A-C1-2), respectively. In the monomers (MC1_B-CCl₃-1) and (MC1_B-CCl₃-2), CCl₃ is substituted for C1 in the monomers (MC1_B-C1-1) and (MC1_B-C1-2), respectively. As an example, a reaction formula for synthesizing the monomer (MC1_A-CCl₃-1) from the monomer (MC1_A-CHCl₂-1) and a reaction formula for synthesizing the monomer (MC1_B-CCl₃-1) from the monomer (MC1_B-CHCl₂-1) are shown below.

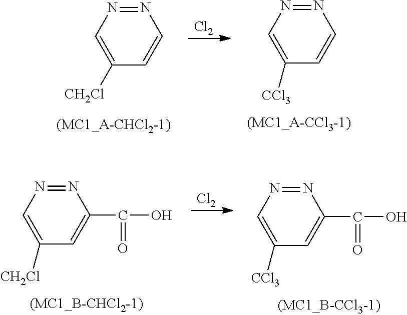

Following the synthesis route of the high-molecular compound having the constitutional unit (UC1) with the heterocyclic ring, to which C1 is bonded as the substituent, except that the monomer (MC1_A-CCl₃) and the monomer (MC1_B-CCl₃) are used instead of the monomer (MC1_A-C1) and the monomer (MC1_B-C1), respectively, allows a high-molecular compound having a constitutional unit (UC1) with such a heterocyclic ring, to which CCl₃ is bonded as an alternative substituent, to be synthesized. An exemplary structure of a high-molecular compound synthesized by using the monomer (MC1_A-CCl₃-1) and the monomer (MC1_B-CCl₃-1) is shown below as an example.

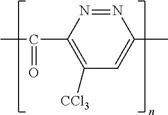

A synthesis route for a high-molecular compound having a constitutional unit (UC1) with a heterocyclic ring, to which CH₂Br is bonded as a substituent, will be described.

By allowing each of the monomer (MC1_A-CH₃) and the monomer (MC1_B-CH₃) to react with Br₂, a reaction product containing a monomer (MC1_A-CH₂Br) and a reaction product containing a monomer (MC1_B-CH₂Br) may be respectively produced. It is preferable that these reaction products be classified as appropriate to recover the target monomers. The monomer (MC1_A-CH₂Br) herein refers to at least one monomer selected from the group consisting of monomers (MC1_A-CH₂Br-1) and (MC1_A-CH₂Br-2). The monomer (MC1_B-CH₂Br) herein refers to at least one monomer selected from the group consisting of monomers (MC1_B-CH₂Br-1) and (MC1_B-CH₂Br-2). In the monomers (MC1_A-CH₂Br-1) and (MC1_A-CH₂Br-2), CH₂Br is substituted for C1 in the monomers (MC1_A-C1-1) and (MC1_A-C1-2), respectively. In the monomers (MC1_B-CH₂Br-1) and (MC1_B-CH₂Br-2), CH₂Br is substituted for C1 in the monomers (MC1_B-C1-1) and (MC1_B-C1-2), respectively. As an example, a reaction formula for synthesizing the monomer (MC1_A-CH₂Br-1) from the monomer (MC1_A-CH₃-1) and a reaction formula for synthesizing the monomer (MC1_B-CH₂Br-1) from the monomer (MC1_B-CH₃-1) are shown below:

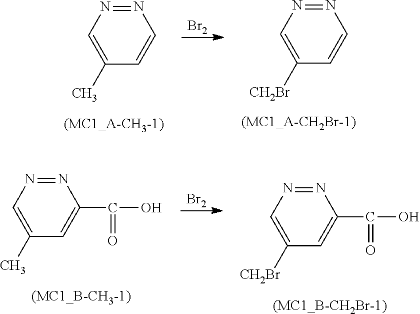

Following the synthesis route of the high-molecular compound having the constitutional unit (UC1) with the heterocyclic ring, to which C1 is bonded as the substituent, except that the monomer (MC1_A-CH₂Br) and the monomer (MC1_B-CH₂Br) are used instead of the monomer (MC1_A-C1) and the monomer (MC1_B-C1), respectively, allows a high-molecular compound having a constitutional unit (UC1) with such a heterocyclic ring, to which CH₂Br is bonded as an alternative substituent, to be synthesized. An exemplary structure of a high-molecular compound synthesized by using the monomer (MC1_A-CH₂Br-1) and the monomer (MC1_B-CH₂Br-1) is shown below as an example.

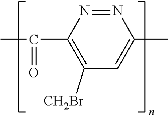

A synthesis route for a high-molecular compound having a constitutional unit (UC1) with a heterocyclic ring, to which CHBr₂ is bonded as a substituent, will be described.

By allowing each of the monomer (MC1_A-CH₂Br) and the monomer (MC1_B-CH₂Br) to react with Br₂, a reaction product containing a monomer (MC1_A-CHBr₂) and a reaction product containing a monomer (MC1_B-CHBr₂) may be respectively produced. It is preferable that these reaction products be classified as appropriate to recover the target monomers. The monomer (MC1_A-CHBr₂) herein refers to at least one monomer selected from the group consisting of monomers (MC1_A-CHBr₂-1) and (MC1_A-CHBr₂-2). The monomer (MC1_B-CHBr₂) herein refers to at least one monomer selected from the group consisting of monomers (MC1_B-CHBr₂-1) and (MC1_B-CHBr₂-2). In the monomers (MC1_A-CHBr₂-1) and (MC1_A-CHBr₂-2), CHBr₂ is substituted for C1 in the monomers (MC1_A-C1-1) and (MC1_A-C1-2), respectively. In the monomers (MC1_B-CHBr₂-1) and (MC1_B-CHBr₂-2), CHBr₂ is substituted for C1 in the monomers (MC1_B-C1-1) and (MC1_B-C1-2), respectively. As an example, a reaction formula for synthesizing the monomer (MC1_A-CHBr₂-1) from the monomer (MC1_A-CH₂Br-1) and a reaction formula for synthesizing the monomer (MC1_B-CHBr₂-1) from the monomer (MC1_B-CH₂Br-1) are shown below:

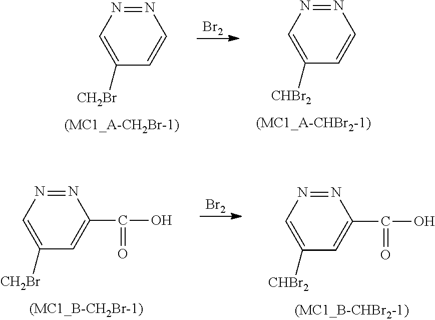

Following the synthesis route of the high-molecular compound having the constitutional unit (UC1) with the heterocyclic ring, to which C1 is bonded as the substituent, except that the monomer (MC1_A-CHBr₂) and the monomer (MC1_B-CHBr₂) are used instead of the monomer (MC1_A-C1) and the monomer (MC1_B-C1), respectively, allows a high-molecular compound having a constitutional unit (UC1) with such a heterocyclic ring, to which CHBr₂ is bonded as an alternative substituent, to be synthesized. An exemplary structure of a high-molecular compound synthesized by using the monomer (MC1_A-CHBr₂-1) and the monomer (MC1_B-CHBr₂-1) is shown below as an example.

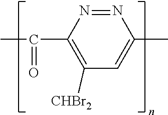

A synthesis route for a high-molecular compound having a constitutional unit (UC1) with a heterocyclic ring, to which CBr₃ is bonded as a substituent, will be described.

By allowing each of the monomer (MC1_A-CHBr₂) and the monomer (MC1_B-CHBr₂) to react with Br₂, a reaction product containing a monomer (MC1_A-CBr₃) and a reaction product containing a monomer (MC1_B-CBr₃) may be respectively produced. It is preferable that these reaction products be classified as appropriate to recover the target monomers. The monomer (MC1_A-CBr₃) herein refers to at least one monomer selected from the group consisting of monomers (MC1_A-CBr₃-1) and (MC1_A-CBr₃-2). The monomer (MC1_B-CBr₃) herein refers to at least one monomer selected from the group consisting of monomers (MC1_B-CBr₃-1) and (MC1_B-CBr₃-2). In the monomers (MC1_A-CBr₃-1) and (MC1_A-CBr₃-2), CBr₃ is substituted for C1 in the monomers (MC1_A-C1-1) and (MC1_A-C1-2), respectively. In the monomers (MC1_B-CBr₃-1) and (MC1_B-CBr₃-2), CBr₃ is substituted for C1 in the monomers (MC1_B-C1-1) and (MC1_B-C1-2), respectively. As an example, a reaction formula for synthesizing the monomer (MC1_A-CBr₃-1) from the monomer (MC1_A-CHBr₂-1) and a reaction formula for synthesizing the monomer (MC1_B-CBr₃-1) from the monomer (MC1_B-CHBr₂-1) are shown below:

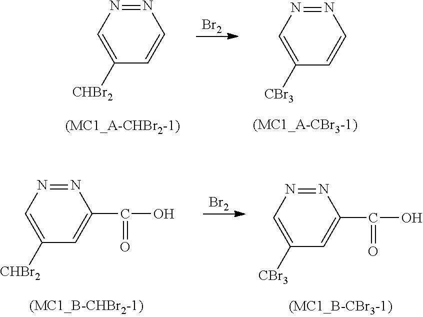

Following the synthesis route of the high-molecular compound having the constitutional unit (UC1) with the heterocyclic ring, to which C1 is bonded as the substituent, except that the monomer (MC1_A-CBr₃) and the monomer (MC1_B-CBr₃) are used instead of the monomer (MC1_A-C1) and the monomer (MC1_B-C1), respectively, allows a high-molecular compound having a constitutional unit (UC1) with such a heterocyclic ring, to which CBr₃ is bonded as an alternative substituent, to be synthesized. An exemplary structure of a high-molecular compound synthesized by using the monomer (MC1_A-CBr₃-1) and the monomer (MC1_B-CBr₃-1) is shown below as an example.

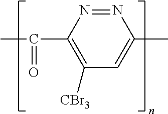

A synthesis route for a high-molecular compound having a constitutional unit (UC1) with a heterocyclic ring, to which CHO is bonded as a substituent, will be described.

By allowing each of the monomer (MC1_A-CH₂Cl) and the monomer (MC1_B-CH₂Cl) to react with NaOH in water and then allowing the reactants to react with HCl, a reaction product containing a monomer (MC1_A-CH₂OH) and a reaction product containing a monomer (MC1_B-CH₂OH) may be respectively produced. It is preferable that these reaction products be classified as appropriate to recover the target monomers. The monomer (MC1_A-CH₂OH) herein refers to at least one monomer selected from the group consisting of monomers (MC1_A-CH₂OH-1) and (MC1_A-CH₂OH-2). The monomer (MC1_B-CH₂OH) herein refers to at least one monomer selected from the group consisting of monomers (MC1_B-CH₂OH-1) and (MC1_B-CH₂OH-2). In the monomers (MC1_A-CH₂OH-1) and (MC1_A-CH₂OH-2), CH₂OH is substituted for C1 in the monomers (MC1_A-C1-1) and (MC1_A-C1-2), respectively. In the monomers (MC1_B-CH₂OH-1) and (MC1_B-CH₂OH-2), CH₂OH is substituted for C1 in the monomers (MC1_B-C1-1) and (MC1_B-C1-2), respectively. As an example, a reaction formula for synthesizing the monomer (MC1_A-CH₂OH-1) from the monomer (MC1_A-CH₂Cl-1) and a reaction formula for synthesizing the monomer (MC1_B-CH₂OH-1) from the monomer (MC1_B-CH₂Cl-1) are shown below:

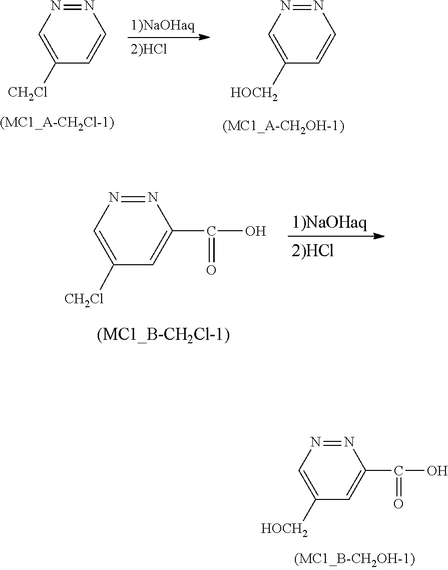

By allowing each of the monomer (MC1_A-CH₂OH) and the monomer (MC1_B-CH₂OH) to react with PCC in a methylene chloride solvent, a reaction product containing a monomer (MC1_A-CHO) and a reaction product containing a monomer (MC1_B-CHO) may be respectively produced. The monomer (MC1_A-CHO) herein refers to at least one monomer selected from the group consisting of monomers (MC1_A-CHO-1) and (MC1_A-CHO-2). The monomer (MC1_B-CHO) herein refers to at least one monomer selected from the group consisting of monomers (MC1_B-CHO-1) and (MC1_B-CHO-2). In the monomers (MC1_A-CHO-1) and (MC1_A-CHO-2), CHO is substituted for C1 in the monomers (MC1_A-C1-1) and (MC1_A-C1-2), respectively. In the monomers (MC1_B-CHO-1) and (MC1_B-CHO-2), CHO is substituted for C1 in the monomers (MC1_B-C1-1) and (MC1_B-C1-2), respectively. As an example, a reaction formula for synthesizing the monomer (MC1_A-CHO-1) from the monomer (MC1_A-CH₂OH-1) and a reaction formula for synthesizing the monomer (MC1_B-CHO-1) from the monomer (MC1_B-CH₂OH-1) are shown below:

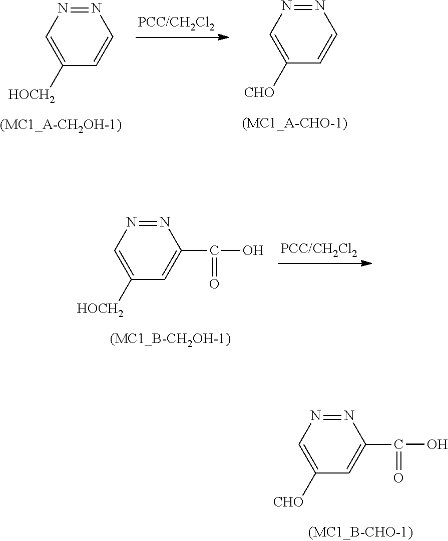

Following the synthesis route of the high-molecular compound having the constitutional unit (UC1) with the heterocyclic ring, to which C1 is bonded as the substituent, except that the monomer (MC1_A-CHO) and the monomer (MC1_B-CHO) are used instead of the monomer (MC1_A-C1) and the monomer (MC1_B-C1), respectively, allows a high-molecular compound having a constitutional unit (UC1) with such a heterocyclic ring, to which CHO is bonded as an alternative substituent, to be synthesized. An exemplary structure of a high-molecular compound synthesized by using the monomer (MC1_A-CHO-1) and the monomer (MC1_B-CHO-1) is shown below as an example:

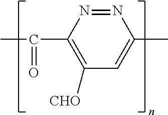

A synthesis route for a high-molecular compound having a constitutional unit (UC1) with a heterocyclic ring, to which COOH is bonded as a substituent, will be described.

By allowing the monomer (MC1_A-CH₂OH) to react with a mixture of potassium dichromate and an aqueous solution of sulfuric acid, a reaction product containing a monomer (MC1_A-COOH) may be produced. Meanwhile, by allowing the monomer (MC1_B-CH₂OH) to react with phosphorus pentachloride and then allowing the reactant to react with a mixture of potassium dichromate and an aqueous solution of sulfuric acid, a reaction product containing a monomer (MC1_C-COOH) may be produced. It is preferable that these reaction products be classified as appropriate to recover the target monomers. The monomer (MC1_A-COOH) herein refers to at least one monomer selected from the group consisting of monomers (MC1_A-COOH-1) and (MC1_A-COOH-2). The monomer (MC1_C-COOH) herein refers to at least one monomer selected from the group consisting of monomers (MC1_C-COOH-1) and (MC1LC-COOH-2). In the monomers (MC1_A-COOH-1) and (MC1_A-COOH-2), COOH is substituted for C1 in the monomers (MC1_A-C1-1) and (MC1_A-C1-2), respectively. In the monomers (MC1_C-COOH-1) and (MC1_C-COOH-2), COOH is substituted for C1 in the monomers (MC1_C-C1-1) and (MC1_C-C1-2), respectively. As an example, a reaction formula for synthesizing the monomer (MC1_A-COOH-1) from the monomer (MC1_A-CH₂OH-1) and a reaction formula for synthesizing the monomer (MC1_C-COOH-1) from the monomer (MC1_B-CH₂OH-1) are shown below.

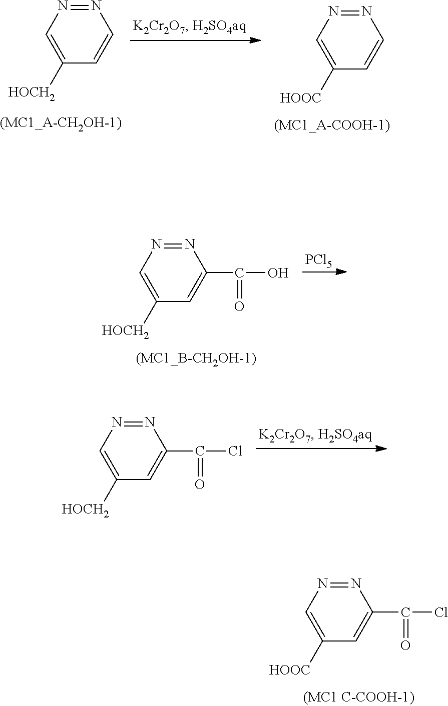

Following the synthesis route of the high-molecular compound having the constitutional unit (UC1) with the heterocyclic ring, to which C1 is bonded as the substituent, except that the monomer (MC1_A-COOH) and the monomer (MC1_C-COOH) are used instead of the monomer (MC1_A-C1) and the monomer (MC1_C-C1), respectively, allows a high-molecular compound having a constitutional unit (UC1) with such a heterocyclic ring, to which COOH is bonded as an alternative substituent, to be synthesized. An exemplary structure of a high-molecular compound synthesized by using the monomer (MC1_A-COOH-1) and the monomer (MC1_C-COOH-1) is shown below as an example.

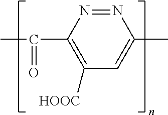

A synthesis route for a high-molecular compound having a constitutional unit (UC1) with a heterocyclic ring, to which CHOHCH₂OH is bonded as a substituent, will be described.

By allowing each of the monomer (MC1_A-C₂H₅) and the monomer (MC1_B-C₂H₅) to react with C12 and then allowing the reactants to react with NaOH in water, a reaction product containing a monomer (MC1_A-CHOHCH₂OH) and a reaction product containing a monomer (MC1_B-CHOHCH₂OH) may be produced. It is preferable that these reaction products be classified as appropriate to recover the target monomers. The monomer (MC1_A-CHOHCH₂OH) herein refers to at least one monomer selected from the group consisting of monomers (MC1_A-CHOHCH₂OH-1) and (MC1_A-CHOHCH₂OH-2). The monomer (MC1_B-CHOHCH₂OH) herein refers to at least one monomer selected from the group consisting of monomers (MC1_B-CHOHCH₂OH-1) and (MC1_B-CHOHCH₂OH-2). In the monomers (MC1_A-CHOHCH₂OH-1) and (MC1_A-CHOHCH₂OH-2), CHOHCH₂OH is substituted for C1 in the monomers (MC1_A-C1-1) and (MC1_A-C1-2), respectively. In the monomers (MC1_B-CHOHCH₂OH-1) and (MC1_B-CHOHCH₂OH-2), CHOHCH₂OH is substituted for C1 in the monomers (MC1_B-C1-1) and (MC1_B-C1-2), respectively. As an example, a reaction formula for synthesizing the monomer (MC1_A-CHOHCH₂OH-1) from the monomer (MC1_A-C2H₅-1) and a reaction formula for synthesizing the monomer (MC1_B-CHOHCH₂OH-1) from the monomer (MC1_B-C₂H₅-1) are shown below.

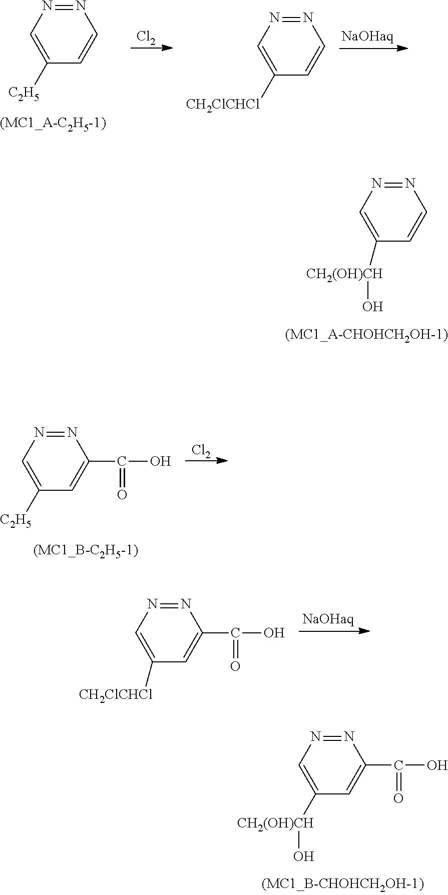

Following the synthesis route of the high-molecular compound having the constitutional unit (UC1) with the heterocyclic ring, to which C1 is bonded as the substituent, except that the monomer (MC1_A-CHOHCH₂OH) and the monomer (MC1_B-CHOHCH₂OH) are used instead of the monomer (MC1_A-C1) and the monomer (MC1_B-C1), respectively, allows a high-molecular compound having a constitutional unit (UC1) with such a heterocyclic ring, to which CHOHCH₂OH is bonded as an alternative substituent, to be synthesized. An exemplary structure of a high-molecular compound synthesized by using the monomer (MC1_A-CHOHCH₂OH-1) and the monomer (MC1_B-CHOHCH₂OH-1) is shown below as an example.

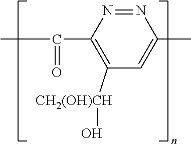

A synthesis route for a high-molecular compound having the constitutional unit (UC2) expressed by the chemical structural formula (C2) will be described.

A high-molecular compound having the constitutional unit (UC2) includes a constitutional unit derived from a monomer synthesized by using the following monomer (MC2_A) as a starting material and a constitutional unit derived from a monomer synthesized by using the following monomer (MC2_B) as a starting material:

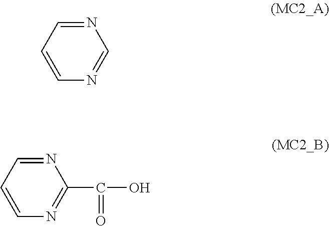 [SMILES: c1cncnc1 ; O=C(O)c1ncccn1]

Following the various reaction methods for introducing substituents that have been mentioned in the foregoing description of the synthesis routes for the high-molecular compounds each having the constitutional unit (UA) and the synthetic routes for the high-molecular compounds each having the constitutional unit (UB) allows a monomer (MC2_A-X-Y) and a monomer (MC2_B-X-Y) each having a heterocyclic ring, to which a substituent is bonded, to be produced from a monomer (MC2_A) and a monomer (MC2_B) as respective starting materials. It is preferable that the monomer (MC2_A-X-Y) and the monomer (MC2_B-X-Y) be classified as appropriate to recover the target monomers. As used herein, X in the monomer (MC2_A-X-Y) denotes a substituent bonded to the heterocyclic ring of (MC2_A) and X in the monomer (MC2_B-X-Y) denotes a substituent bonded to the heterocyclic ring of the monomer (MC2_B). Meanwhile, Y of the monomer (MC2_A-X-Y) denotes a number assigned to each isomer according to the position and number of substituents bonded to the heterocyclic ring, to distinguish the respective isomers produced during the reaction. Y of the monomer (MC2_B-X-Y) denotes a number assigned to each isomer according to the position and number of substituents bonded to the heterocyclic ring, to distinguish the respective isomers produced during the reaction.

A synthesis route for a high-molecular compound having a constitutional unit (UC2) with a heterocyclic ring, to which C1 is bonded as a substituent, will be described.

By allowing each of the monomer (MC2_A) and monomer (MC2_B) as respective starting materials to react with Cl₂, a reaction product containing a monomer (MC2_A-C1) and a reaction product containing a monomer (MC2_B-C1) may be respectively produced. It is preferable that these reaction products be classified as appropriate to recover the target monomers. The monomer (MC2_A-C1) herein refers to at least one monomer selected from the group consisting of monomers (MC2_A-C1-1) and (MC2_A-C1-2). The monomer (MC2_B-C1) herein refers to at least one monomer selected from the group consisting of monomers (MC2_B-C1-1) and (MC2_B-C1-2). Regarding each reaction shown in the description of the synthetic route, the production ratio of each monomer during the reaction may be appropriately optimized by adjusting the reaction duration and reaction temperature. As an example, a reaction formula for synthesizing the monomer (MC2_A-C1-1) from the monomer (MC2_A), a reaction formula for synthesizing the monomer (MC2_B-C1-1) from the monomer (MC2_B), and the respective structures of the monomers (MC2_A-C1-1) and (MC2_A-C1-2) and the monomers (MC2_B-C1-1) and (MC2_B-C1-2) are shown below.

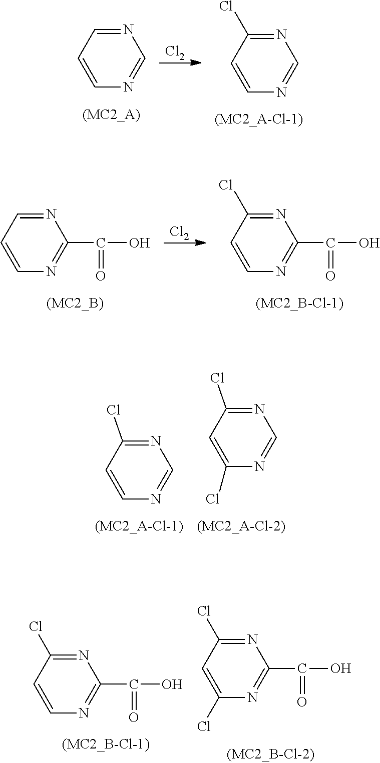

By allowing the monomer (MC2_B-C1) to react with phosphorus pentachloride, a reaction product containing the monomer (MC2_C-C1) may be produced. It is preferable that this reaction product be classified as appropriate to recover the target monomer. The monomer (MC2_C-C1) herein refers to at least one monomer selected from the group consisting of the monomer (MC2_C-C1-1) and the monomer (MC2_C-C1-2). As an example, a reaction formula for synthesizing the monomer (MC2_C-C1-1) from the monomer (MC2_B-C1-1) and the respective structures of the monomers (MC2_C-C1-1) and (MC2_C-C1-2) are shown below.

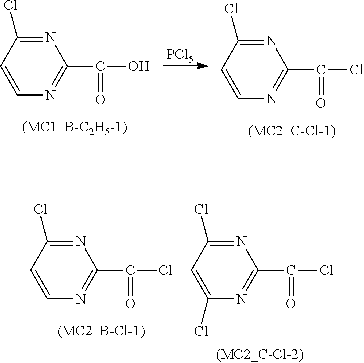

By allowing the monomer (MC2_A-C1) and the monomer (MC2_C-C1) to react with each other using AlCl₃ as a catalyst, a high-molecular compound having the constitutional unit (UC2) with the heterocyclic ring, to which C1 is bonded as a substituent, may be produced. As an example, a reaction formula for synthesizing the target high-molecular compound from the monomer (MC2_A-C1-1) and the monomer (MC2_C-C1-1) is shown below.

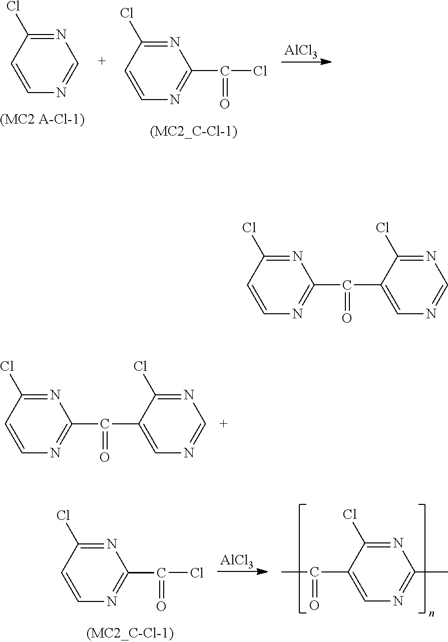

A synthesis route for a high-molecular compound having a constitutional unit (UC2) with a heterocyclic ring, to which F is bonded as a substituent, will be described.

By allowing each of the monomer (MC2_A-C1) and the monomer (MC2_B-C1) to react with KF in a sulfolane solvent, C1 in each of these monomers may be replaced with F and thereby a reaction product containing a monomer (MC2_A-F) and a reaction product containing a monomer (MC2_B-F) may be respectively produced. It is preferable that each of these reaction products be classified as appropriate to recover the target monomer. The monomer (MC2_A-F) herein refers to at least one monomer selected from the group consisting of monomers (MC2_A-F-1) and (MC2_A-F-2). The monomer (MC2_B-F) herein refers to at least one monomer selected from the group consisting of monomers (MC2_B-F-1) and (MC2_B-F-2). In the monomers (MC2_A-F-1) and (MC2_A-F-2), F is substituted for C1 in the monomers (MC2_A-C1-1) and (MC2_A-C1-2), respectively. In the monomers (MC2_B-F-1) and (MC2_B-F-2), F is substituted for C1 in the monomers (MC2_B-C1-1) and (MC2_B-C1-2), respectively. As an example, a reaction formula for synthesizing the monomer (MC2_A-F-1) from the monomer (MC2_A-C1-1) and a reaction formula for synthesizing the monomer (MC2_B-F-1) from the monomer (MC2_B-C1-1) are shown below.

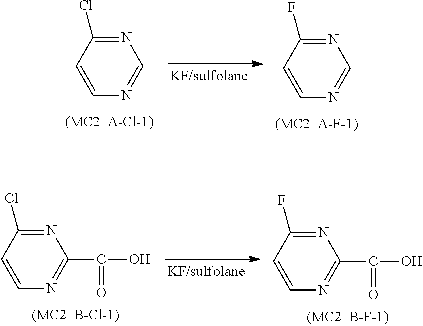 [SMILES: Clc1ccncn1 ; Fc1ccncn1 ; O=C(O)c1nccc(Cl)n1 ; O=C(O)c1nccc(F)n1]

Following the synthesis route of the high-molecular compound having the constitutional unit (UC2) with the heterocyclic ring, to which C1 is bonded as the substituent, except that the monomer (MC2_A-F) and the monomer (MC2_B-F) are used instead of the monomer (MC2_A-C1) and the monomer (MC2_B-C1), respectively, allows a high-molecular compound having a constitutional unit (UC2) with such a heterocyclic ring, to which F is bonded as an alternative substituent, to be synthesized. An exemplary structure of a high-molecular compound synthesized by using the monomer (MC2_A-F-1) and the monomer (MC2_B-F-1) is shown below as an example.

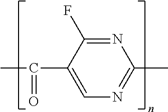

A synthesis route for a high-molecular compound having a constitutional unit (UC2) with a heterocyclic ring, to which Br is bonded as a substituent, will be described.

By allowing each of the monomer (MC2_A) and the monomer (MC2_B) as respective starting materials to react with Br₂, a reaction product containing a monomer (MC2_A-Br) and a reaction product containing a monomer (MC2_B-Br) may be respectively produced. It is preferable that these reaction products be classified as appropriate to recover the target monomers. The monomer (MC2_A-Br) herein refers to at least one monomer selected from the group consisting of monomers (MC2_A-Br-1) and (MC2_A-Br-2). The monomer (MC2_B-Br) herein refers to at least one monomer selected from the group consisting of monomers (MC2_B-Br-1) and (MC2_B-Br-2). In the monomers (MC2_A-Br-1) and (MC2_A-Br-2), Br is substituted for C1 in the monomers (MC2_A-C1-1) and (MC2_A-C1-2), respectively. In the monomers (MC2_B-Br-1) and (MC2_B-Br-2), Br is substituted for C1 in the monomers (MC2_B-C1-1) and (MC2_B-C1-2), respectively. As an example, a reaction formula for synthesizing the monomer (MC2_A-Br-1) from the monomer (MC2_A) and a reaction formula for synthesizing the monomer (MC2_B-Br-1) from the monomer (MC2_B) are shown below.

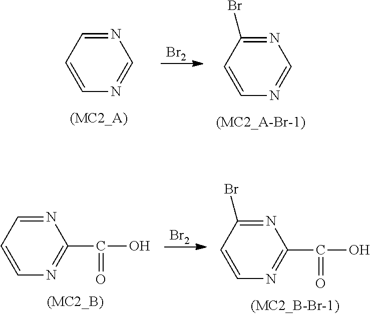

Following the synthesis route of the high-molecular compound having the constitutional unit (UC2) with the heterocyclic ring, to which C1 is bonded as the substituent, except that the monomer (MC2_A-Br) and the monomer (MC2_B-Br) are used instead of the monomer (MC2_A-C1) and the monomer (MC2_B-C1), respectively, allows a high-molecular compound having a constitutional unit (UC2) with such a heterocyclic ring, to which Br is bonded as an alternative substituent, to be synthesized. An exemplary structure of a high-molecular compound synthesized by using the monomer (MC2_A-Br-1) and the monomer (MC2_B-Br-1) is shown below as an example.

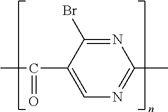

A synthesis route for a high-molecular compound having a constitutional unit (UC2) with a heterocyclic ring, to which OH is bonded as a substituent, will be described.

By allowing each of the monomer (MC2_A-C1) and the monomer (MC2_B-C1) to react with NaOH in water, C1 may be replaced with OH and thereby a reaction product containing a monomer (MC2_A-OH) and a reaction product containing a monomer (MC2_B-OH) may be respectively produced. It is preferable that these reaction products be classified as appropriate to recover the target monomers. The monomer (MC2_A-OH) herein refers to at least one monomer selected from the group consisting of monomers (MC2_A-OH-1) and (MC2_A-OH-2). The monomer (MC2_B-OH) herein refers to at least one monomer selected from the group consisting of monomers (MC2_B-OH-1) and (MC2_B-OH-2). In the monomers (MC2_A-OH-1) and (MC2_A-OH-2), OH is substituted for C1 in the monomers (MC2_A-C1-1) and (MC2_A-C1-2), respectively. In the monomers (MC2_B-OH-1) and (MC2_B-OH-2), OH is substituted for C1 in the monomers (MC2_B-C1-1) and (MC2_B-C1-2), respectively. As an example, a reaction formula for synthesizing the monomer (MC2_A-OH-1) from the monomer (MC2_A-C1-1) and a reaction formula for synthesizing the monomer (MC2_B-OH-1) from the monomer (MC2_B-C1-1) are shown below.

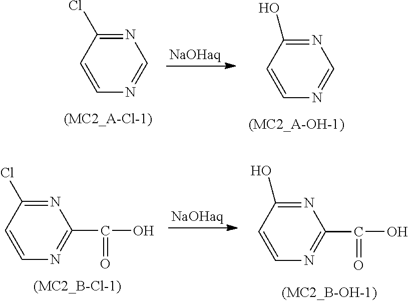

Following the synthesis route of the high-molecular compound having the constitutional unit (UC2) with the heterocyclic ring, to which C1 is bonded as the substituent, except that the monomer (MC2_A-OH) and the monomer (MC2_B-OH) are used instead of the monomer (MC2_A-C1) and the monomer (MC2_B-C1), respectively, allows a high-molecular compound having a constitutional unit (UC2) with such a heterocyclic ring, to which OH is bonded as an alternative substituent, to be synthesized. An exemplary structure of a high-molecular compound synthesized by using the monomer (MC2_A-OH-1) and the monomer (MC2_B-OH-1) is shown below as an example.

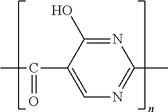

A synthesis route for a high-molecular compound having a constitutional unit (UC2) with a heterocyclic ring, to which CH₃ is bonded as a substituent, will be described.

By allowing each of the monomer (MC2_A) and the monomer (MC2_B) as respective starting materials to react with CH₃C1 in the presence of AlCl₃, a reaction product containing a monomer (MC2_A-CH₃) and a reaction product containing a monomer (MC2_B-CH₃) may be respectively produced. It is preferable that these reaction products be classified as appropriate to recover the target monomers. The monomer (MC2_A-CH₃) herein refers to at least one monomer selected from the group consisting of monomers (MC2_A-CH₃-1) and (MC2_A-CH₃-2). The monomer (MC2_B-CH₃) herein refers to at least one monomer selected from the group consisting of monomers (MC2_B-CH₃-1) and (MC2_B-CH₃-2). In the monomers (MC2_A-CH₃-1) and (MC2_A-CH₃-2), CH₃ is substituted for C1 in the monomers (MC2_A-C1-1) and (MC2_A-C1-2), respectively. In the monomers (MC2_B-CH₃-1) and (MC2_B-CH₃-2), CH₃ is substituted for C1 in the monomers (MC2_B-C1-1) and (MC2_B-C1-2), respectively. As an example, a reaction formula for synthesizing the monomer (MC2_A-CH₃-1) from the monomer (MC2_A) and a reaction formula for synthesizing the monomer (MC2_B-CH₃-1) from the monomer (MC2_B) are shown below.

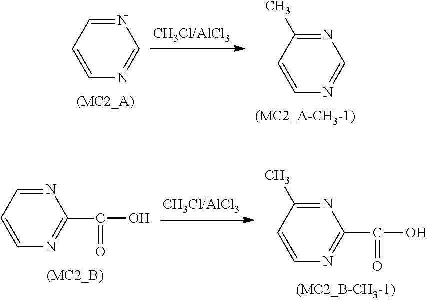

Following the synthesis route of the high-molecular compound having the constitutional unit (UC2) with the heterocyclic ring, to which C1 is bonded as the substituent, except that the monomer (MC2_A-CH₃) and the monomer (MC2_B-CH₃) are used instead of the monomer (MC2_A-C1) and the monomer (MC2_B-C1), respectively, allows a high-molecular compound having a constitutional unit (UC2) with such a heterocyclic ring, to which CH₃ is bonded as an alternative substituent, to be synthesized. An exemplary structure of a high-molecular compound synthesized by using the monomer (MC2_A-CH₃-1) and the monomer (MC2_B-CH₃-1) is shown below as an example.

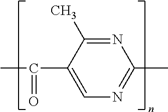

A synthesis route for a high-molecular compound having a constitutional unit (UC2) with a heterocyclic ring, to which C₂H₅ is bonded as a substituent, will be described.

By allowing each of the monomer (MC2_A) and the monomer (MC2_B) as respective starting materials to react with C₂H₅Li, a reaction product containing a monomer (MC2_A-C₂H₅) and a reaction product containing a monomer (MC2_B-C2H₅) may be respectively produced. It is preferable that these reaction products be classified as appropriate to recover the target monomers. The monomer (MC2_A-C₂H₅) herein refers to at least one monomer selected from the group consisting of monomers (MC2_A-C₂H₅-1) and (MC2_A-C₂H₅-2). The monomer (MC2_B-C₂H₅) herein refers to at least one monomer selected from the group consisting of monomers (MC2_B-C₂H₅-1) and (MC2_B-C₂H₅-2). In the monomers (MC2_A-C₂H₅-1) and (MC2_A-C₂H₅-2), C₂H₅ is substituted for C1 in the monomers (MC2_A-C1-1) and (MC2_A-C1-2), respectively. In the monomers (MC2_B-C₂H₅-1) and (MC2_B-C₂H₅-2), C₂H₅ is substituted for C1 in the monomers (MC2_B-C1-1) and (MC2_B-C1-2), respectively. As an example, a reaction formula for synthesizing the monomer (MC2_A-C₂H₅-1) from the monomer (MC2_A) and a reaction formula for synthesizing the monomer (MC2_B-C₂H₅-1) from the monomer (MC2_B) are shown below.

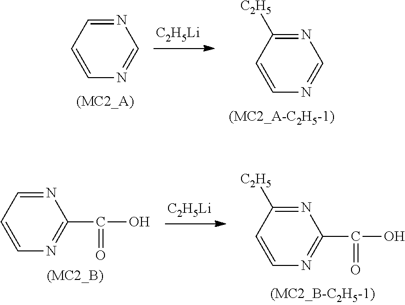 [SMILES: "C2H5Li" ; "C2H5Li" ; c1cncnc1 ; CCc1ccncn1 ; O=C(O)c1ncccn1 ; CCc1ccnc(C(=O)O)n1]

Following the synthesis route of the high-molecular compound having the constitutional unit (UC2) with the heterocyclic ring, to which C1 is bonded as the substituent, except that the monomer (MC2_A-C₂H₅) and the monomer (MC2_B-C₂H₅) are used instead of the monomer (MC2_A-C1) and the monomer (MC2_B-C1), respectively, allows a high-molecular compound having a constitutional unit (UC2) with such a heterocyclic ring, to which C₂H₅ is bonded as an alternative substituent, to be synthesized. An exemplary structure of a high-molecular compound synthesized by using the monomer (MC2_A-C2H₅-1) and the monomer (MC2_B-C2H₅-1) is shown below as an example.

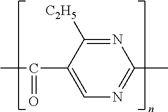

A synthesis route for a high-molecular compound having a constitutional unit (UC2) with a heterocyclic ring, to which CH₂F is bonded as a substituent, will be described.

By allowing each of the monomer (MC2_A-CH₃) and the monomer (MC2_B-CH₃) to react with F₂, a reaction product containing a monomer (MC2_A-CH₂F) and a reaction product containing a monomer (MC2_B-CH₂F) may be respectively produced. It is preferable that these reaction products be classified as appropriate to recover the target monomers. The monomer (MC2_A-CH₂F) herein refers to at least one monomer selected from the group consisting of monomers (MC2_A-CH₂F-1) and (MC2_A-CH₂F-2). The monomer (MC2_B-CH₂F) herein refers to at least one monomer selected from the group consisting of monomers (MC2_B-CH₂F-1) and (MC2_B-CH₂F-2). In the monomers (MC2_A-CH₂F-1) and (MC2_A-CH₂F-2), CH₂F is substituted for C1 in the monomers (MC2_A-C1-1) and (MC2_A-C1-2), respectively. In the monomers (MC2_B-CH₂F-1) and (MC2_B-CH₂F-2), CH₂F is substituted for C1 in the monomers (MC2_B-C1-1) and (MC2_B-C1-2), respectively. As an example, a reaction formula for synthesizing the monomer (MC2_A-CH₂F-1) from the monomer (MC2_A-CH₃-1) and a reaction formula for synthesizing the monomer (MC2_B-CH₂F-1) from the monomer (MC2_B-CH₃-1) are shown below.

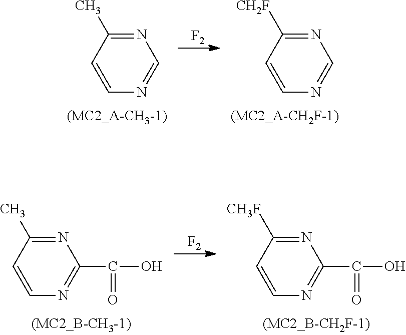

Following the synthesis route of the high-molecular compound having the constitutional unit (UC2) with the heterocyclic ring, to which C1 is bonded as the substituent, except that the monomer (MC2_A-CH₂F) and the monomer (MC2_B-CH₂F) are used instead of the monomer (MC2_A-C1) and the monomer (MC2_B-C1), respectively, allows a high-molecular compound having a constitutional unit (UC2) with such a heterocyclic ring, to which CH₂F is bonded as an alternative substituent, to be synthesized. An exemplary structure of a high-molecular compound synthesized by using the monomer (MC2_A-CH₂F-1) and the monomer (MC2_B-CH₂F-1) is shown below as an example.

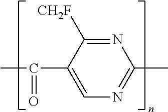

A synthesis route for a high-molecular compound having a constitutional unit (UC2) with a heterocyclic ring, to which CHF₂ is bonded as a substituent, will be described.

By allowing each of the monomer (MC2_A-CH₂F) and the monomer (MC2_B-CH₂F) to react with F₂, a reaction product containing a monomer (MC2_A-CHF₂) and a reaction product containing a monomer (MC2_B-CHF₂) may be respectively produced. It is preferable that these reaction products be classified as appropriate to recover the target monomers. The monomer (MC2_A-CHF₂) herein refers to at least one monomer selected from the group consisting of monomers (MC2_A-CHF₂-1) and (MC2_A-CHF₂-2). The monomer (MC2_B-CHF₂) herein refers to at least one monomer selected from the group consisting of monomers (MC2_B-CHF₂-1) and (MC2_B-CHF₂-2). In the monomers (MC2_A-CHF₂-1) and (MC2_A-CHF₂-2), CHF₂ is substituted for C1 in the monomers (MC2_A-C1-1) and (MC2_A-C1-2), respectively. In the monomers (MC2_B-CHF₂-1) and (MC2_B-CHF₂-2), CHF₂ is substituted for C1 in the monomers (MC2_B-C1-1) and (MC2_B-C1-2), respectively. As an example, a reaction formula for synthesizing the monomer (MC2_A-CHF₂-1) from the monomer (MC2_A-CH₂F-1) and a reaction formula for synthesizing the monomer (MC2_B-CHF₂-1) from the monomer (MC2_B-CH₂F-1) are shown below.

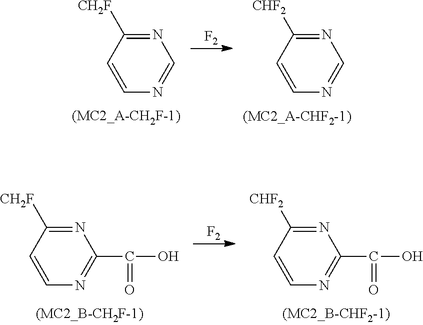

Following the synthesis route of the high-molecular compound having the constitutional unit (UC2) with the heterocyclic ring, to which C1 is bonded as the substituent, except that the monomer (MC2_A-CHF₂) and the monomer (MC2_B-CHF₂) are used instead of the monomer (MC2_A-C1) and the monomer (MC2_B-C1), respectively, allows a high-molecular compound having a constitutional unit (UC2) with such a heterocyclic ring, to which CHF₂ is bonded as an alternative substituent, to be synthesized. An exemplary structure of a high-molecular compound synthesized by using the monomer (MC2_A-CHF₂-1) and the monomer (MC2_B-CHF₂-1) is shown below as an example.

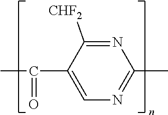

A synthesis route for a high-molecular compound having a constitutional unit (UC2) with a heterocyclic ring, to which CF₃ is bonded as a substituent, will be described.

By allowing each of the monomer (MC2_A-CHF₂) and the monomer (MC2_B-CHF₂) to react with F₂, a reaction product containing a monomer (MC2_A-CF₃) and a reaction product containing a monomer (MC2_B-CF₃) may be respectively produced. It is preferable that these reaction products be classified as appropriate to recover the target monomers. The monomer (MC2_A-CF₃) herein refers to at least one monomer selected from the group consisting of monomers (MC2_A-CF₃-1) and (MC2_A-CF₃-2). The monomer (MC2_B-CF₃) herein refers to at least one monomer selected from the group consisting of monomers (MC2_B-CF₃-1) and (MC2_B-CF₃-2). In the monomers (MC2_A-CF₃-1) and (MC2_A-CF₃-2), CF₃ is substituted for C1 in the monomers (MC2_A-C1-1) and (MC2_A-C1-2), respectively. In the monomers (MC2_B-CF₃-1) and (MC2_B-CF₃-2), CF₃ is substituted for C1 in the monomers (MC2_B-C1-1) and (MC2_B-C1-2), respectively. As an example, a reaction formula for synthesizing the monomer (MC2_A-CF₃-1) from the monomer (MC2_A-CHF₂-1) and a reaction formula for synthesizing the monomer (MC2_B-CF₃-1) from the monomer (MC2_B-CHF₂-1) are shown below:

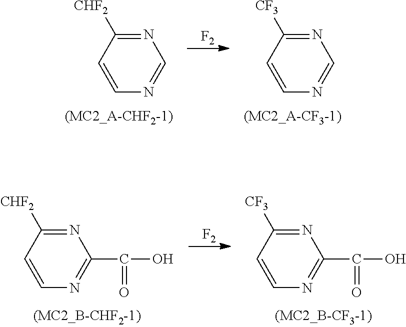

Following the synthesis route of the high-molecular compound having the constitutional unit (UC2) with the heterocyclic ring, to which C1 is bonded as the substituent, except that the monomer (MC2_A-CF₃) and the monomer (MC2_B-CF₃) are used instead of the monomer (MC2_A-C1) and the monomer (MC2_B-C1), respectively, allows a high-molecular compound having a constitutional unit (UC2) with such a heterocyclic ring, to which CF₃ is bonded as an alternative substituent, to be synthesized. An exemplary structure of a high-molecular compound synthesized by using the monomer (MC2_A-CF₃-1) and the monomer (MC2_B-CF₃-1) is shown below as an example.

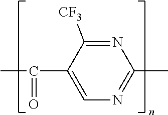

A synthesis route for a high-molecular compound having a constitutional unit (UC2) with a heterocyclic ring, to which CH₂Cl is bonded as a substituent, will be described.

By allowing each of the monomer (MC2_A-CH₃) and the monomer (MC2_B-CH₃) to react with Cl₂, a reaction product containing a monomer (MC2_A-CH₂Cl) and a reaction product containing a monomer (MC2_B-CH₂Cl) may be respectively produced. It is preferable that these reaction products be classified as appropriate to recover the target monomers. The monomer (MC2_A-CH₂Cl) herein refers to at least one monomer selected from the group consisting of monomers (MC2_A-CH₂Cl-1) and (MC2_A-CH₂Cl-2). The monomer (MC2_B-CH₂Cl) herein refers to at least one monomer selected from the group consisting of monomers (MC2_B-CH₂Cl-1) and (MC2_B-CH₂Cl-2). In the monomers (MC2_A-CH₂Cl-1) and (MC2_A-CH₂Cl-2), CH₂Cl is substituted for C1 in the monomers (MC2_A-C1-1) and (MC2_A-C1-2), respectively. In the monomers (MC2_B-CH₂Cl-1) and (MC2_B-CH₂Cl-2), CH₂Cl is substituted for C1 in the monomers (MC2_B-C1-1) and (MC2_B-C1-2), respectively. As an example, a reaction formula for synthesizing the monomer (MC2_A-CH₂Cl-1) from the monomer (MC2_A-CH₃-1) and a reaction formula for synthesizing the monomer (MC2_B-CH₂Cl-1) from the monomer (MC2_B-CH₃-1) are shown below:

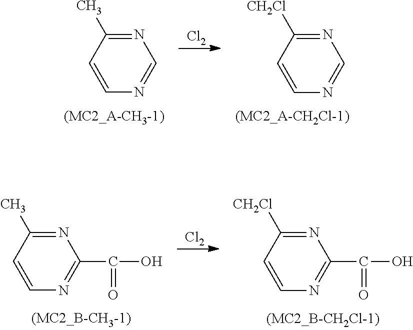

Following the synthesis route of the high-molecular compound having the constitutional unit (UC2) with the heterocyclic ring, to which C1 is bonded as the substituent, except that the monomer (MC2_A-CH₂Cl) and the monomer (MC2_B-CH₂Cl) are used instead of the monomer (MC2_A-C1) and the monomer (MC2_B-C1), respectively, allows a high-molecular compound having a constitutional unit (UC2) with such a heterocyclic ring, to which CH₂Cl is bonded as an alternative substituent, to be synthesized. An exemplary structure of a high-molecular compound synthesized by using the monomer (MC2_A-CH₂Cl-1) and the monomer (MC2_B-CH₂Cl-1) is shown below as an example.

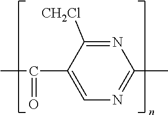

A synthesis route for a high-molecular compound having a constitutional unit (UC2) with a heterocyclic ring, to which CHCl₂ is bonded as a substituent, will be described.

By allowing each of the monomer (MC2_A-CH₂Cl) and the monomer (MC2_B-CH₂Cl) to react with Cl₂, a reaction product containing a monomer (MC2_A-CHCl₂) and a reaction product containing a monomer (MC2_B-CHCl₂) may be respectively produced. It is preferable that these reaction products be classified as appropriate to recover the target monomers. The monomer (MC2_A-CHCl₂) herein refers to at least one monomer selected from the group consisting of monomers (MC2_A-CHCl₂-1) and (MC2_A-CHCl₂-2). The monomer (MC2_B-CHCl₂) herein refers to at least one monomer selected from the group consisting of monomers (MC2_B-CHCl₂-1) and (MC2_B-CHCl₂-2). In the monomers (MC2_A-CHCl₂-1) and (MC2_A-CHCl₂-2), CHCl₂ is substituted for C1 in the monomers (MC2_A-C1-1) and (MC2_A-C1-2), respectively. In the monomers (MC2_B-CHCl₂-1) and (MC2_B-CHCl₂-2), CHCl₂ is substituted for C1 in the monomers (MC2_B-C1-1) and (MC2_B-C1-2), respectively. As an example, a reaction formula for synthesizing the monomer (MC2_A-CHCl₂-1) from the monomer (MC2_A-CH₂Cl-1) and a reaction formula for synthesizing the monomer (MC2_B-CHCl₂-1) from the monomer (MC2_B-CH₂Cl-1) are shown below.

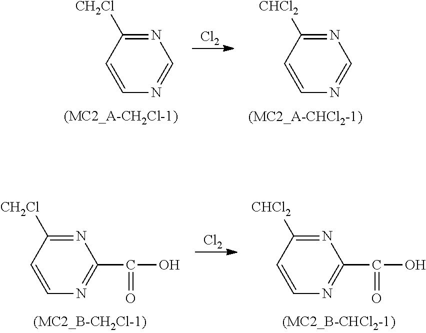

Following the synthesis route of the high-molecular compound having the constitutional unit (UC2) with the heterocyclic ring, to which C1 is bonded as the substituent, except that the monomer (MC2_A-CHCl₂) and the monomer (MC2_B-CHCl₂) are used instead of the monomer (MC2_A-C1) and the monomer (MC2_B-C1), respectively, allows a high-molecular compound having a constitutional unit (UC2) with such a heterocyclic ring, to which CHCl₂ is bonded as an alternative substituent, to be synthesized. An exemplary structure of a high-molecular compound synthesized by using the monomer (MC2_A-CHCl₂-1) and the monomer (MC2_B-CHCl₂-1) is shown below as an example.

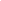

A synthesis route for a high-molecular compound having a constitutional unit (UC2) with a heterocyclic ring, to which CCl₃ is bonded as a substituent, will be described.

By allowing each of the monomer (MC2_A-CHCl₂) and the monomer (MC2_B-CHCl₂) to react with Cl₂, a reaction product containing a monomer (MC2_A-CCl₃) and a reaction product containing a monomer (MC2_B-CCl₃) may be respectively produced. It is preferable that these reaction products be classified as appropriate to recover the target monomers. The monomer (MC2_A-CCl₃) herein refers to at least one monomer selected from the group consisting of monomers (MC2_A-CCl₃-1) and (MC2_A-CCl₃-2). The monomer (MC2_B-CCl₃) herein refers to at least one monomer selected from the group consisting of monomers (MC2_B-CCl₃-1) and (MC2_B-CCl₃-2). In the monomers (MC2_A-CCl₃-1) and (MC2_A-CCl₃-2), CCl₃ is substituted for C1 in the monomers (MC2_A-C1-1) and (MC2_A-C1-2), respectively. In the monomers (MC2_B-CCl₃-1) and (MC2_B-CCl₃-2), CCl₃ is substituted for C1 in the monomers (MC2_B-C1-1) and (MC2_B-C1-2), respectively. As an example, a reaction formula for synthesizing the monomer (MC2_A-CCl₃-1) from the monomer (MC2_A-CHCl₂-1) and a reaction formula for synthesizing the monomer (MC2_B-CCl₃-1) from the monomer (MC2_B-CHCl₂-1) are shown below.

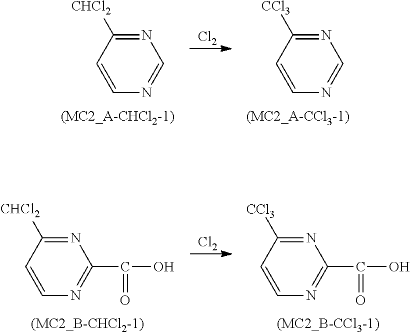

Following the synthesis route of the high-molecular compound having the constitutional unit (UC2) with the heterocyclic ring, to which C1 is bonded as the substituent, except that the monomer (MC2_A-CCl₃) and the monomer (MC2_B-CCl₃) are used instead of the monomer (MC2_A-C1) and the monomer (MC2_B-C1), respectively, allows a high-molecular compound having a constitutional unit (UC2) with such a heterocyclic ring, to which CCl₃ is bonded as an alternative substituent, to be synthesized. An exemplary structure of a high-molecular compound synthesized by using the monomer (MC2_A-CCl₃-1) and the monomer (MC2_B-CCl₃-1) is shown below as an example.

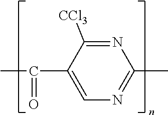

A synthesis route for a high-molecular compound having a constitutional unit (UC2) with a heterocyclic ring, to which CH₂Br is bonded as a substituent, will be described.

By allowing each of the monomer (MC2_A-CH₃) and the monomer (MC2_B-CH₃) to react with Br₂, a reaction product containing a monomer (MC2_A-CH₂Br) and a reaction product containing a monomer (MC2_B-CH₂Br) may be respectively produced. It is preferable that these reaction products be classified as appropriate to recover the target monomers. The monomer (MC2_A-CH₂Br) herein refers to at least one monomer selected from the group consisting of monomers (MC2_A-CH₂Br-1) and (MC2_A-CH₂Br-2). The monomer (MC2_B-CH₂Br) herein refers to at least one monomer selected from the group consisting of monomers (MC2_B-CH₂Br-1) and (MC2_B-CH₂Br-2). In the monomers (MC2_A-CH₂Br-1) and (MC2_A-CH₂Br-2), CH₂Br is substituted for C1 in the monomers (MC2_A-C1-1) and (MC2_A-C1-2), respectively. In the monomers (MC2_B-CH₂Br-1) and (MC2_B-CH₂Br-2), CH₂Br is substituted for C1 in the monomers (MC2_B-C1-1) and (MC2_B-C1-2), respectively. As an example, a reaction formula for synthesizing the monomer (MC2_A-CH₂Br-1) from the monomer (MC2_A-CH₃-1) and a reaction formula for synthesizing the monomer (MC2_B-CH₂Br-1) from the monomer (MC2_B-CH₃-1) are shown below:

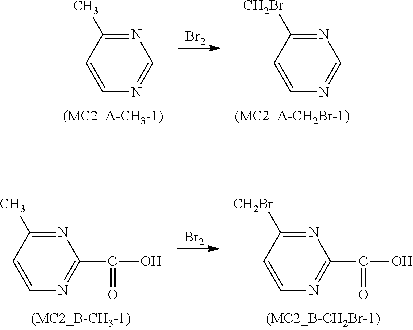

Following the synthesis route of the high-molecular compound having the constitutional unit (UC2) with the heterocyclic ring, to which C1 is bonded as the substituent, except that the monomer (MC2_A-CH₂Br) and the monomer (MC2_B-CH₂Br) are used instead of the monomer (MC2_A-C1) and the monomer (MC2_B-C1), respectively, allows a high-molecular compound having a constitutional unit (UC2) with such a heterocyclic ring, to which CH₂Br is bonded as an alternative substituent, to be synthesized. An exemplary structure of a high-molecular compound synthesized by using the monomer (MC2_A-CH₂Br-1) and the monomer (MC2_B-CH₂Br-1) is shown below as an example.

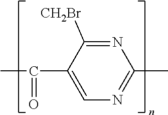

A synthesis route for a high-molecular compound having a constitutional unit (UC2) with a heterocyclic ring, to which CHBr₂ is bonded as a substituent, will be described.

By allowing each of the monomer (MC2_A-CH₂Br) and the monomer (MC2_B-CH₂Br) to react with Br₂, a reaction product containing a monomer (MC2_A-CHBr₂) and a reaction product containing a monomer (MC2_B-CHBr₂) may be respectively produced. It is preferable that these reaction products be classified as appropriate to recover the target monomers. The monomer (MC2_A-CHBr₂) herein refers to at least one monomer selected from the group consisting of monomers (MC2_A-CHBr₂-1) and (MC2_A-CHBr₂-2). The monomer (MC2_B-CHBr₂) herein refers to at least one monomer selected from the group consisting of monomers (MC2_B-CHBr₂-1) and (MC2_B-CHBr₂-2). In the monomers (MC2_A-CHBr₂-1) and (MC2_A-CHBr₂-2), CHBr₂ is substituted for C1 in the monomers (MC2_A-C1-1) and (MC2_A-C1-2), respectively. In the monomers (MC2_B-CHBr₂-1) and (MC2_B-CHBr₂-2), CHBr₂ is substituted for C1 in the monomers (MC2_B-C1-1) and (MC2_B-C1-2), respectively. As an example, a reaction formula for synthesizing the monomer (MC2_A-CHBr₂-1) from the monomer (MC2_A-CH₂Br-1) and a reaction formula for synthesizing the monomer (MC2_B-CHBr₂-1) from the monomer (MC2_B-CH₂Br-1) are shown below.

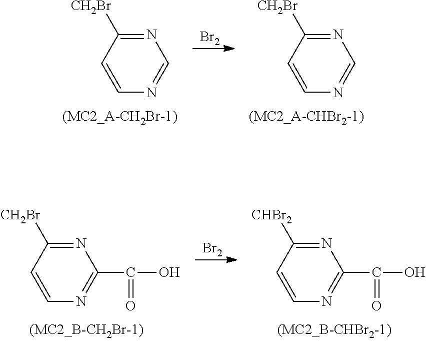

Following the synthesis route of the high-molecular compound having the constitutional unit (UC2) with the heterocyclic ring, to which C1 is bonded as the substituent, except that the monomer (MC2_A-CHBr₂) and the monomer (MC2_B-CHBr₂) are used instead of the monomer (MC2_A-C1) and the monomer (MC2_B-C1), respectively, allows a high-molecular compound having a constitutional unit (UC2) with such a heterocyclic ring, to which CHBr₂ is bonded as an alternative substituent, to be synthesized. An exemplary structure of a high-molecular compound synthesized by using the monomer (MC2_A-CHBr₂-1) and the monomer (MC2_B-CHBr₂-1) is shown below as an example.

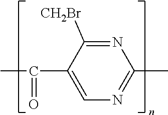

A synthesis route for a high-molecular compound having a constitutional unit (UC2) with a heterocyclic ring, to which CBr₃ is bonded as a substituent, will be described.

By allowing each of the monomer (MC2_A-CHBr₂) and the monomer (MC2_B-CHBr₂) to react with Br₂, a reaction product containing a monomer (MC2_A-CBr₃) and a reaction product containing a monomer (MC2_B-CBr₃) may be respectively produced. It is preferable that these reaction products be classified as appropriate to recover the target monomers. The monomer (MC2_A-CBr₃) herein refers to at least one monomer selected from the group consisting of monomers (MC2_A-CBr₃-1) and (MC2_A-CBr₃-2). The monomer (MC2_B-CBr₃) herein refers to at least one monomer selected from the group consisting of monomers (MC2_B-CBr₃-1) and (MC2_B-CBr₃-2). In the monomers (MC2_A-CBr₃-1) and (MC2_A-CBr₃-2), CBr₃ is substituted for C1 in the monomers (MC2_A-C1-1) and (MC2_A-C1-2), respectively. In the monomers (MC2_B-CBr₃-1) and (MC2_B-CBr₃-2), CBr₃ is substituted for C1 in the monomers (MC2_B-C1-1) and (MC2_B-C1-2), respectively. As an example, a reaction formula for synthesizing the monomer (MC2_A-CBr₃-1) from the monomer (MC2_A-CHBr₂-1) and a reaction formula for synthesizing the monomer (MC2_B-CBr₃-1) from the monomer (MC2_B-CHBr₂-1) are shown below.

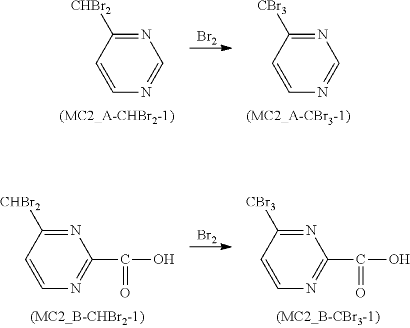

Following the synthesis route of the high-molecular compound having the constitutional unit (UC2) with the heterocyclic ring, to which C1 is bonded as the substituent, except that the monomer (MC2_A-CBr₃) and the monomer (MC2_B-CBr₃) are used instead of the monomer (MC2_A-C1) and the monomer (MC2_B-C1), respectively, allows a high-molecular compound having a constitutional unit (UC2) with such a heterocyclic ring, to which CBr₃ is bonded as an alternative substituent, to be synthesized. An exemplary structure of a high-molecular compound synthesized by using the monomer (MC2_A-CBr₃-1) and the monomer (MC2_B-CBr₃-1) is shown below as an example.

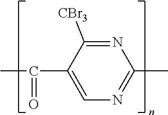

A synthesis route for a high-molecular compound having a constitutional unit (UC2) with a heterocyclic ring, to which CHO is bonded as a substituent, will be described.

By allowing each of the monomer (MC2_A-CH₂Cl) and the monomer (MC2_B-CH₂Cl) to react with NaOH in water and then allowing the reactants to react with HCl, a reaction product containing a monomer (MC2_A-CH₂OH) and a reaction product containing a monomer (MC2_B-CH₂OH) may be respectively produced. It is preferable that these reaction products be classified as appropriate to recover the target monomers. The monomer (MC2_A-CH₂OH) herein refers to at least one monomer selected from the group consisting of monomers (MC2_A-CH₂OH-1) and (MC2_A-CH₂OH-2). The monomer (MC2_B-CH₂OH) herein refers to at least one monomer selected from the group consisting of monomers (MC2_B-CH₂OH-1) and (MC2_B-CH₂OH-2). In the monomers (MC2_A-CH₂OH-1) and (MC2_A-CH₂OH-2), CH₂OH is substituted for C1 in the monomers (MC2_A-C1-1) and (MC2_A-C1-2), respectively. In the monomers (MC2_B-CH₂OH-1) and (MC2_B-CH₂OH-2), CH₂OH is substituted for C1 in the monomers (MC2_B-C1-1) and (MC2_B-C1-2), respectively. As an example, a reaction formula for synthesizing the monomer (MC2_A-CH₂OH-1) from the monomer (MC2_A-CH₂Cl-1) and a reaction formula for synthesizing the monomer (MC2_B-CH₂OH-1) from the monomer (MC2_B-CH₂Cl-1) are shown below:

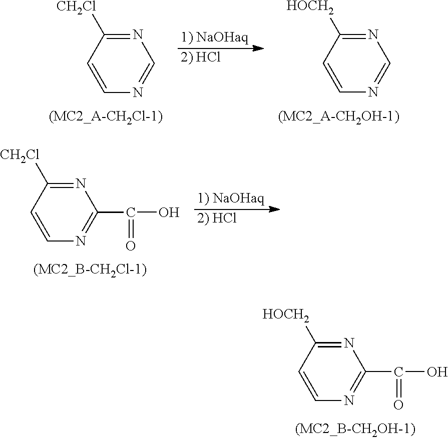

By allowing each of the monomer (MC2_A-CH₂OH) and the monomer (MC2_B-CH₂OH) to react with PCC in a methylene chloride solvent, a reaction product containing a monomer (MC2_A-CHO) and a reaction product containing a monomer (MC2_B-CHO) may be respectively produced. The monomer (MC2_A-CHO) herein refers to at least one monomer selected from the group consisting of monomers (MC2_A-CHO-1) and (MC2_A-CHO-2). The monomer (MC2_B-CHO) herein refers to at least one monomer selected from the group consisting of monomers (MC2_B-CHO-1) and (MC2_B-CHO-2). In the monomers (MC2_A-CHO-1) and (MC2_A-CHO-2), CHO is substituted for C1 in the monomers (MC2_A-C1-1) and (MC2_A-C1-2), respectively. In the monomers (MC2_B-CHO-1) and (MC2_B-CHO-2), CHO is substituted for C1 in the monomers (MC2_B-C1-1) and (MC2_B-C1-2), respectively. As an example, a reaction formula for synthesizing the monomer (MC2_A-CHO-1) from the monomer (MC2_A-CH₂OH-1) and a reaction formula for synthesizing the monomer (MC2_B-CHO-1) from the monomer (MC2_B-CH₂OH-1) are shown below.

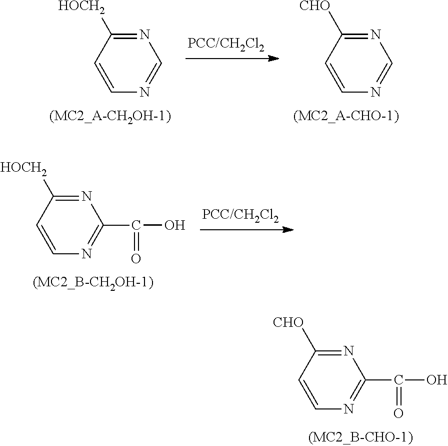

Following the synthesis route of the high-molecular compound having the constitutional unit (UC2) with the heterocyclic ring, to which C1 is bonded as the substituent, except that the monomer (MC2_A-CHO) and the monomer (MC2_B-CHO) are used instead of the monomer (MC2_A-C1) and the monomer (MC2_B-C1), respectively, allows a high-molecular compound having a constitutional unit (UC2) with such a heterocyclic ring, to which CHO is bonded as an alternative substituent, to be synthesized. An exemplary structure of a high-molecular compound synthesized by using the monomer (MC2_A-CHO-1) and the monomer (MC2_B-CHO-1) is shown below as an example.

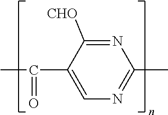

A synthesis route for a high-molecular compound having a constitutional unit (UC2) with a heterocyclic ring, to which COOH is bonded as a substituent, will be described.

By allowing the monomer (MC2_A-CH₂OH) to react with a mixture of potassium dichromate and an aqueous solution of sulfuric acid, a reaction product containing a monomer (MC2_A-COOH) may be produced. Meanwhile, by allowing the monomer (MC2_B-CH₂OH) to react with phosphorus pentachloride and then allowing the reactant to react with a mixture of potassium dichromate and an aqueous solution of sulfuric acid, a reaction product containing a monomer (MC2_C-COOH) may be produced. It is preferable that these reaction products be classified as appropriate to recover the target monomers. The monomer (MC2_A-COOH) herein refers to at least one monomer selected from the group consisting of monomers (MC2_A-COOH-1) and (MC2_A-COOH-2). The monomer (MC2_C-COOH) herein refers to at least one monomer selected from the group consisting of monomers (MC2_C-COOH-1) and (MC2_C-COOH-2). In the monomers (MC2_A-COOH-1) and (MC2_A-COOH-2), COOH is substituted for C1 in the monomers (MC2_A-C1-1) and (MC2_A-C1-2), respectively. In the monomers (MC2_C-COOH-1) and (MC2_C-COOH-2), COOH is substituted for C1 in the monomers (MC2_C-C1-1) and (MC2_C-C1-2), respectively. As an example, a reaction formula for synthesizing the monomer (MC2_A-COOH-1) from the monomer (MC2_A-CH₂OH-1) and a reaction formula for synthesizing the monomer (MC2_C-COOH-1) from the monomer (MC2_B-CH₂OH-1) are shown below.

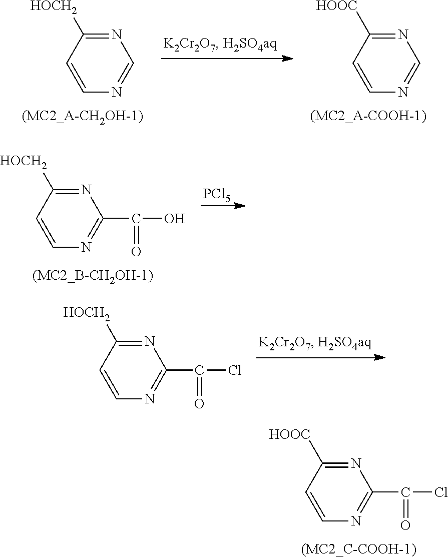

Following the synthesis route of the high-molecular compound having the constitutional unit (UC2) with the heterocyclic ring, to which C1 is bonded as the substituent, except that the monomer (MC2_A-COOH) and the monomer (MC2_C-COOH) are used instead of the monomer (MC2_A-C1) and the monomer (MC2_C-C1), respectively, allows a high-molecular compound having a constitutional unit (UC2) with such a heterocyclic ring, to which COOH is bonded as an alternative substituent, to be synthesized. An exemplary structure of a high-molecular compound synthesized by using the monomer (MC2_A-COOH-1) and the monomer (MC2_C-COOH-1) is shown below as an example.

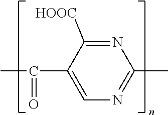

A synthesis route for a high-molecular compound having a constitutional unit (UC2) with a heterocyclic ring, to which CHOHCH₂OH is bonded as a substituent, will be described.

By allowing each of the monomer (MC2_A-C₂H₅) and the monomer (MC2_B-C₂H₅) with Cl₂ and then allowing the reactants to react with NaOH in water, a reaction product containing a monomer (MC2_A-CHOHCH₂OH) and a reaction product containing a monomer (MC2_B-CHOHCH₂OH) may be respectively produced. It is preferable that these reaction products be classified as appropriate to recover the target monomers. The monomer (MC2_A-CHOHCH₂OH) herein refers to at least one monomer selected from the group consisting of monomers (MC2_A-CHOHCH₂OH-1) and (MC2_A-CHOHCH₂OH-2). The monomer (MC2_B-CHOHCH₂OH) herein refers to at least one monomer selected from the group consisting of monomers (MC2_B-CHOHCH₂OH-1) and (MC2_B-CHOHCH₂OH-2). In the monomers (MC2_A-CHOHCH₂OH-1) and (MC2_A-CHOHCH₂OH-2), CHOHCH₂OH is substituted for C1 in the monomers (MC2_A-C1-1) and (MC2_A-C1-2), respectively. In the monomers (MC2_B-CHOHCH₂OH-1) and (MC2_B-CHOHCH₂OH-2), CHOHCH₂OH is substituted for C1 in the monomers (MC2_B-C1-1) and (MC2_B-C1-2), respectively. As an example, a reaction formula for synthesizing the monomer (MC2_A-CHOHCH₂OH-1) from the monomer (MC2_A-C₂H₅-1) and a reaction formula for synthesizing the monomer (MC2_B-CHOHCH₂OH-1) from the monomer (MC2_B-C₂H₅-1) are shown below.

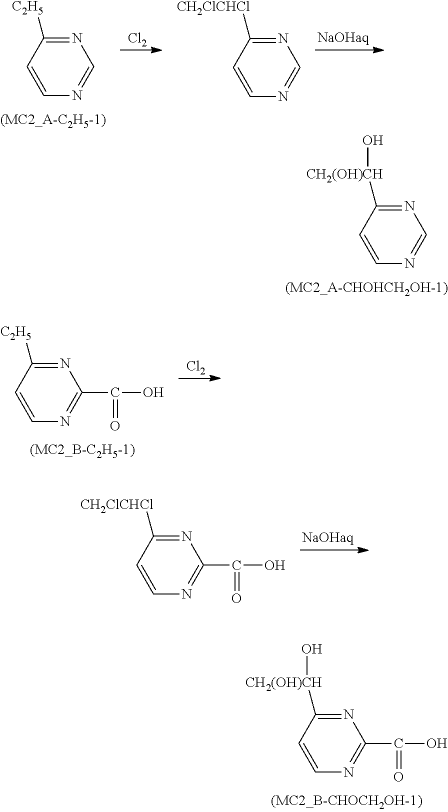

Following the synthesis route of the high-molecular compound having the constitutional unit (UC2) with the heterocyclic ring, to which C1 is bonded as the substituent, except that the monomer (MC2_A-CHOHCH₂OH) and the monomer (MC2_B-CHOHCH₂OH) are used instead of the monomer (MC2_A-C1) and the monomer (MC2_B-C1), respectively, allows a high-molecular compound having a constitutional unit (UC2) with such a heterocyclic ring, to which CHOHCH₂OH is bonded as an alternative substituent, to be synthesized. An exemplary structure of a high-molecular compound synthesized by using the monomer (MC2_A-CHOHCH₂OH-1) and the monomer (MC2_B-CHOHCH₂OH-1) is shown below as an example.

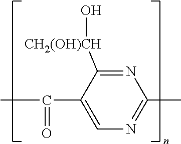

### (2) Molding Composition

A molding composition according to this embodiment contains the high-molecular compound described above. For example, if a film is formed out of the molding composition, then the percentage of the high-molecular compound to the molding composition is preferably equal to or greater than 90% by mass. This makes it easier to form a film with a high dielectric constant. The percentage of the high-molecular compound to the molding composition is more preferably equal to or greater than 95% by mass. Optionally, the molding composition may contain not only the high-molecular compound but also at least one other additional component selected from the group consisting of, for example, a solvent such as water, a polymerization initiator, a polymerization inhibitor, and a curing agent.

### (3) Film

A film according to this embodiment will be described.

The film according to this embodiment contains the high-molecular compound described above. This allows a film with a high dielectric constant to be provided.

If the film is formed out of the molding composition, then the above-described molding composition preferably contains a solvent. This may improve the applicability of the molding composition when the film is molded.

The film according to this embodiment may be formed by drying and curing the molding composition and then turning the cured product into a film shape. Alternatively, the film according to this embodiment may also be formed by turning the molding composition containing the solvent into a film shape.

Specifically, the film according to this embodiment may be formed by, for example, applying the molding composition onto a carrier film and then drying and curing the molding composition to turn the cured product into the film shape. In that case, the solvent contained in the molding composition may be water, for example. Also, a film with good peelability such as a PET film may be used as the carrier film. In addition, the molding composition needs to be dried when the film is formed. In that case, the molding composition may be heated to be dried.

The film according to this embodiment may also be formed by a method other than the above-described one. For example, the film may also be formed by subjecting the molding composition to an extrusion molding process.

The film according to this embodiment may be formed to have an appropriate thickness depending on the intended use. For example, if the film is used as a dielectric layer for a capacitor, then the film preferably has a thickness equal to or greater than 1.0 μm and equal to or less than 6.0 μm and more preferably has a thickness equal to or greater than 2.3 μm and equal to or less than 3.0 μm. Also, if the film is used as a dielectric layer for a capacitor, then the film preferably has a breakdown voltage equal to or greater than 0.9 kV.

### (4) Capacitor

A capacitor according to this embodiment will be described.

A capacitor 10 according to this embodiment includes a dielectric layer 1 containing the above-described high-molecular compound.

The dielectric layer 1 includes the above-described film. In other words, the dielectric layer 1 is a film containing the high-molecular compound according to this embodiment.

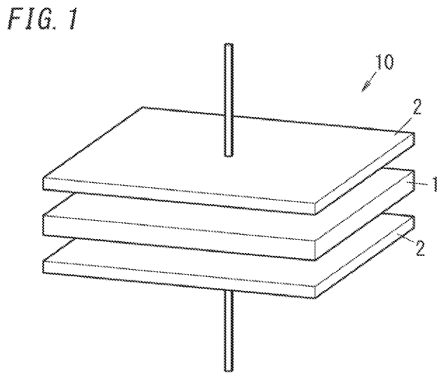

The capacitor 10 includes the dielectric layer 1 as its dielectric layer. Specifically, the capacitor 10 includes a pair of electrodes 2 and the dielectric layer 1 interposed between the two electrodes (refer to FIG. 1).

Each of these electrodes 2 may be either a thin-film electrode layer formed by evaporating a metal or a sheet of metal foil, whichever is appropriate. The metal as a constituent material for the electrodes 2 may include at least one selected from the group consisting of, for example, aluminum, zinc, copper, and alloys thereof. The metal as a constituent material for the electrodes 2 is preferably aluminum or an aluminum alloy.

The broader the electrode area of the capacitor 10 is, the higher the capacitance of the capacitor 10 is. Also, the higher the dielectric constant of the dielectric layer thereof is, the higher the capacitance of the capacitor 10 is. Furthermore, the narrower the gap distance between its electrodes is, the higher the capacitance of the capacitor 10 is. The capacitor 10 according to this embodiment includes the dielectric layer 1 made of the high-molecular compound with a high dielectric constant according to this embodiment. This contributes to increasing the capacitance of the capacitor.

In the process of forming the capacitor 10 according to this embodiment, after a film of the molding composition has been formed, polymerizing the high-molecular compound in the film and forming electrodes by evaporating a metal on the film may be performed in the same process step. This allows the dielectric layer to be formed out of the film and the evaporated electrodes to be formed out of the metal efficiently.

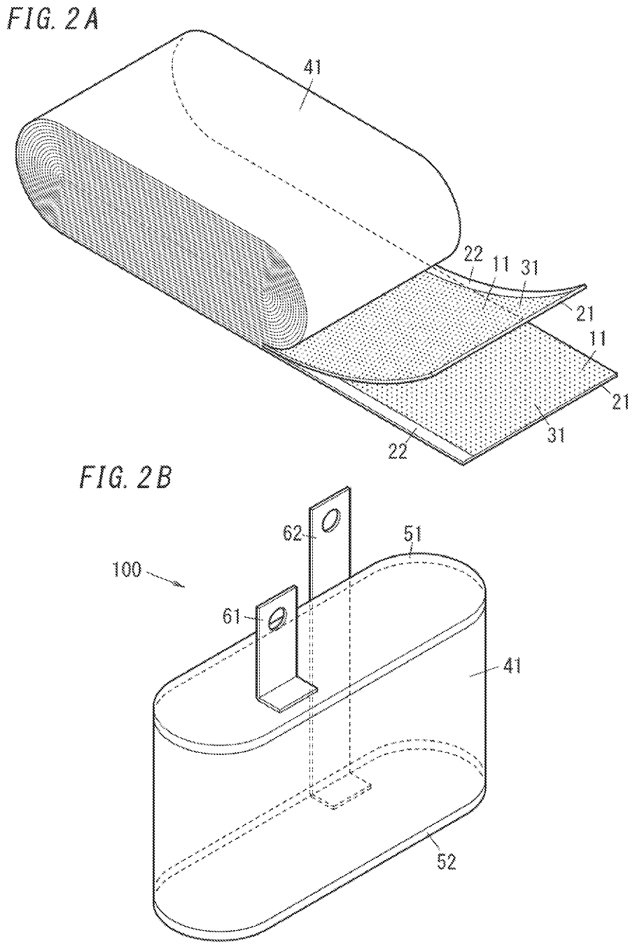

Furthermore, the capacitor according to this embodiment may be a wound capacitor (hereinafter also referred to as a “rolled capacitor”) or a stacked capacitor, whichever is appropriate. The rolled capacitor 100 includes a roll 41. The roll 41 includes a pair of electrodes 11 and a dielectric layer 21 interposed between the pair of electrodes 11 as shown in FIG. 2A. Meanwhile, the stacked capacitor 10 includes a multilayer stack including the pair of electrodes 2 and the dielectric layer 1 interposed between the pair of electrodes 2 as shown in FIG. 1.

The rolled capacitor 100 may be formed in the following manner, for example. First, a film containing the high-molecular compound according to this embodiment is formed as the dielectric layer 21. Next, an electrode layer containing aluminum, zinc, magnesium, or any other metal is formed as an electrode 11 on one surface of the dielectric layer 21 by, for example, an evaporation process or a sputtering process, thereby forming a metallized film 31. In this case, the metallized film 31 includes a margin portion 22 where the electrode 11 is not formed. The margin portion 22 is provided along one of the longer sides of the metallized film 31.

Next, a pair of such metallized films 31 are normally laid one on top of the other with their longer sides aligned with each other. Then, the pair of the metallized films 31 are rolled up such that the longer side with the margin portion 22 of one metallized film 31 is located opposite from the longer side with the margin portion 22 of the other metallized film 31 and that the electrodes 11 face each other with the dielectric layer 21 interposed between the electrodes 11 themselves. A circular cylindrical roll is formed by rolling up the pair of metallized films 31 that are laid one on top of the other. Then, the circular cylindrical roll is pressed on both side surfaces thereof, thereby obtaining a roll 41 having an oval cross section.

Next, external electrodes 51, 52 are respectively formed on both ends of the roll 41 by Metallikon (metal spraying) method, thereby completing the rolled capacitor 100. The external electrodes 51, 52 may be made of, for example, aluminum, zinc, magnesium, or an alloy thereof. The external electrodes 51, 52 are electrically connected to the pair of electrodes 11, respectively. The pair of electrodes 11 serves as a pair of internal electrodes. Then, the capacitor 100 shown in FIG. 2B may be formed by electrically connecting external connection terminals 61, 62 to the external electrodes 51, 52, respectively, by solder welding. This allows the capacitor 100 to have further increased capacitance while maintaining the thickness of the dielectric layer 21 thereof. In addition, this also allows the capacitor 100 to have a reduced size while maintaining the capacitance thereof. Note that the dielectric constants and capacitance values according to Examples 1-215 of the present disclosure were measured by using the rolled capacitor 100 that had been formed by the above-described method.

Also, the capacitance of the capacitors 10, 100 according to this embodiment is equal to or greater than 8.0×10² μF, for example, preferably equal to or greater than 1.0×10³ μF, more preferably equal to or greater than 1.2×10³ μF, and even more preferably equal to or greater than 1.4×10³ μF. The upper limit of the capacitance of the capacitors 10, 100 is not limited to any particular value but may be, for example, equal to or less than 2.0×10³ μF.

### (Variations)

The high-molecular compound according to this embodiment may be contained in not only films and capacitors but also various other products as well. Also, the molding composition containing the high-molecular compound according to this embodiment may be used to make various products.

The molding composition according to this embodiment may be used to make a dielectric mirror, a thermal conductive member, a printed wiring board, and an encapsulant for encapsulating a semiconductor device. Note that the molding composition may have an appropriate composition depending on the intended use or purpose. For example, the molding composition according to this embodiment may also contain, depending on the intended use or purpose, any component other than the solvent such as water, the polymerization initiator, and the curing agent that are used to form the film.

A dielectric mirror may be formed by stacking a plurality of dielectric layers one on top of another. The plurality of dielectric layers may be formed by stacking, on a glass substrate, multiple layers of films, each containing the high-molecular compound according to this embodiment, one on top of another.

A thermal conductive member may be formed in the following manner. First, a molded product is formed by curing a thermally conductive resin composition containing the high-molecular compound according to this embodiment and a thermally conductive filler. Next, the molded product is cut into a sheet shape to obtain a sheet of the molded product. Then, the sheet is pressed to form the thermal conductive member.

A printed wiring board may be formed by forming a resin substrate using a film containing the high-molecular compound according to this embodiment and then forming a conductor on the surface of the resin substrate.

An encapsulant for encapsulating a semiconductor device may be formed in the following manner. First, the high-molecular compound according to this embodiment, an inorganic filler, and a curing agent are added to an organic solvent and mixed and dispersed, thereby preparing a varnish for encapsulating connecting portions of semiconductor devices. Then, the varnish is applied onto a base member film. Thereafter, the organic solvent is dried by heating to turn the varnish into an adhesive in the shape of a film for use as the encapsulant. Optionally, when the adhesive varnish for encapsulating the connecting portions of a semiconductor device is prepared, a curing accelerator may be added as a catalyst. Alternatively, any other suitable additive may also be added thereto.

### (Recapitulation)

As can be seen from the foregoing description of embodiments and examples, a high-molecular compound according to a first aspect of the present disclosure has a constitutional unit (U) having a heterocyclic ring, a carbonyl group, and a substituent bonded to the heterocyclic ring. The substituent includes at least one group selected from the group consisting of a halogen group, a hydroxyl group, an aldehyde group, a carboxyl group, an alkyl group, a halogenated alkyl group, and a hydroxyalkyl group.

The first aspect provides a high-molecular compound with a high dielectric constant.

In a high-molecular compound according to a second aspect of the present disclosure, which may be implemented in conjunction with the first aspect, the substituent includes at least one group selected from the group consisting of F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH.

The second aspect provides a high-molecular compound with a high dielectric constant.

In a high-molecular compound according to a third aspect of the present disclosure, which may be implemented in conjunction with the first or second aspect, the heterocyclic ring has a nitrogen atom.

The third aspect provides a high-molecular compound with a high dielectric constant.

In a high-molecular compound according to a fourth aspect of the present disclosure, which may be implemented in conjunction with any one of the first to third aspects, the carbonyl group is directly bonded to the heterocyclic ring.

The fourth aspect provides a high-molecular compound with a high dielectric constant.

In a high-molecular compound according to a fifth aspect of the present disclosure, which may be implemented in conjunction with any one of the first to fourth aspects, the constitutional unit (U) includes a constitutional unit (UA) expressed by the chemical structural formula (A), where R₁, R₂, and R₃ are each independently selected from the list consisting of H, F, Cl, Br, OH, CHO, COOH, CH₃, CH₂F, CHF₂, CH₂Cl, CHCl₂, CCl₃, CH₂Br, CHBr₂, CBr₃, and CHOHCH₂OH, and H is excluded from the list for least one of R₁, R₂, or R₃.

The fifth aspect provides a high-molecular compound with a high dielectric constant.

In a high-molecular compound according to a sixth aspect of the present disclosure, which may be implemented in conjunction with the fifth aspect, in the chemical structural formula (A), R₁ is H; R₂ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₃ is either H or the same as R₂. Alternatively, R₂ is H; R₃ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₁ is either H or the same as R₃. Still alternatively, R₃ is H; R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH; and R₂ is either H or the same as R₁.

The sixth aspect provides a high-molecular compound with a high dielectric constant.

In a high-molecular compound according to a seventh aspect of the present disclosure, which may be implemented in conjunction with the fifth aspect, in the chemical structural formula (A), R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and each of R₂ and R₃ is the same as R₁.

The seventh aspect provides a high-molecular compound with a high dielectric constant.

In a high-molecular compound according to an eighth aspect of the present disclosure, which may be implemented in conjunction with any one of the first to seventh aspects, the constitutional unit (U) includes a constitutional unit (UB) expressed by the chemical structural formula (B), where R₁ and R₂ are each independently selected from the list consisting of H, F, Cl, Br, OH, CHO, COOH, CH₃, CH₂F, CH₂Cl, CHCl₂, CCl₃, CH₂Br, CHBr₂, CBr₃, and CHOHCH₂OH, and H is excluded from the list for at least one of R₁ or R₂.

The eighth aspect provides a high-molecular compound with a high dielectric constant.

In a high-molecular compound according to a ninth aspect of the present disclosure, which may be implemented in conjunction with the eighth aspect, in the chemical structural formula (B), R₁ is H; and R₂ is F, Cl, Br, OH, CHO, COOH, CH₃, CH₂F, CH₂Cl, CHCl₂, CCl₃, CH₂Br, CHBr₂, CBr₃, or CHOHCH₂OH. Alternatively, R₁ is F, Cl, Br, OH, CHO, COOH, CH₃, CH₂F, CH₂Cl, CHCl₂, CCl₃, CH₂Br, CHBr₂, CBr₃, or CHOHCH₂OH; and R₂ is either H or the same as R₁.

The ninth aspect provides a high-molecular compound with a high dielectric constant.

In a high-molecular compound according to a tenth aspect of the present disclosure, which may be implemented in conjunction with any one of the first to ninth aspects, the constitutional unit (U) includes a constitutional unit (UC1) expressed by the chemical structural formula (C1), where R₁ and R₂ are each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for at least one of R₁ or R₂.

The tenth aspect provides a high-molecular compound with a high dielectric constant.

In a high-molecular compound according to an eleventh aspect of the present disclosure, which may be implemented in conjunction with the tenth aspect, in the chemical structural formula (C1), R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either H or the same as R₁.

The eleventh aspect provides a high-molecular compound with a high dielectric constant.

In a high-molecular compound according to a twelfth aspect of the present disclosure, which may be implemented in conjunction with any one of the first to eleventh aspects, the constitutional unit (U) includes a constitutional unit (UC2) expressed by the chemical structural formula (C2), where R₁ and R₂ are each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and H is excluded from the list for at least one of R₁ or R₂.

The twelfth aspect provides a high-molecular compound with a high dielectric constant.

In a high-molecular compound according to a thirteenth aspect of the present disclosure, which may be implemented in conjunction with the twelfth aspect, in the chemical structural formula (C2), R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and R₂ is either H or the same as R₁.

The thirteenth aspect provides a high-molecular compound with a high dielectric constant.

A molding composition according to a fourteenth aspect of the present disclosure contains the high-molecular compound according to any one of the first to thirteenth aspects.

The fourteenth aspect provides a molding composition with a high dielectric constant.

A film according to a fifteenth aspect of the present disclosure contains the high-molecular compound according to any one of the first to thirteenth aspects.

The fifteenth aspect provides a film with a high dielectric constant.

A capacitor according to a sixteenth aspect of the present disclosure includes a dielectric layer containing the high-molecular compound according to any one of the first to thirteenth aspects.

The sixteenth aspect provides a capacitor with a high dielectric constant.

### REFERENCE SIGNS LIST

1, 21 Dielectric Layer
2, 11 Electrode
10, 100 Capacitor
22 Margin Portion
31 Metallized Film
41 Roll
51, 52 External Electrode
61, 62 External Connection Terminal

1. A high-molecular compound comprising a constitutional unit (U) having a heterocyclic ring, a carbonyl group, and a substituent bonded to the heterocyclic ring,
the substituent including at least one group selected from the group consisting of a halogen group, a hydroxyl group, an aldehyde group, a carboxyl group, an alkyl group, a halogenated alkyl group, and a hydroxyalkyl group.

2. The high-molecular compound of claim 1, wherein
the substituent includes at least one group selected from the group consisting of F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH.

3. The high-molecular compound of claim 1, wherein
the heterocyclic ring has a nitrogen atom.

4. The high-molecular compound of claim 1, wherein
the carbonyl group is directly bonded to the heterocyclic ring.

5. The high-molecular compound of claim 2, wherein
the constitutional unit (U) includes a constitutional unit (UA) expressed by the following chemical structural formula (A): 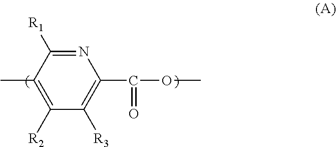
where R₁, R₂, and R₃ are each independently selected from the list consisting of H, F, Cl, Br, OH, CHO, COOH, CH₃, CH₂F, CHF₂, CH₂Cl, CHCl₂, CCl₃, CH₂Br, CHBr₂, CBr₃, and CHOHCH₂OH, and
H is excluded from the list for least one of R₁, R₂, or R₃.

6. The high-molecular compound of claim 5, wherein
in the chemical structural formula (A),
R₁ is H,
R₂ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and
R₃ is either H or same as R₂, or
R₂ is H,
R₃ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and
R₁ is either H or same as R₃, or
R₃ is H,
R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and
R₂ is either H or same as R₁.

7. The high-molecular compound of claim 5, wherein
in the chemical structural formula (A),
R₁ is F, Cl, Br, OH, CHO, COOH, CH₃, CH₂F, CHF₂, CH₂Cl, CHCl₂, CCl₃, CH₂Br, CHBr₂, CBr₃, or CHOHCH₂OH, and
each of R₂ and R₃ is same as R₁.

8. The high-molecular compound of claim 2, wherein
the constitutional unit (U) includes a constitutional unit (UB) expressed by the following chemical structural formula (B): 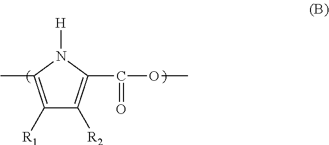
where R₁ and R₂ are each independently selected from the list consisting of H, F, Cl, Br, OH, CHO, COOH, CH₃, CH₂F, CH₂Cl, CHCl₂, CCl₃, CH₂Br, CHBr₂, CBr₃, and CHOHCH₂OH, and
H is excluded from the list for at least one of R₁ or R₂.

9. The high-molecular compound of claim 8, wherein
in the chemical structural formula (B),
R₁ is H, and
R₂ is F, Cl, Br, OH, CHO, COOH, CH₃, CH₂F, CH₂Cl, CHCl₂, CCl₃, CH₂Br, CHBr₂, CBr₃, or CHOHCH₂OH, or
R₁ is F, Cl, Br, OH, CHO, COOH, CH₃, CH₂F, CH₂Cl, CHCl₂, CCl₃, CH₂Br, CHBr₂, CBr₃, or CHOHCH₂OH, and
R₂ is either H or same as R₁.

10. The high-molecular compound of claim 2, wherein
the constitutional unit (U) includes a constitutional unit (UC1) expressed by the following chemical structural formula (C1): 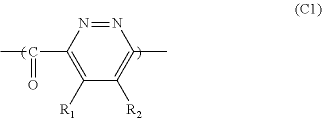
where R₁ and R₂ are each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and
H is excluded from the list for at least one of R₁ or R₂.

11. The high-molecular compound of claim 10, wherein
in the chemical structural formula (C1),
R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and
R₂ is either H or same as R₁.

12. The high-molecular compound of claim 2, wherein
the constitutional unit (U) includes a constitutional unit (UC2) expressed by the following chemical structural formula (C2): 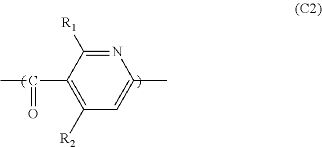
where R₁ and R₂ are each independently selected from the list consisting of H, F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, and CHOHCH₂OH, and
H is excluded from the list for at least one of R₁ or R₂.

13. The high-molecular compound of claim 12, wherein
in the chemical structural formula (C2),
R₁ is F, Cl, Br, OH, CHO, COOH, CH₃, C₂H₅, CH₂F, CHF₂, CF₃, CH₂Cl, CHCl₂, CCl₃, CH₂Br, CHBr₂, CBr₃, or CHOHCH₂OH, and
R₂ is either H or same as R₁.

14. A molding composition containing the high-molecular compound of claim 1.

15. A film containing the high-molecular compound of claim 1.

16. A capacitor including a dielectric layer containing the high-molecular compound of claim 1.
